(19) United States
(12) Patent Application Publication
(10) Pub. No.: US 2015/0033112 A1
(43) Pub. Date: Jan. 29, 2015

(54) SYSTEM AND METHOD FOR TAGGING CONTENT IN A DIGITAL MEDIA DISPLAY

(71) Applicant: SOCIAL COMMENTING, LLC, Sedona, AZ (US)

(72) Inventors: Michael Roy Norwood, Phoenix, AZ (US); Steve Malvern Omohundro, Palo Alto, CA (US)

(73) Assignee: SOCIAL COMMENTING, LLC, Sedona, AZ (US)

(21) Appl. No.: 14/515,293

(22) Filed: Oct. 15, 2014

Related U.S. Application Data
(63) Continuation-in-part of application No. 13/759,693, filed on Feb. 5, 2013.
Application No. 13/759,693 is a continuation of application No. 11/818,912, filed on Jun. 15, 2007, now Pat. No. 8,402,357.
(60) Provisional application No. 61/892,426, filed on Oct. 17, 2013.
(60) Provisional application No. 60/813,982, filed on Jun. 15, 2006.

(51) Int. Cl. G06F 17/24; G06F 17/30

(52) U.S. Cl. CPC G06F 17/241; G06F 17/3089; G06F 17/30864
USPC 715/230

(57) ABSTRACT

A software system and method that allows website readers to create and store comments pertaining to website content, with tags identifying the comment, so that the comments may be easily retrieved at a later time. An administrator accesses a website to enter data (e.g. HTML code) for creating reader comment and tag. When the webpage containing the code is posted to a website, the code results in a reader comment and tag display page where website visitors can comment on the content of the website, and create one or more tags that identify their comment. Comments and tags are then saved at a local or remote website database accessible to the reader. A reader can find their comments that they posted on various websites stored within their database record by searching the database for comments with a particular tag. They can also assign new tags to their stored comments.

### CROSS-REFERENCE TO RELATED APPLICATIONS

This is a utility patent application being filed in the United States as a non-provisional application for patent under Title 35 U.S.C. §100 et seq. and 37 C.F.R. §1.53(b) and, claiming the priority under 35 U.S.C. §119(e) to the provisional application for patent filed in the United States on Oct. 17, 2013, bearing the title of “SYSTEM AND METHOD FOR TAGGING CONTENT IN A DIGITAL MEDIA DISPLAY”, and assigned application Ser. No. 61/892,426.

Further, this application is a continuation-in-part of U.S. patent application Ser. No. 13/759,693, filed on Feb. 5, 2013, which application is a continuation of U.S. patent application Ser. No. 11/818,912 filed on Jun. 15, 2007 and issued as U.S. Pat. No. 8,402,357 to Norwood et al., on Mar. 19, 2013, and bears the title of “SYSTEM AND METHOD FOR FACILITATING POSTING OF PUBLIC AND PRIVATE USERS COMMENTS AT A WEBSITE”, which application is a non-provisional application of United States. Provisional Application for patent filed on Jun. 15, 2006 and assigned Ser. No. 60/813,982.

Each of these above-referenced applications are hereby incorporated by reference in its entirety.

### FIELD OF THE INVENTION

The present invention relates generally to software applications for annotating web pages. In particular, the present invention is a system and method for use by web site operators to facilitate user posting of comments with tags at a web site.

### BACKGROUND OF THE INVENTION

Although web site blogs that provide commentary on a variety of topics are very popular, they typically emphasize the web site owner's or blogger's comments. Many bloggers do not allow readers to comment on posts for fear of the readers submitting inappropriate comments. As a result, reader interaction with blogs and other web sites is limited. If readers were permitted to post private rather than public comments, bloggers could allow readers to comment on posts without the fear that inappropriate comments will be read by other readers. However, blogs and web sites typically do not support posting of private comments.

Another problem with current web technology is that adapting blogs and other web pages for annotations and comments is very cumbersome and difficult. Even if a blogger would like to invite his or her readers to comment on the blogger's posts, adapting the blog or other web site content to allow such interactivity is difficult and requires programming skills. Details related to web page layout and content can also make it difficult to adapt pages for comments. Because of the difficulties in facilitating comments on individual web pages, many web site operators maintain a single blog for the entire site. Comments regarding unrelated content appear in the same area of the web site simply because a blog is supported in only one area of the site that users can visit to post. If a blogger would like to support private as well as public comments, additional programming is required to allow such postings on web pages.

### Tagging

Placing end-user (e.g. website reader or visitor) created tags or labels on any item that s/he views in a digital media display is an essential part of an internet end-user experience. Tagging or labeling allows the end-user to classify information into groups that is stored in their database file so as to facilitate their searching and retrieving content associated with a particular tag. Gmail's uses of labels to classify any email into a single group is a form of tagging. The Delicious Toolbar which allows users to classify any webpage into a group with comments is another form of tagging.

But, there is still a need for a system and method that enables website visitors to post public and private comments on website content and to assign a tag or topic to their comment so that they can later retrieve their comments that are associated with a particular tag/topic. For example, the end-user may desire to retrieve all comments that they have posted on various websites that s/he has stored on a database (remote or local) under a particular tag.

### SUMMARY OF THE INVENTION

The present disclosure is a software system and method that allows web site operators to easily adapt web page content to support posting of public and private user comments at web sites. Web site operators can support interactivity with their web site visitors centering on public reader comment areas as well as private visitor journals.

Reader comment areas according to the present disclosure allow web site visitors to comment on the content found on the particular web pages where the reader comment areas appear. Examples of such pages are ones containing articles, newsletters, photographs, quotes, news commentaries, etc. One aspect that may be included in the various embodiments presented herein is the ability to create a “mini-blog” out of every single content-oriented web page of an owner's web site. Reader comment areas can be added to many types of web pages and in some instances, may be added to a wide variety of web pages, requiring just a minute or two of time for each new page.

To prevent publication of inappropriate comments, the web site owner or an administrator has a variety of controls to maintain the privacy of comments. One such control is a “hide incoming posts” control that allows the administrator to review posts before permitting them to be published. Other controls allow the administrator to hide or delete posts that have already been published. Every reader who makes a comment on a web page enabled according to the various embodiments presented herein may be automatically added to the web site owner's subscriber list (if the web site owner so chooses, and if the reader approves via typical double opt-in methods). When an end user makes a comment on the web site owner's site, the user may also have the opportunity to sign up for a personal journal. This option further enrolls the end user and enables the end user to return to the owner's site and become part of the web site owner's community and subscriber list.

A variety of personal journal features may also be supported. Personal journal features may include, but are not limited to, keeping comments private for the user's personal viewing only, posting comments to other public web pages containing the specialized reader comment areas, and creating a unique page with the user's own individualized URL that mimics the public web page to which he or she has posted a comment. The end user comment may be displayed more prominently than other items (e.g., at the top of all other comments entered by other end users, and/or highlighted in some way such as in bold or in a different color or any number of other highlighting techniques that may be selected. The end user may also be permitted choose to eliminate all the other comments posted on the original web page so his or her comment is the only one featured.)

Additionally, from the personal journal page, the end user may print all or pre-selected journal entries in various design formats (such as mini-books or ebooks or on-line or off-line greeting cards), create a public blog out of posts he or she chooses to make public under a private domain or sub-domain name, create his or her own web pages or a web site using additional formatting features or simply publish his or her posts as text under a private domain or sub-domain name, enter audio comments to a journal, enter video comments to a journal, create podcasts of these audio and video comments, and make actual saleable products of these written, audio and/or video posts, which will be available collectively on a common commercial web site.

The features and functionality present in the various embodiments described herein can be made available to web site owners in a “prepackaged” and ready-made, ready-to-install system. Such embodiments allow web site owners to limit the need of hiring programmers to create each individual feature. The system enables the web site owner to be the administrator of the entire system. The administrator, utilizing the prepackaged system, may perform the following functions:
1. Create reader comment areas that can be added to any web page of the administrator's choosing by having the program automatically create the code for the reader comment areas. This code is simply copied and pasted into the code of the administrator's pre-existing web pages where the administrator wants the reader comment areas to appear.
2. Search engine optimize the end user posts by specifying single or multiple search engine keywords that appear either as a subtitle of each end user post or appear in any other area of the post. This coupling makes the keywords “contextual,” for which some search engines may assign a higher ranking than if the keywords were standing alone.
3. Place his or her own advertisements next to each individual post entered both on the public display page and the private journal pages
4. Add a tell-a-friend page, pop-up, layer or other tell-a-friend format which allows the end user to automatically email notice of his or her post(s) to friends. The end user benefits from this feature by publicizing his or her posts and allowing a taste of frame, and the administrator enjoys it as a way of getting more people to visit his or her web site.
5. Automatically add each new end user who places a post or signs up for his or her own personal journal to an auto-responder series of emails created by the administrator.
6. Automatically rotate the end user posts on the web page so different end user posts are featured each day. Automatic emails are sent to each end user at predetermined times to notify the end user that his or her post will be featured at the specified times so the end user, even years later, may re-activate interest in what he or she wrote, and refer friends to the site on the particular day his or her posts are featured. (This feature is also very important for search engine optimization. Search engines give higher rankings to continually-changing web pages. Search engines consider the content on these updated pages to be more timely and relevant to the keywords for which users are searching).
7. Enable the administrator to delete or hide any post of his or her choosing.
8. Enable the administrator either to hide all incoming posts until approved for public display, or to immediately allow the posts to appear for public display.
9. Select individual posts using checkmark boxes for printing out these posts together, either onto a separate web page or into a printed document to create such things as books and ebooks.
10. See the number of posts on each public web page by a counter in the administrator area and/or to the public on the public web page itself
11. Create a contest, by allowing other web site visitors to rate posts numerically (e.g., using 1-5 with 1 being “under average” and 5 being “superb” and giving prizes to the highest scoring end-user for all his or her posts scores combined over a given time period).
12. Create RSS feeds to receive additional Search Engine Traffic.

The various embodiments may facilitate eliciting reader comments to engage readers in the blogger's or web site owner's writings. It also provides greater search engine optimization resulting from specialized keyword utilization associated with the incoming posts, as well as list building advantages.

### Tagging

Embodiments presented herein may be directed to a new type of end-user (e.g. reader) created tagging. This new tagging technique allows a much more granular form of grouping of an end-user's inputs than previously allowed by the prior art. It is noted that while “keywords” as described herein are subject matter identifiers that are designated by a website administrator, “tags” are subject matter identifiers that are created by the website end-user visitor and are generally for their private use.

As a non-limiting example, a website end-user visitor places a comment on the phrase “Without vision the people perish.” on a first website. This comment is placed on a Bible-related web site that was created by a website administrator allowing end-user commenting/inputting. The website end-user visitor tags his/her comment on “Without vision the people perish” with the tag “Vision.”

Subsequently, the same end-user visitor places a different comment on a second website comprising the quote, “If one advances confidently in the direction of his dreams, and endeavors to live the life which he has imagined, he will meet with success unexpected in common hours.” This comment is placed on a web site about Henry David Thoreau that was created by a website administrator allowing end-user commenting/inputting. The website end-user visitor again labels his/her comment with the tag “Vision.”

The website end-user visitor one day decides to write a book on “Vision” and goes to his centralized journal page. There, he/she looks up the tag “Vision” and sees all the comments he has ever made on the web on third party websites and tagged with the label “Vision.”

This disclosure therefore comprises a computerized method, system, and computer program product for at least three separate aspects that may be included in one or more embodiments to the presently disclosed tagging: aspect (1) pertaining to an end-user being able to assign one or more tags to a comment when the comment is created; aspect (2) pertaining to an end-user having the ability to add the tag to an existing comment (e.g. inside the end-user's journal or on a social media website); and, aspect (3) pertaining to an end-user being able to display only those comments associated with selected tags (e.g. search for comments by tag).

The various embodiments may further comprise a local server with a database in lieu of, or in addition to, a remote second website server. For example, a reader may use a non-networked or networked computer comprising a local server with a database for: entering comments and associated tags concurrently for storage on the local database; and/or, adding one or more tags to a previously stored comment; and/or, searching for stored comments associated with a particular tag.

Additionally, the various embodiments as disclosed herein, as well as variations thereof, may further comprise keywords in addition to tags, wherein keywords are created by a web administrator and associated with comments on a webpage for the purpose of facilitating search engine optimization of the webpage.

Additionally, the various embodiments as disclosed herein, as well as variations thereof, may comprise the tagging area being a part of the comment area, or the tagging area may not be included within the definition of “comment area”.

By way of a non-limiting example, a method of tagging may comprise: a computerized method for receiving and managing reader comments associated with a web page comprising:
a) displaying, by a first web site server, a web page comprising a reader comment area, said reader comment area comprising a reader comment input, and a tag area comprising one or more of a reader created and/or selected label assigned to said comment input;
b) receiving, in said reader comment input section, data related to a comment and tag(s) entered by a reader of said web page and associated with said web page;
c) receiving, at a remote second web site server, said data related to said comment, tag(s) and the associated web page, said data related to said comment transferred upon said user selection of a submit option on said reader comment input section; and,
d) storing at said remote second web site server, using a database that is remote from said first web site server said data related to said comment, tag(s) and the associated web page entered by said reader of said web page at said first web site server.

The method may further comprise: adding said data related to said comment entered by said reader to a personal journal for said reader; and, prompting said reader to keep said comment private.

By way of another non-limiting example, the tagging method may comprise: a computerized method for receiving and managing reader comments associated with a web page, wherein a first web site server displays a web page modified to display a reader comment and tag function and is configured to receive data related to a comment, and one or more tags associated with said comment, entered by a reader of said web page displayed by said first web site server, the method comprising the actions of;
a) receiving at a remote second web site server data related to a comment and associated with the web page, said data related transferred upon said user actuating a submit function displayed on the web page presented by the first web site server; and,
b) storing at said remote second web site server, using a database that is remote from said first web site server said data related to said comment that was entered by a reader of said web page at said first web site server.

### BRIEF DESCRIPTION OF THE DRAWINGS

FIG. 1 is a block diagram of the basic components for an example embodiment of the present invention;

FIG. 2 is a detailed block diagram of components for an example embodiment of the present invention;

FIG. 3 is a login screen shot according to an example embodiment of the present invention;

FIG. 4 is an administrator page creator screen shot according to an example embodiment of the present invention;

FIG. 5A is a personal journal screen shot according to an example embodiment of the present invention;

FIG. 5B is a screen shot for the tagging of comments feature for an example of aspect (1) of the present disclosure.

FIG. 6 is an administrator page editor screen shot according to an example embodiment of the present invention;

FIG. 7 is a display page screen shot for an example embodiment of the present invention;

FIG. 8 is a tell-a-friend screen shot according to an example embodiment of the present invention;

FIG. 9 is an administrator email screen shot according to an example embodiment of the present invention;

FIG. 10 is an administrator change page editor screen shot according to an example embodiment of the present invention;

FIGS. 11-16 are screen shots for administrator category creation according to an example embodiment of the present invention;

FIG. 17 is example iFrame code according to an example embodiment of the present invention;

FIGS. 18 and 19 are screen shots for creating and managing banners according to an example embodiment of the present invention;

FIGS. 20-22 are end user comment screen shots for an example embodiment of the present invention;

FIGS. 23A-23OO are a flow diagram illustrating the web site administration, user administration, and end user components for an example embodiment of the present invention;

FIG. 24 is a sample web page comprising a reader comment area according to an example embodiment of the present invention; and

FIG. 25 is a flowchart illustrating the iFrame solution according to an example embodiment of the present invention.

FIGS. 26A and 26B are flowcharts illustrating the tagging feature of aspect (1).

FIG. 27 is a flowchart illustrating the tagging feature of aspect (2).

FIG. 28 is a flowchart illustrating the tagging feature of aspect (3).

### DETAILED DESCRIPTION OF THE INVENTION

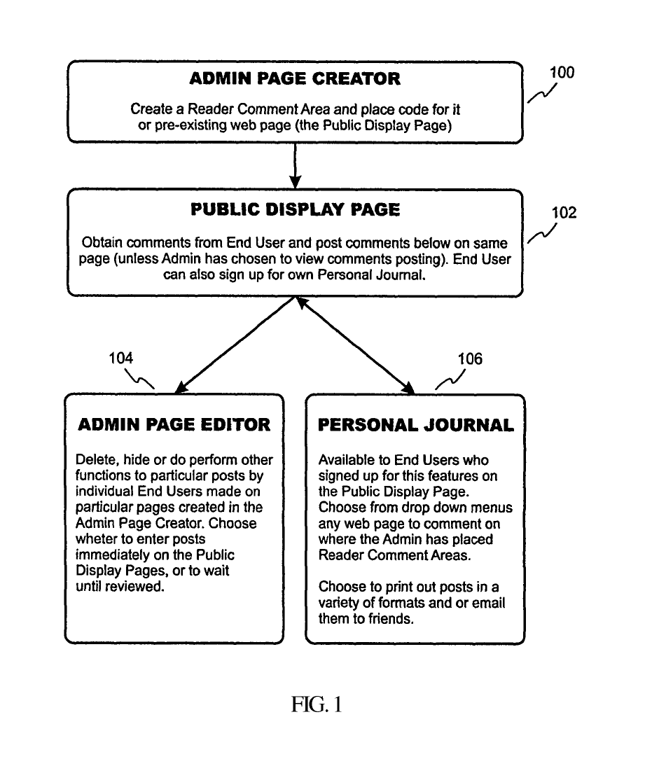

Referring to FIG. 1, a block diagram of the basic components for an example embodiment of the present invention is shown. An administrator page creator component allows an administrator to first create a reader comment area and place code for the reader comment on any new or pre-existing web page 100. Once posted to a web site, a public display page component 102 allows end users to input comments that are posted on the page. The comments may be displayed on the page when they are entered or the administrator may review them prior to displaying them. The end user may also sign up for his or her own personal journal at the web page. An administrator page editor 104 component allows an administrator to delete, hide, and perform other functions on posts entered by individual end users on particular pages created using the administrator page creator 100. The administrator may decide whether to enter posts immediately on the public display page or to review them prior to displaying them. A personal journal component 106 is available to end users that select a personal journal feature. End users can choose web pages from drop down menus and enter comments in any area where an administrator has placed a reader comment area. The end user can review and manage his or her own comments, print them in a variety of formats, and/or email them to friends.

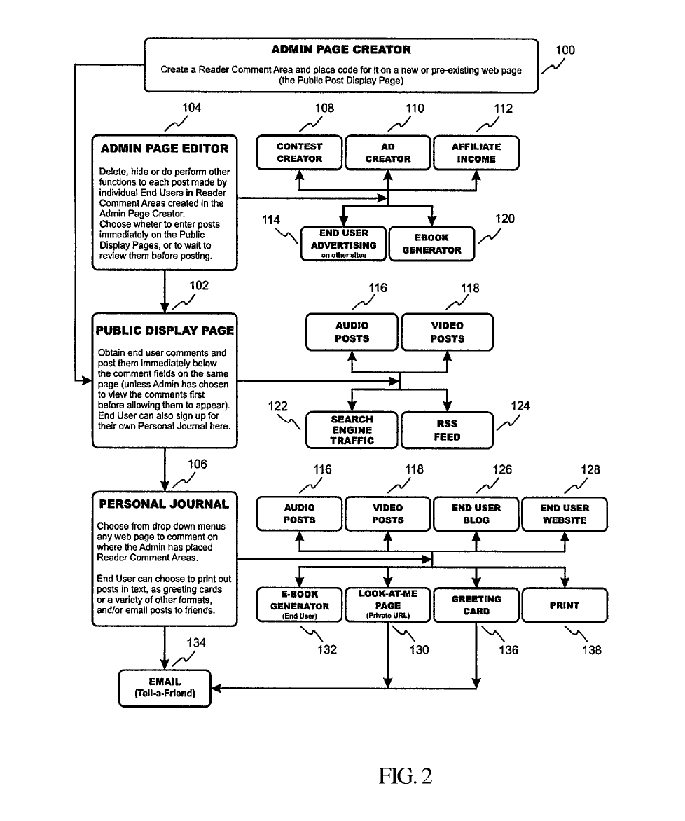

Referring to FIG. 2, a detailed block diagram of component for an example embodiment of the present invention is shown. A public display page component 102 may support audio posts 116 and video posts 118 in addition to text entries. Because posts are part of the web pages on which they are entered, they may be considered by search engines in page rankings 122 and they may be considered web page updates to RSS feed readers 124. An administrator page editor component 104 may use to generate ebooks of end user posts 120. Finally, a personal journal component 106 allows an end user to manage his or her own posts and perform various functions based the personal posts. For example, an end user may create an end user blog 126 or a web site 128 based on his or her own posts as well as a private URL to a page of the end user's posts 130. The end user may create an eBook of the posts 132 or a greeting card of the posts 136. Finally, the end user may print the posts 138. Posts in a variety of formats may be emailed to friends 134.

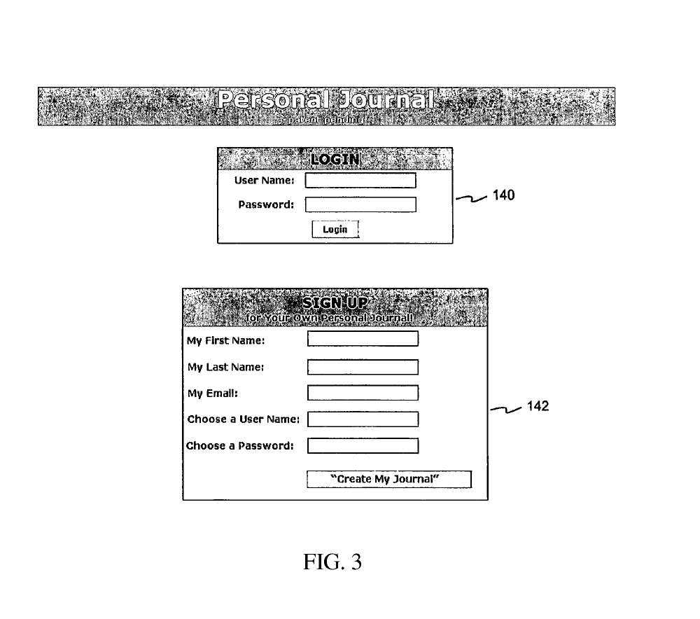

Referring to FIG. 3, a login screen shot according to an example embodiment of the present invention is shown. An end user who is already signed up for a personal journal logs in with his or her user name and password and selects a sign-up option to reach a personal journal page 140. In another portion of the screen 142, the end user signs up to create his or her own personal journal. Fields include first name, last name, email address, user name, and password. The end user selects a “create my journal” option to the complete the process.

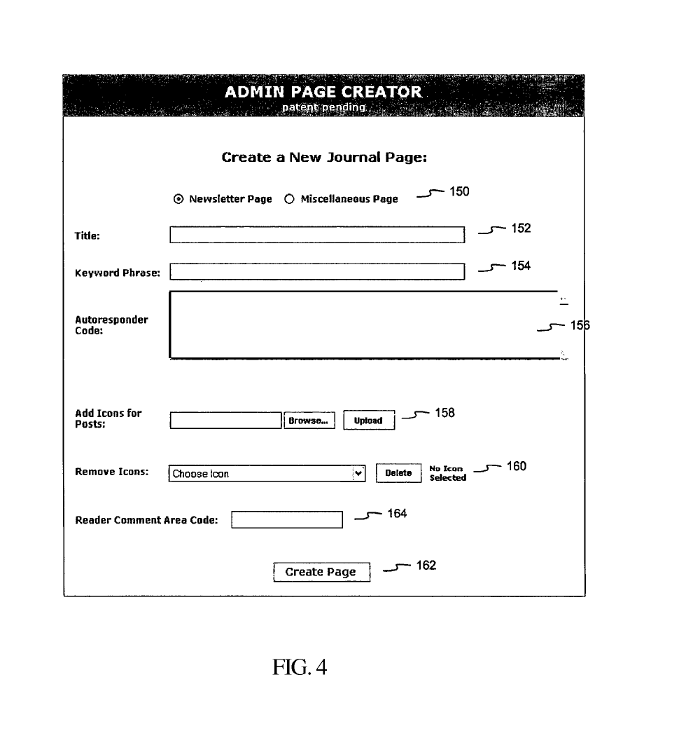

Referring to FIG. 4, an administrator page creator screen shot according to an example embodiment of the present invention is shown. The administrator may create new reader comment areas for various types of web documents such as newsletters and miscellaneous web pages at the web site. The administrator identifies the type of web page 150. A newsletter page option may be used for a web page that was originally created as a newsletter. A miscellaneous page may refer to any other type of web page. In the title field 152, the administrator enters the title of the web site page for which he or she is creating a reader comment area. In the keyword phrase field 154, administrator enters keywords of his or her choice for search engine optimization. These keywords appear next to the time/date stamp of the end user posts. An auto responder code field 156 is where the administrator enters the form/post HTML code that automatically subscribes new end users who are making posts or who are signing up for personal journals to the administrator's Auto responder. (The auto responder is the database/emailing service that maintains the administrator's list of subscribers). The “add icons for posts” browse menu 158 enables the administrator to upload images from which the end user can choose to add to his or her posts. Images uploaded automatically are reformatted to a preset width, length and kilobyte size. A “remove icons” pull down menu 160 enables the administrator to remove previously added icons. A reader comment area code field 164 is an output field and is created after the administrator presses the create page option 162. It is the specialized XML code that allows the administrator to have the reader comment areas appear on remote web sites and, it is where all the administrator's selections in the previous fields appear.

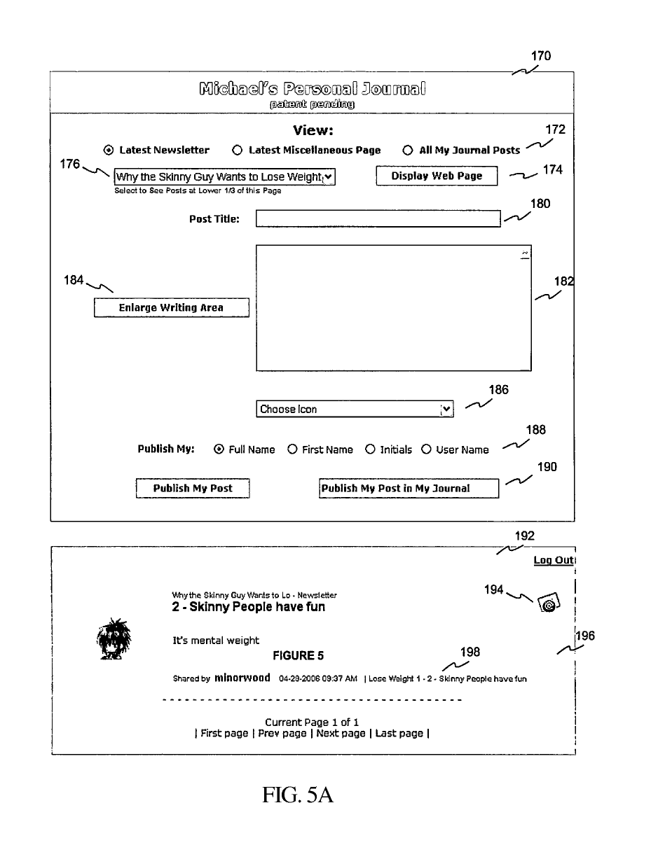

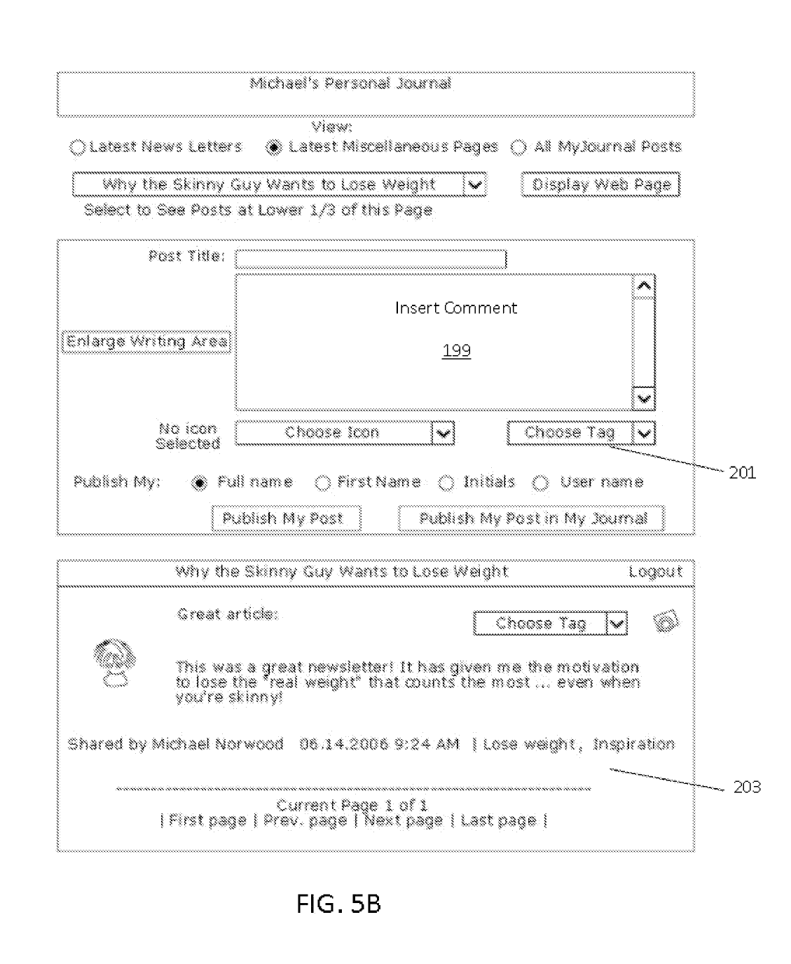

Referring to FIG. 5A, a personal journal screen shot according to an example embodiment of the present invention is shown. This screen displays the end user's personal journal resulting from the sign-up process of FIG. 3. At the top of the page, the end user's first name automatically appears indicating <end user's first name> personal journal 170. Radio buttons 172 allow the end user to choose the web page to which he or she would like to post a comment. The end user may also choose to view the previous posts he or she wrote. This option displays every post the end user previously entered on every newsletter or other web page the administrator has made available for postings. A pull down menu option 176 displays all the web pages with titles entered by the administrator in the title field of the administrator page creator based on the radio button 172 selected. A display web page option 174 allows the end user to see a popup of the display page where his or her posts will be appearing. The title next to the display web page option automatically reflects the title that the end user selected from the pull down menu 176.

Posting data fields are in the middle section of the screen. The end user may provide a title for his or her post in a post title field 180. A comment field 182 is where the end user enters his or her actual post. An enlarged writing area option 184 results in a popup that provides the end user with an enlarged writing area to compose his or her comment. The end user can adjust this writing area to any comfortable size including full screen. It automatically adjusts the writing area field proportionately to whatever size the end user desires the page to appear on his screen. A choose icon pull down menu 186 allows the end user to choose from the icons the administrator entered in the “add icons for posts” field of the administrator page creator screen (FIG. 4). The end user may choose from a selection of four radio buttons 188 to have his or her full name, first name, initials, or user name published on the public display page. Publishing options 190 include a public posting option and an option to publish the post only in the end user's private journal.

Post fields appear at the bottom of the screen. The newsletter/miscellaneous title 194 listing reflects which newsletter or miscellaneous page the end user selected previously. The title listing reflects the title the end user chose from post title field 196. The comment field has the content entered previously by the end user. Next to the comment field is the icon selected by the end user. The identifier reflects the name option selected previously 198.

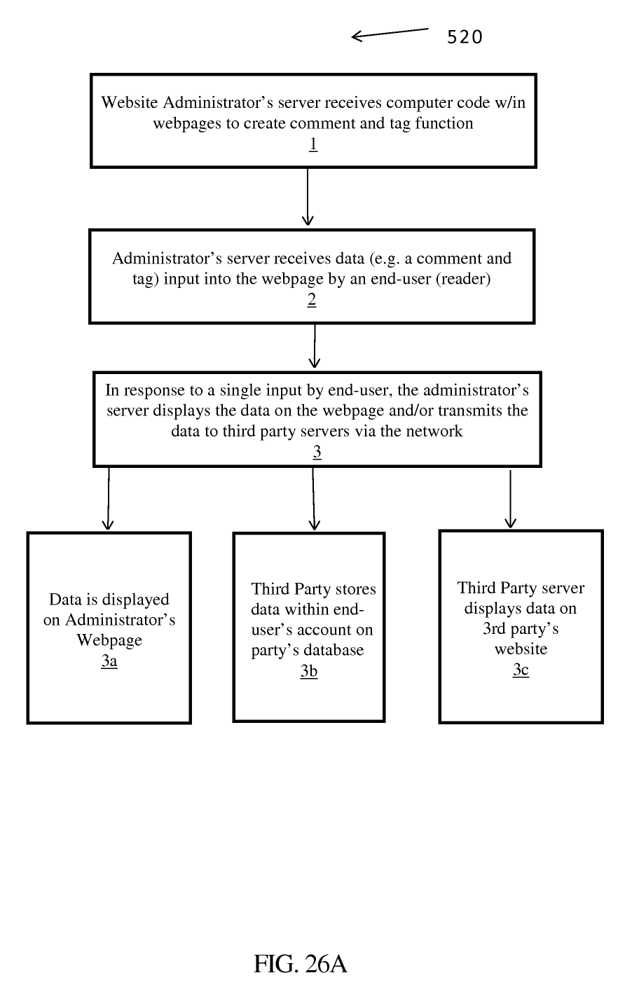

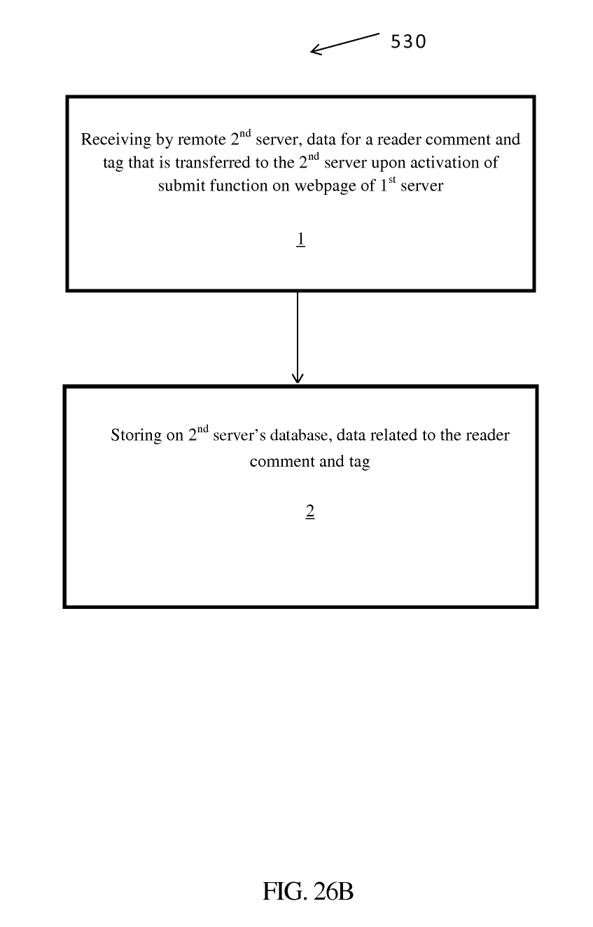

Referring to FIG. 5B, as per aspect (1) of the tagging feature: the user is able to select one or more tags 201 from, for example, a drop down menu while concurrently inputting their comment 199. If a tag that the user desires does not yet exist, one of the options in the drop down menu may be for enabling the end-user to create and input a new tag. It is noted, though, that other means of inputting and displaying tags, besides drop-down boxes are within the scope of this invention, such as: lists of tags with check boxes aligned with each tag; etc. The tags will then display with the comments (FIG. 5B, 203). In aspect (1): a) a document is displayed with an additional user interface element; b) the element includes both a comment field and a tag field; c) the user may enter a comment and optionally enter one or more tags; d) on activating a user interface element, the comment is submitted to a database on a second server, together with the tag(s) if any been created and/or selected; and, e) the server records/stores both the comment and the tag(s). (See also FIGS. 26A and 26B).

In situations for aspect (2) of the tagging feature where a user wishes to assign one or more tags to a comment for a first time (e.g. the comment was stored without a tag) and/or the user wishes to change and update one or more tags assigned to a comment, then the method comprises: a) a user's comments stored in a server database are displayed with an additional user interface element allowing the user to add tags to comments; and, b) if the user selects the additional element and provides for a tag, the tag is added to the database entry for the corresponding element (see also FIG. 27).

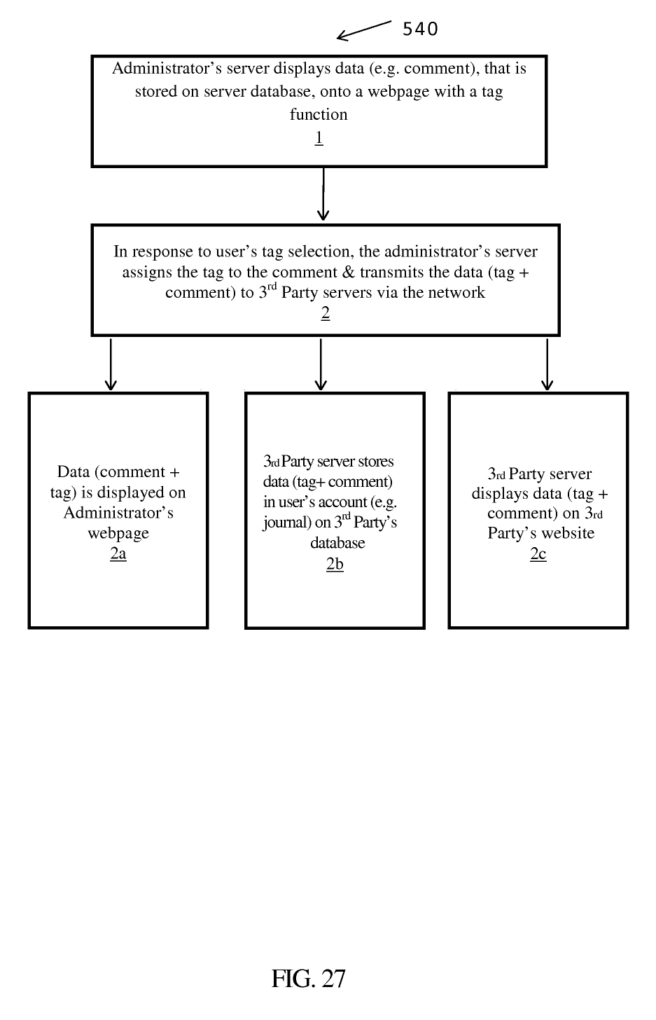

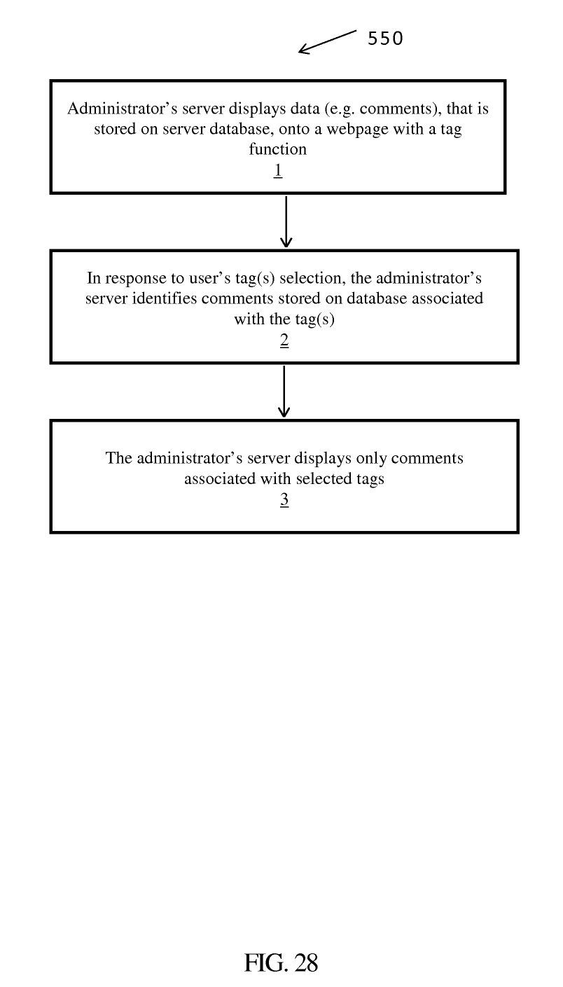

And for aspect (3) of the tagging feature where a user wishes to find comments stored in a server database that are associated with a tag, then the method comprises: a) given a database of user comments, optionally including tag information, the system displays the comments with additional user interface elements allowing the selection of tags; b) if a user selects one or more tags from the interface, then a standard database algorithm selects from the database only those comments which have been stored with the chosen tags; and, c) the system displays a webpage with only the comments associated with the selected tags (also see FIG. 28).

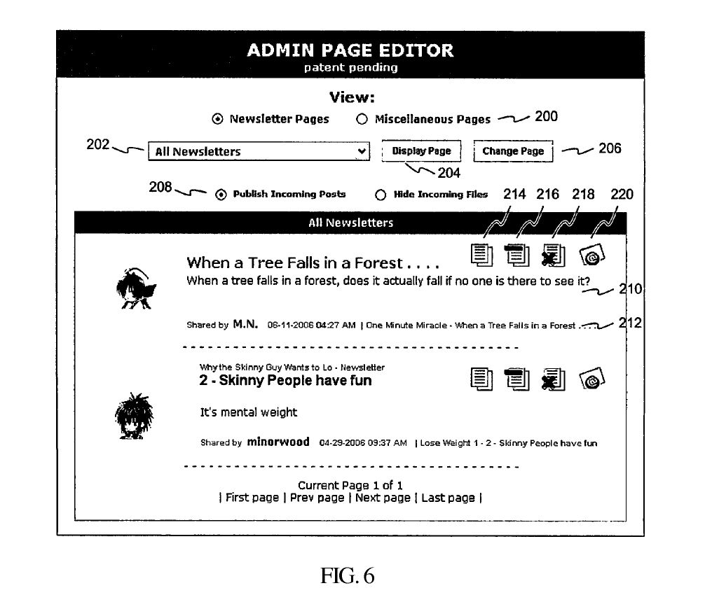

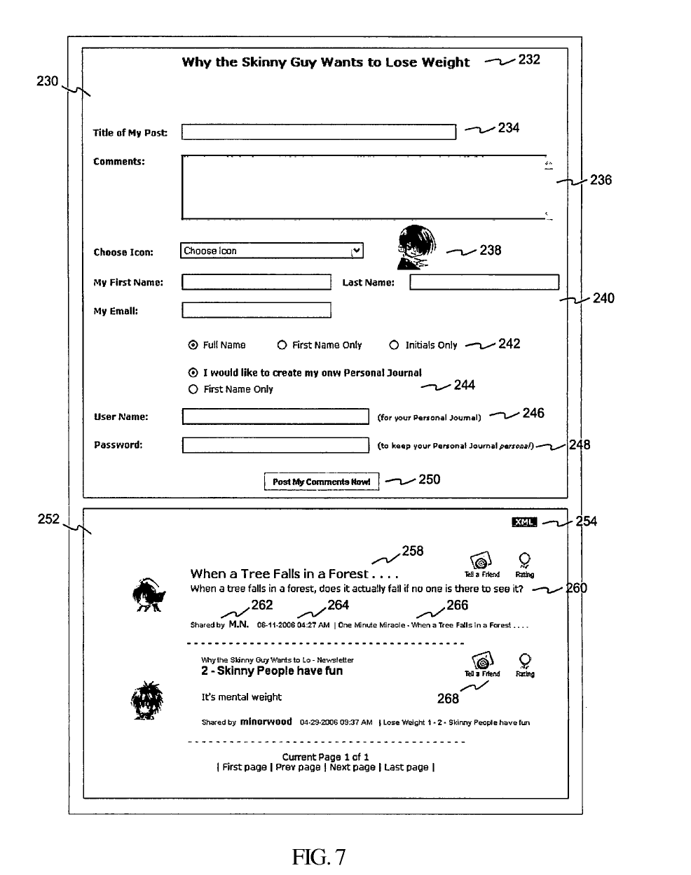

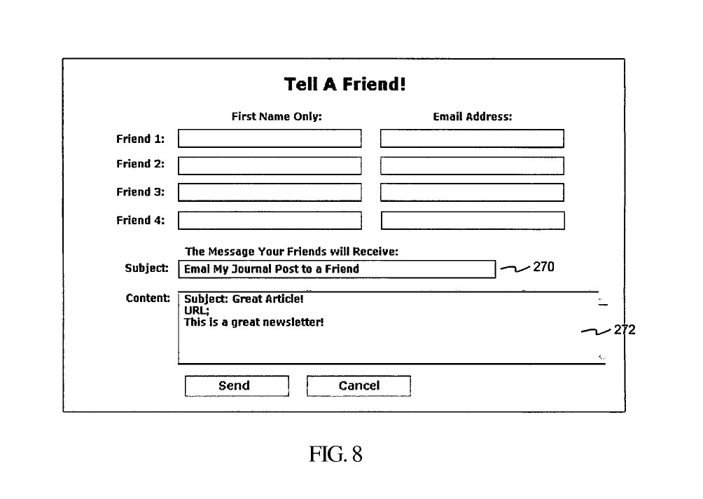

Referring to FIG. 6, an administrator page editor screen shot according to an example embodiment of the present invention is shown. Using this screen an administrator may monitor incoming end user posts created in the reader comment areas. The administrator may select a newsletter or other page 200. Pull down menu options 202 display the web page titles entered by the administrator for the selected newsletter or other miscellaneous page. A display page option 204 allows the administrator to view a popup of the display page for the selected title. A change page option 206 allows the administrator to view a popup of the original administrator page creator to change any item previously entered on that page such as titles, keywords, and auto responder codes. The selected title is displayed in the pull down menu option 202 and the administrator can select an option to display new posts or to hide new posts 208 depending on whether posts entered by end users should be automatically posted onto the display pages, or if they first should be manually approved for publication by the administrator. Hidden posts receive a grey background so the administrator knows at a glance they are hidden.

Each end user post may be displayed in a separate portion of the screen. The icon the end user selected appears with his or her post 210. The title 210 selected by the end user is displayed as well as the end user's comment 210. Also shown is the identifier 212 (name, initials, user name) selected by the end user. A publish option 214 enables the administrator to allow the end user's post to appear on the display page if the administrator had previously chosen to hide this post either via a hide post option 216, or the hide new posts option above 208. The hide post option 216 enables the administrator to hide any individual end user post from appearing on a display page. The entire post appears with a grey background when it is hidden so the administrator knows at a glance it is hidden. A delete post option 218 permanently deletes the post. An email-a-friend option 220 results in a popup that enables the administrator to email the end user who wrote the post (e.g., to thank them for posting, to ask permission to quote his or her post, etc.)

Posts may be selected (e.g., by selecting a checkbox next to each post) for printing, to appear in an eBook, or for other functions. A post counter may be used to tell the administrator how many total posts were received for each newsletter or miscellaneous web page.

Reader comments areas defined by administrators and comments entered by end users are hosted on a server and stored in database remote from the administrator's web site. An “iFrame” is used to allow this remote hosting. The iFrame provides a simple “window” to the database where all reader comments are actually entered, stored, and posted. However, in order for the actual “text” in the posts of the reader comment areas stored on the database to become part of the text on the local web site of the administrator, different formats for input and output are used. An “iFrame” is used for the actual input data fields while XML code is used for output data (the posts themselves). It is important for the actual text of the posts to be a part of the local site (i.e., the administrator's web site) rather than just being reflected there so that the administrator gets the benefit of using incoming posts for search engine optimization. The administrator does not receive this benefit if the text in the posts is not actually on the local site and remains solely in the remote database. By using iFrames for input and XML code for output, the administrator may have continually fresh keyword-rich content added to his or her site via end user posts.

Referring to FIG. 7, a display page screen shot for an example embodiment of the present invention is shown. The display page is the page that is created for public viewing. It is the page that results when an administrator uses the administrator page creator component to create reader comment areas for pre-existing web pages. Typically, the administrator places code generated in the administrator page creator below any pre-existing content on a web page to allow the reader comment areas and posts to appear at the bottom. The administrator can also place code for the reader comment areas in such a way that the reader comment areas appear at the very top of the page or any other area of the page relative to the pre-existing content. The web page content with the inserted code is then saved for posting at a web site. In FIG. 7, the title 232 is the only pre-existing content appearing above the reader comment area on this particular web page.

The display page comprises a reader comment input section 230. The reader enters comment data in this section of the display page. In the title field 232, the end user provides a title for his or her post. The end user enters his or her actual comment in the comment field 236. The end user can select an icon from the icon pull down menu 238 which has the icons the administrator originally uploaded in the administrator page creator. The end user enters a name in the name field and an email address 240. The end user can select an option for publishing his or her full name, first name only, or initials 242. The user name options from the personal journal page are not available on the display page because end users coming to the display page may not yet have signed up for a personal journal, and therefore, do not have a user name.

If the end user then chooses an option to create a personal journal 244, JavaScript Show-Hide Layer Code allows the appearance of the otherwise invisible user name and password fields 248. The end user chooses a use name for logging onto his or her personal journal and a password. These user name and password fields 248 remain hidden if the end user chooses a “just post my comments below without creating my personal journal” option 246. The end user's comments are posted with the selection of a post comments option 250.

The display page also comprises a reader comment output section 252. The post fields appear at the bottom of the display page in the reader comment output section. The most recent end user's post is posted first on the page rather than last. The advantage of publishing the most recent end user's post first is the immediate gratification it gives the end user of being “headlined,” versus stuck at the bottom of the webpage. An RSS option 254 enables web site visitors to create RSS feeds of the incoming posts on his or her own web sites if they like, or to view in other RSS-viewable places (e.g., choosing different RSS feeds is one of various preferences available to Yahoo.com's users). This option support further promotion of the administrator's web site.

The icon 256 for the post reflects the icon selected by the user from the icon pull down menu 238. The title 258 reflects the title entered by the end user previously in the title field 232. The comment 260 reflects the content entered by the end user in the comment field 236. The identifier 262 reflects the end user's choice for identifying his or her posts 242. Because the posts here also reflect posts made by end users in their personal journals, the identifier may reflect the end user's user name per that option uniquely available to end users posting from a personal journal. The date and time labels 264 reflect the date and the time the end user's post was made. The keyword label 266 reflects the keywords the administrator chose in the administrator page creator screen (FIG. 4). The combination of the keyword label 266 and the title listing 258 makes a dynamic keyword-rich page thus making it highly optimized to receive search engine traffic.

A tell-a-friend option 268 displayed next to each post results in a tell-a-friend popup. This feature enables the end user to email any post to multiple friends, which brings more traffic to the site. A rating option 268 may also be added next to each post to allow the end user and other visitors to rate every post on the page (e.g., 1=I didn't like this post; 2=1 liked this post; and 3=1 loved this post!). This option enables the administrator to create a contest for web page postings. As an incentive to get end users to write more posts, the administrator can award prizes to the top-winning end user poster for a given period of time.

Referring to FIG. 8, a tell-a-friend screen shot according to an example embodiment of the present invention is shown. This figure shows a standard tell-a-friend script that enables the end user to simultaneously email multiple friends to tell them about the web site they have just visited. It is coupled directly to the posts generated by end users. The entire tell-a-friend page can be made to automatically appear in a popup window when an end user enters a post on the display page or in his or her personal journal. The administrator page creator screen allows the administrator to automatically provide a subject line for the message 270 and to type any message into the message field 272 of the tell-a-friend page to provide the end user with a readily available message for the end user to tell a friend. The message includes a dynamically-generated URL that refers the end user's friend to the dynamically-generated “look-at-me-page” (as described below) which always highlights the end user's post.

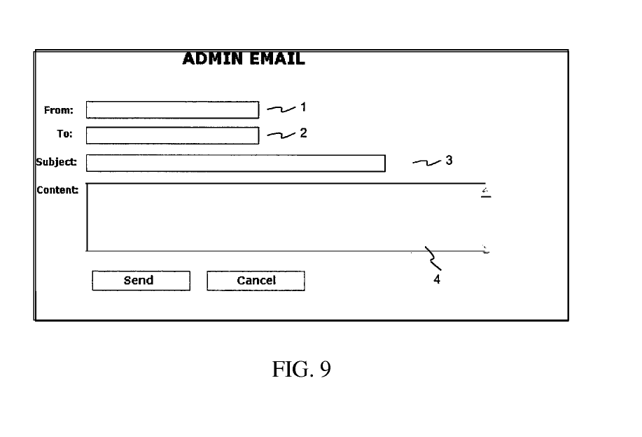

Referring to FIG. 9, an administrator email screen shot according to an example embodiment of the present invention is shown. This figure shows a standard email script that enables the administrator to email the specific end user who made a post. The administrator selects an email option from the administrator page editor screen. The email option of the administrator page editor is linked for easy use to every post generated by end users. The “From” field is automatically populated with the administrator's name and email address. The “To” field is automatically populated with the end user's name and email address obtained when the end user made his or her first post either on the display page, or when he or she signed up for a personal journal on the login/sign-up screen. The content field can be made to automatically populate with any script the administrator entered into the administrator page creator. In the administrator page creator, any message can be input and automatically sent to every end user making a post.

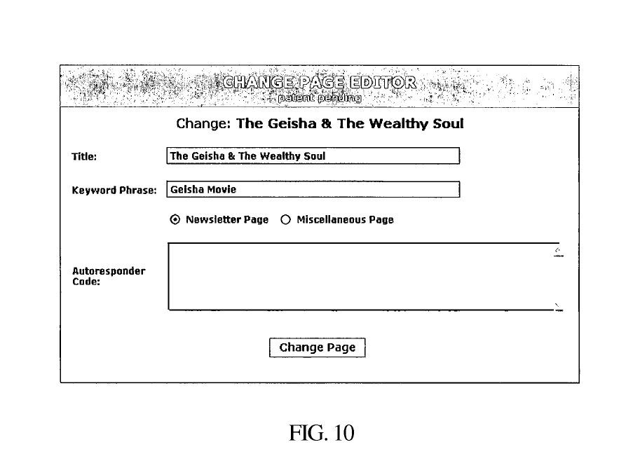

Referring to FIG. 10, an administrator change page editor screen shot according to an example embodiment of the present invention is shown. This screen is virtually identical to the administrator page creator of FIG. 4. An important difference is that all of the fields are auto-populated with the information the administrator previously entered to create a specific page. This change page editor screen allows the administrator to update or change previous settings appearing on the display page of FIG. 7. The change page editor screen is accessible to the administrator via the change page option on the administrator page editor screen of FIG. 6.

A “look-at-me page” may be virtually identical to the display page of—FIG. 7 except for its URL. The URL for the “look-at-me page” is dynamically generated, and it features the end user's posts at the top of the comments section, highlighting them in any variety of ways such as by displaying them in different background colors and designs compared to the other posts, or bordered by stars, in bold, etc. The end user may be provided with various options for highlighting his or her own posts. The end user may also choose which posts to make public and which to keep private. End users may be much more inclined to publicize their own posts if they can personalize them for others. It also results in promotion of the administrator's site using the tell-a-friend feature in FIG. 8 because the end user's post is the highlight of the “look-at-me page.” The feature allows the end user to perform the functions of a “secondary administrator” and promote greater use of the primary administrator's web site thereby greatly increasing the primary administrator's traffic.

A contest generator page hosts the results of end-user post rankings using web site visitors' ratings of the various posts via the ratings feature on the display page of FIG. 7. It features a list of numerically ranked end users names according to his or her scores, highest to lowest. An administrator area of this page contains another entry field that allows the administrator to specify date ranges within which to calculate the scores. Another entry field allows the administrator to specify how many points he or she wants each end user to automatically receive per each post entered. This approach rewards people who post frequently, thus encouraging active participation of end users. The administrator can determine what prizes will be rewarded for each winner.

A “create blog” feature allows each end user to create a blog that displays just his or her posts, and just the ones they choose to make public via checkmark boxes that appear next to each of his or her posts. The end user performs the functions of a “secondary administrator,” and promotes greater use of the primary administrator's web site thereby greatly increasing the primary administrator's traffic.

An eBook feature allows each end user to create an eBook of all his or her unique “look-at-me” pages. The end user chooses which posts to include in the eBook. This feature automatically puts all selected posts into an MS Word format or a pdf. format, per his or her own choosing. It also includes various cover template designs, table of content designs, and overall book designs. The administrator may also be eBook creator by creating ebooks of reader comments. The ebooks may be sold or distributed as a “virtual marketing tool.” End users whose comments appear frequently in an eBook may be inclined to distribute the eBook to others.

An end user greeting card creator feature enables the end user to send his or her posts as virtual greeting cards. This feature may be used in addition to or instead of the tell-a-friend emails and provides another dynamic marketing tool for the administrator's web site.

A comment rotator and emailer feature allows an administrator to rotate posts appearing at the top of each web page. The posts may be rotated daily or more frequently throughout the day. An email may be sent automatically to each particular end user at the time his/her post is headlined. This feature creates a reason for the end user to revisit the web page and to refer friends to it.

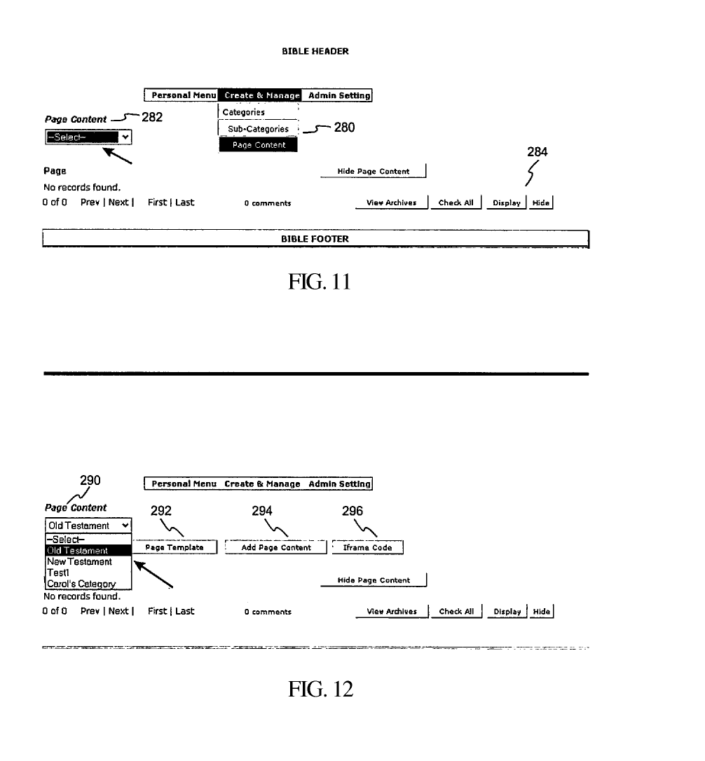

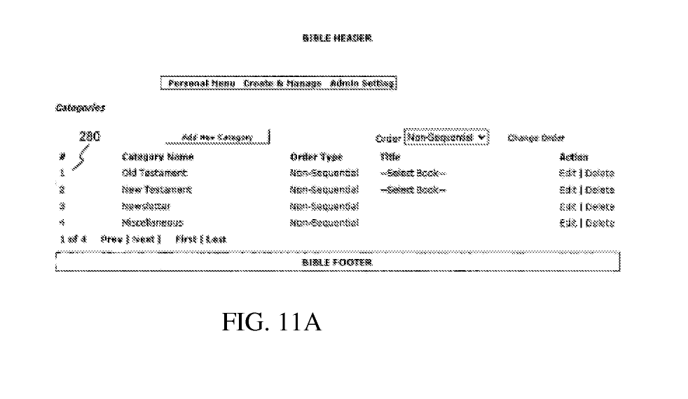

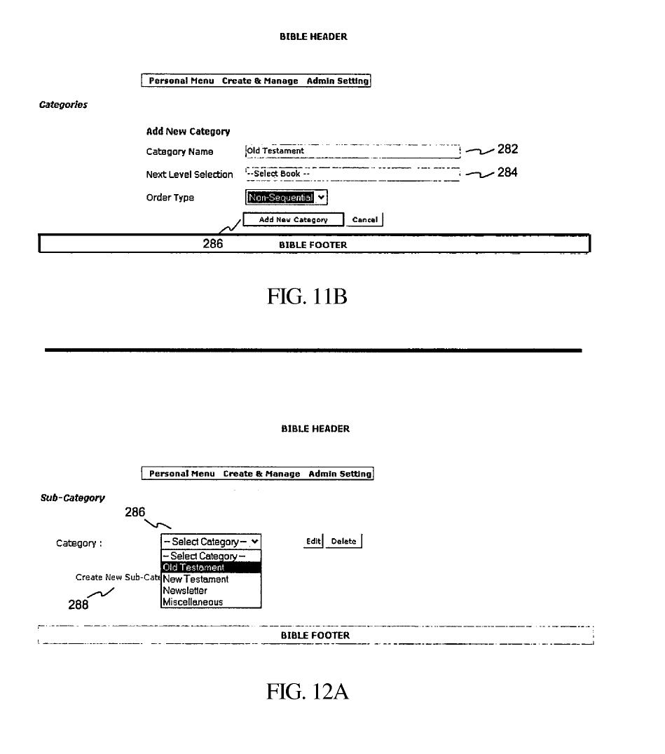

Referring to FIGS. 11-16, screen shots for administrator category creation according to an example embodiment of the invention are shown. The administrator may create categories, subcategories, and page content as he or she chooses so that the administrator can use his or her own preferred way of classifying the web pages for a site. Referring to FIG. 11, the administrator selects “categories,” “sub-categories,” or “page content” from a create and manage menu 280 in order to create a preferred classification for web pages. The administrator may create a plurality of categories and sub-categories from which to choose when creating and classifying web pages. The web page classification also facilitates end user selection of content for which the end user would like to provide comments. The administrator selects a category or sub-category to be associated with web page content 282. Additional options for managing created web page content include options for viewing archive pages, selecting pages, and displaying/hiding pages are also provided 284.

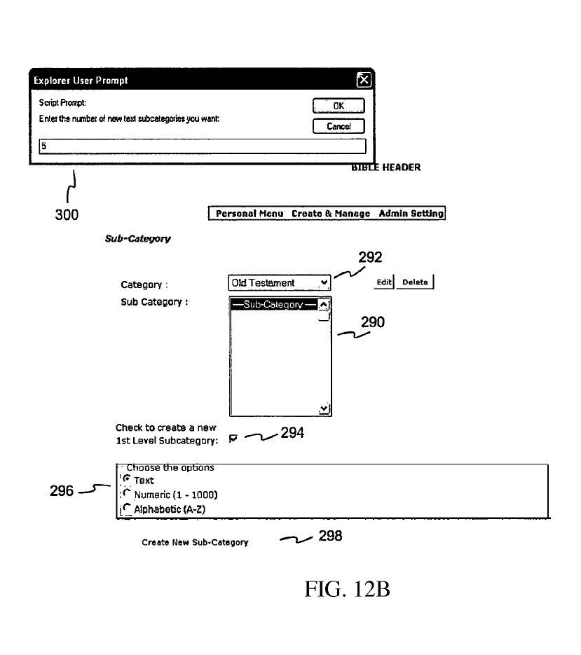

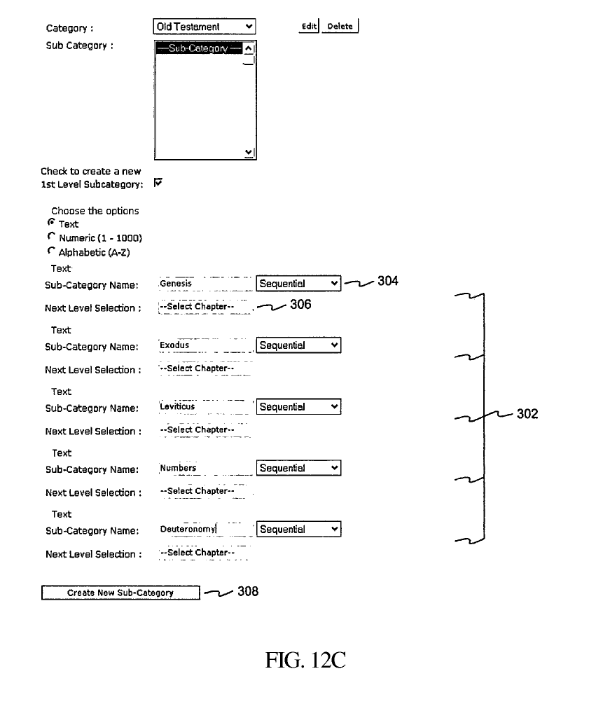

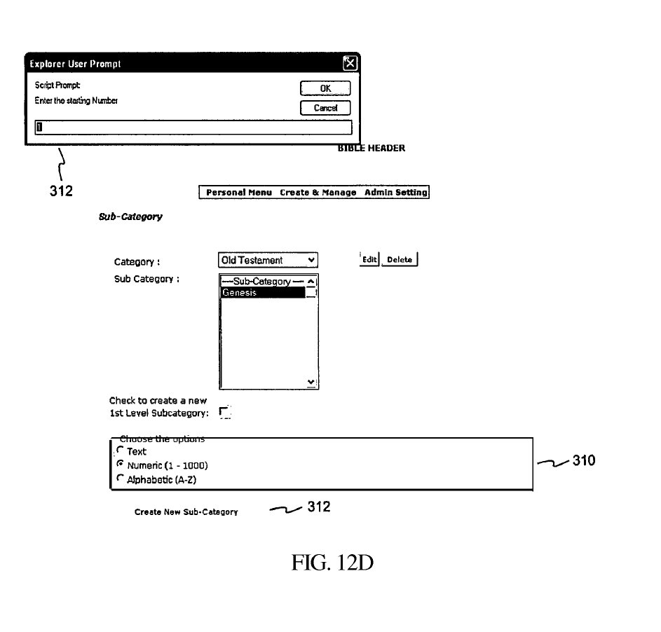

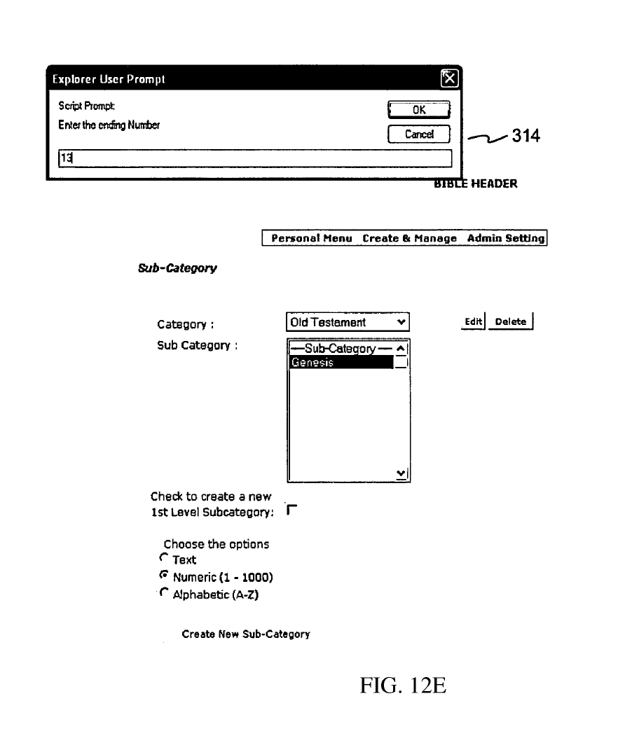

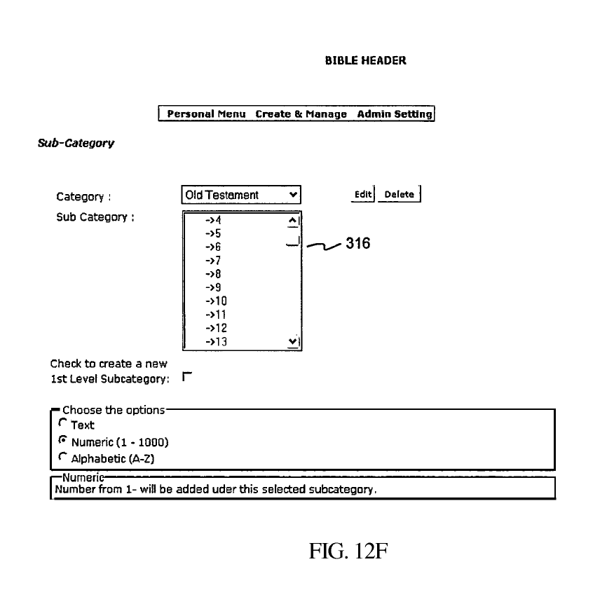

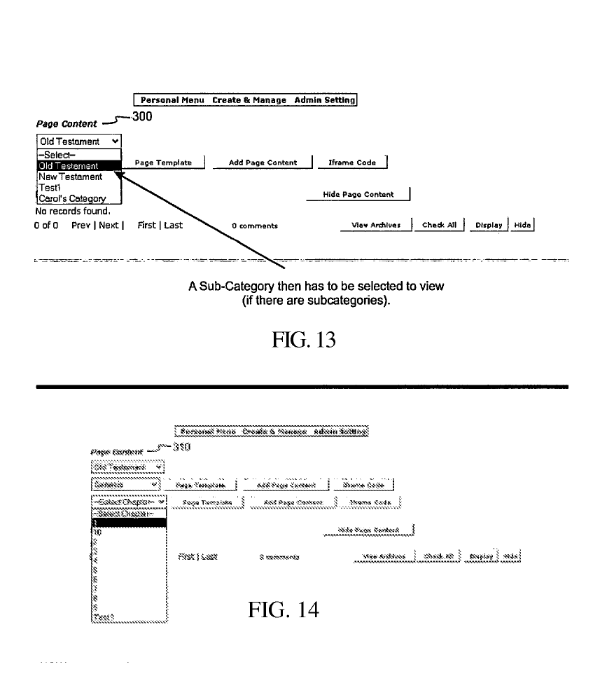

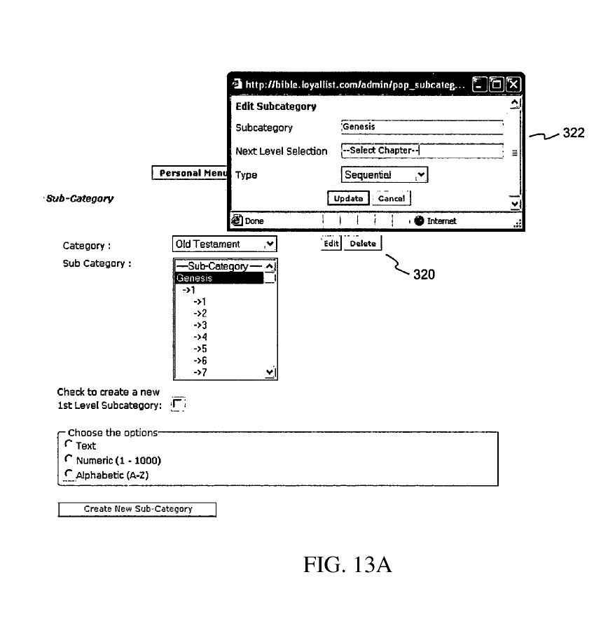

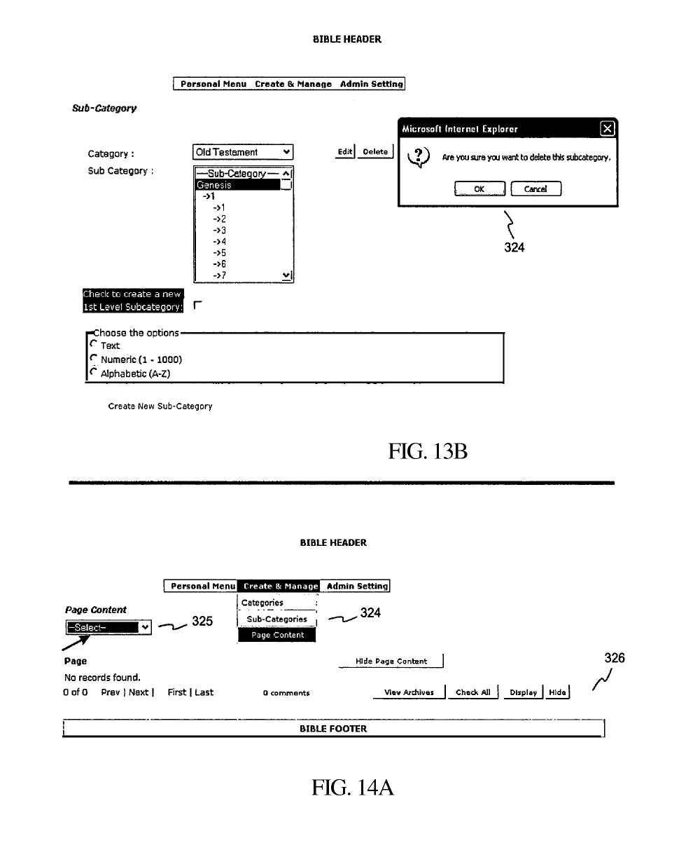

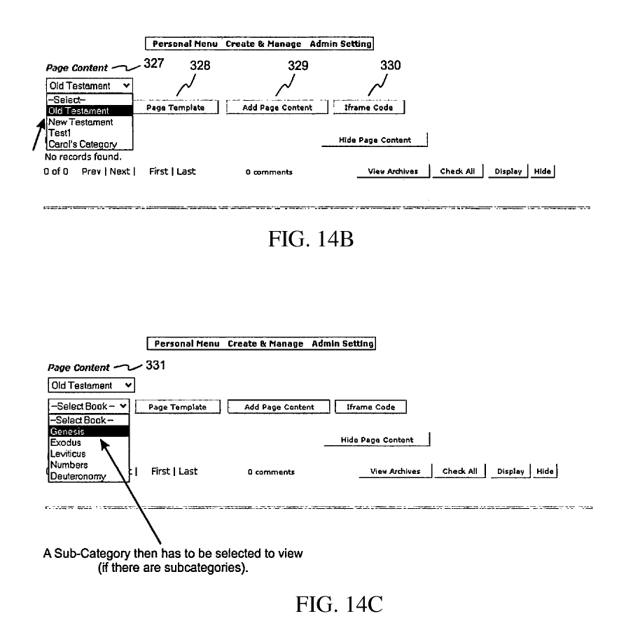

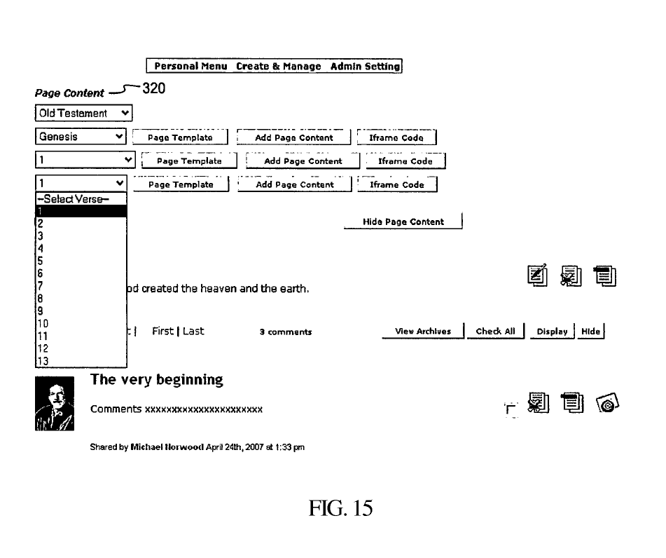

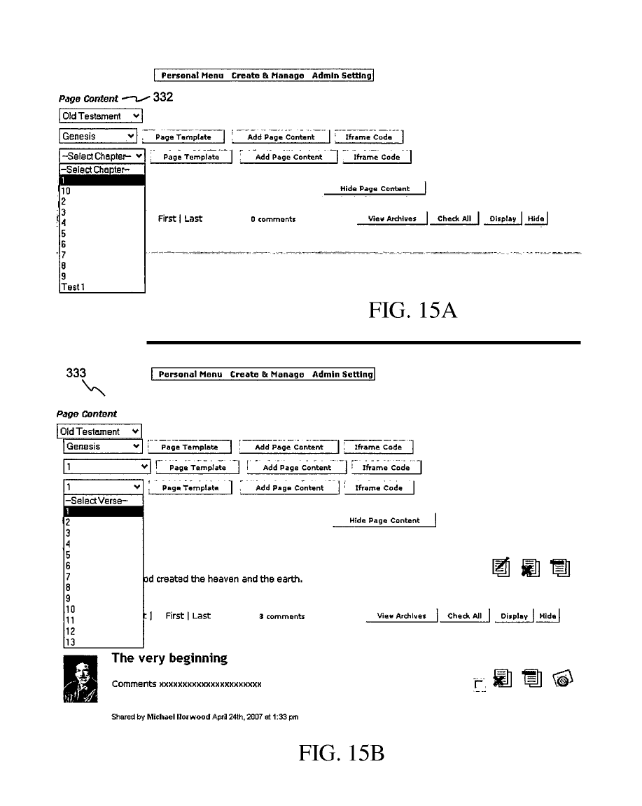

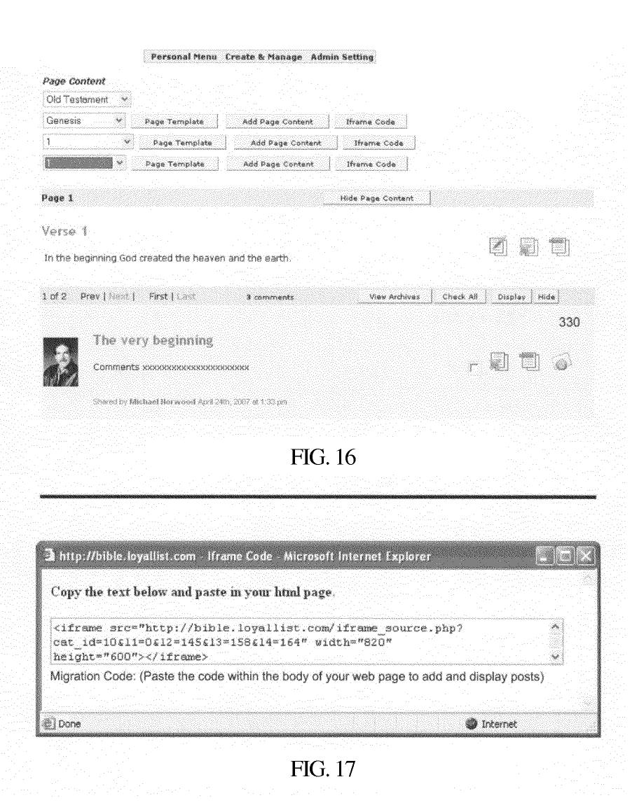

Referring to FIG. 12, the administrator selects a category 290 (e.g., “Old Testament.” The administrator may further select a page template 292 for creating the web page, an option to add page content 294, and an option to add iFrame code 296 to a web page to create a reader comment area on a web page associated with the specified category. Referring to FIG. 13, following selection of the category, the administrator may select a first sub-category 300 (e.g., “Genesis”). Referring to FIGS. 14 and 15, additional sub-categories may be selected (e.g., “Chapter 1” 310 and “Verse 1” 320). Referring to FIG. 16, the administrator may then specify content to be associated with the specified categories and sub-categories 330. Referring to FIG. 17, sample iFrame code according to an example embodiment of the present invention is shown. The iFrame code to be associated with the specified content is generated so that it may be added to HTML code for the web page. The iFrame code provides access to the reader comment area for the specified portion of the web page. Comments provided by end users are then associated with the specified portion of the web page through the reader comment area. When comments are entered by readers of the web site, they are saved in a database remote from the administrator's web site.

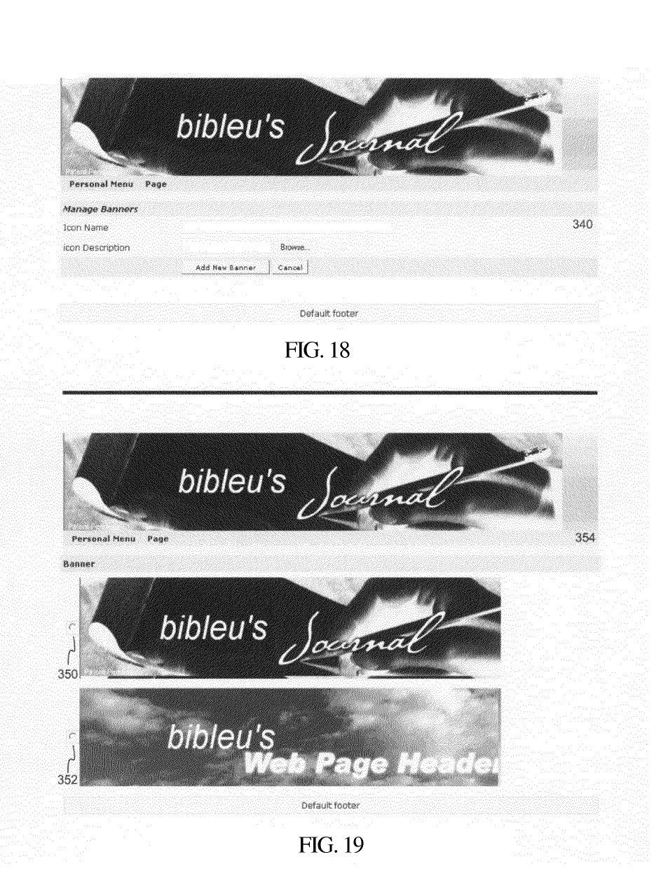

Referring to FIGS. 18 and 19, screen shots for creating and managing banners according to an example embodiment of the present invention are shown. Referring to FIG. 18, an administrator can define various icons 340 to be used as banners for a web page. Referring to FIG. 19, an administrator can select a banner 350, 352 to be used in association with a specified web page. The selected banner may be displayed at the top of the page.

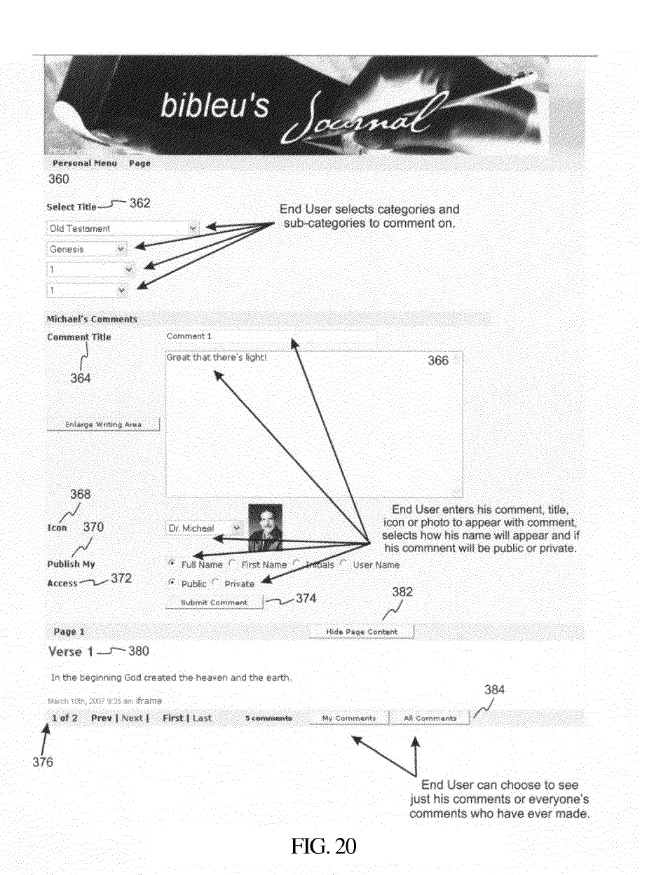

Referring to FIGS. 20-22, sample end user comment screen shots for an example embodiment of the present invention are shown. The screen may comprise a reader comment input section 360 and a reader comment output section 376. Referring to FIG. 20, using the categories and sub-categories defined by the administrator, the end user can specify a category and sub-categories to select a portion of a web page on which to comment 362. In the comment area of the screen, the end user specifies a comment title 364 and enters his or her comment in a text area of the screen 366. The end user may further specify an icon to be associated with the comment 368. The end user may also specify an identifier to be associated with the comment 370 (e.g., full name, first name, initials, or user name). The end user may also decide whether to make his or her comments public or private by specifying an access option 372. After providing the requested input, the end user selects a submit comment option 374 to post the comment publicly or privately depending upon the access option selected.

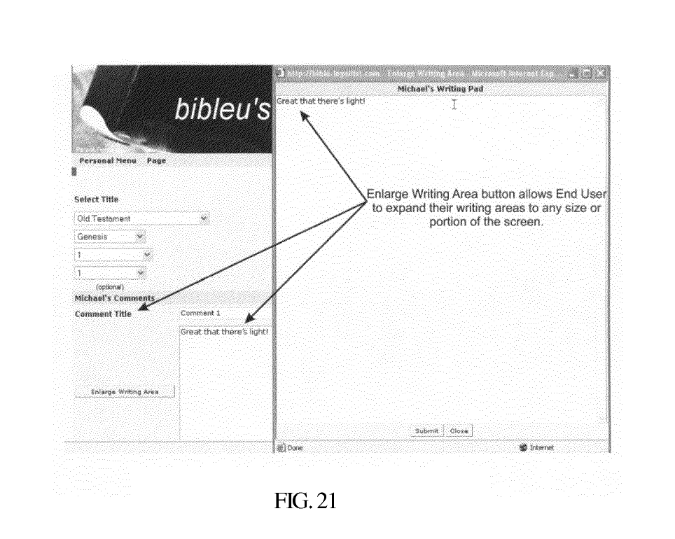

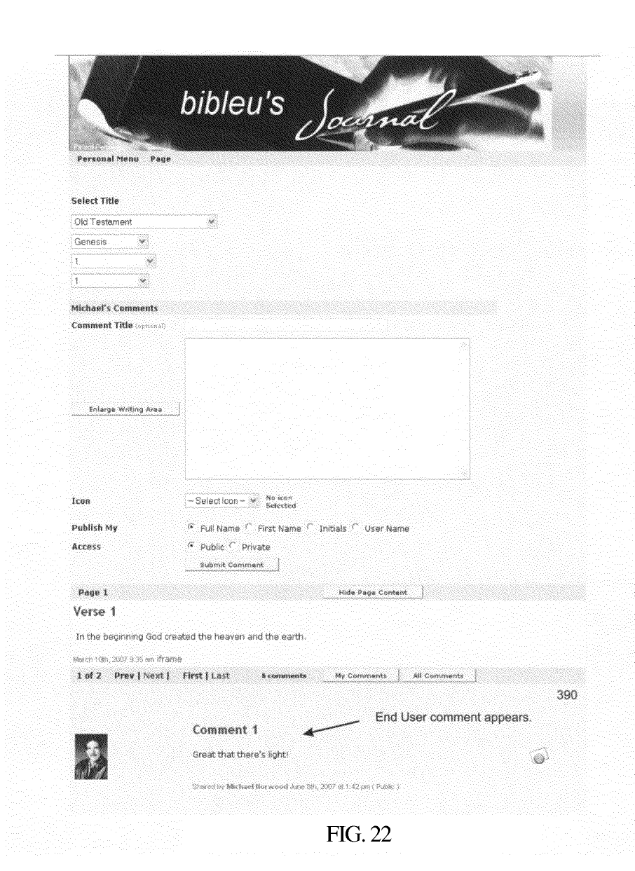

The end user's comment is displayed in the reader comment output section at the bottom of the screen 376. The comment is displayed 380 along with a time stamp indicating when it was entered. The user may select an option to hide the comment once it has been entered 382. The end user can also choose to see only his or her comment or all of the comments entered by other users 384. Referring to FIG. 21, a screen shot for an enlarged writing area option according to an example embodiment of the present invention is shown. Referring to FIG. 22, another sample end user comment screen shot according to an example embodiment of the present invention is shown. As shown in the reader output section 390, the end user's comment appears as it will on the display page for the web site.

Technical details related to the category/sub-category feature of the present invention are as follows. AJAX framework (HTML_AJAX) controls AJAX functionalities for the present invention. The code <?php $utils->get_category_list(‘slt_category’,“onchange=\”sendSubCategory(this.value);showOther( )\“ ”);?> loads a list of categories in the Manage Sub Category page (manage_sub_category.php) page. A utility class is defined in a classes folder (root_folder/classes/utils.class.php) which is a collection of utility functions. This class has many functions including redirecting and displaying JavaScript message, and listing many other functions. The above function get_category_list( ) is defined in a root_folder/classes/utils.class.php file which will that takes some parameters and lists the all the categories made by the current administrator.

When the selection of items listed in the category dropdown list is changed, an onchange event (onchange=\“sendSubCategory(this.value)) is called in this function and this sendSubCateory(this.value) sends the selected item id to sendSubCategory(cat_id) javascript function defined in the current page. After the a value is passed to sendSubCategory(cat_id) function and parameter values are passed to the function, it hides the Options Panel and sub category Panel if the passed parameter value is 0. Otherwise it creates an instance of object of review class defined in root_folder/ajax_classes/review.class.php.

After the instance of object of review class is created using javascript, a last line of code defined in the function sendSubCateogry(cat_id) registers a php function loadSubCategory(cat_id,”) defined in review.class.php class file. While using HTML_AJAX framework in our program we have to register our user defined class to the ReviewServer defined in root_folder/ajax_claases/auto_server.class.php. After the loadSubCategory(cat_id) is called this function connects to the database and loads all the subcategories under selected category and return to the JavaScript. Again there is a function called loadSubCategory: function(result) which is a part of HTML_AJAX. This retrieves the HTML and reloads the sub category drop down box. The options panel is also visible.

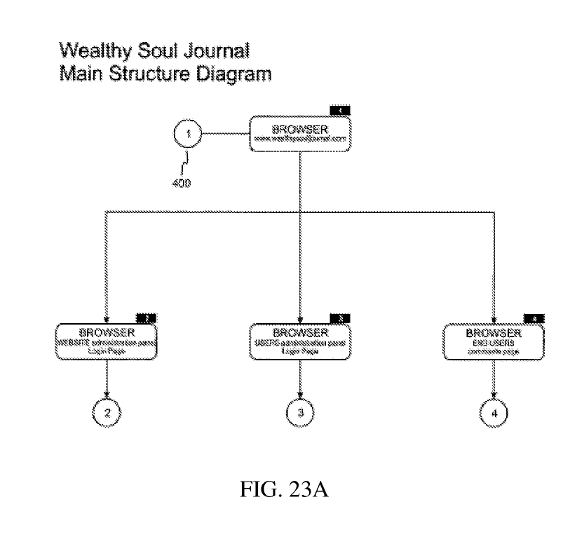

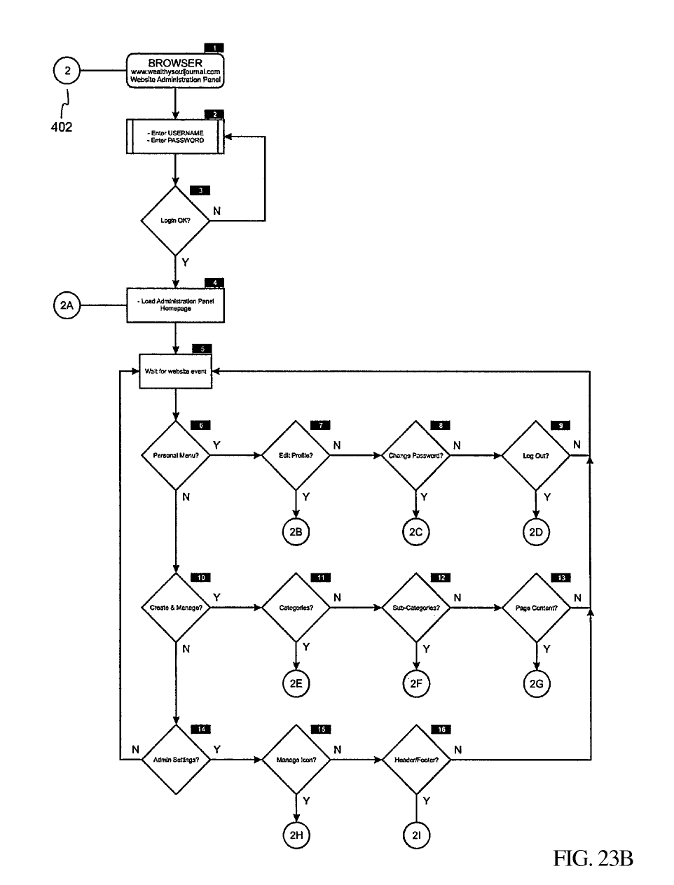

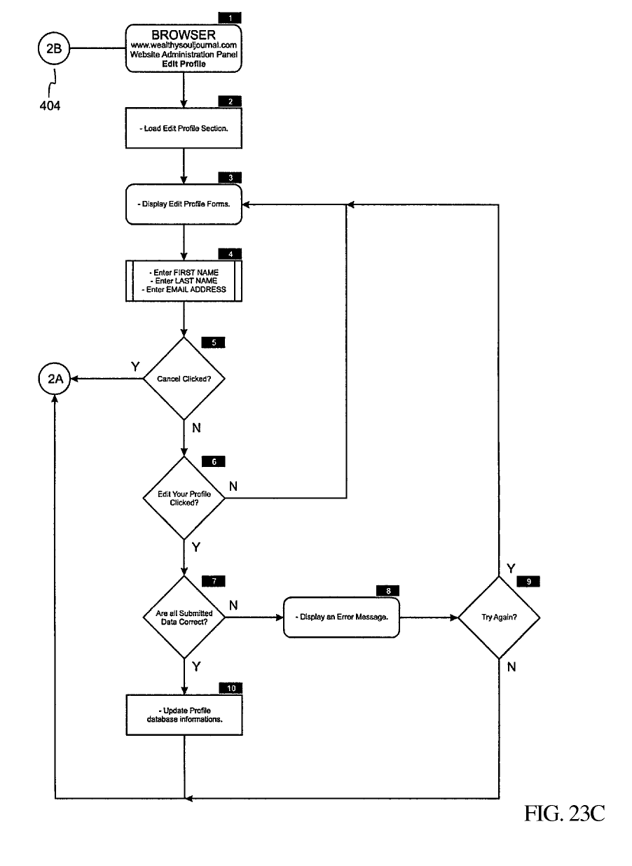

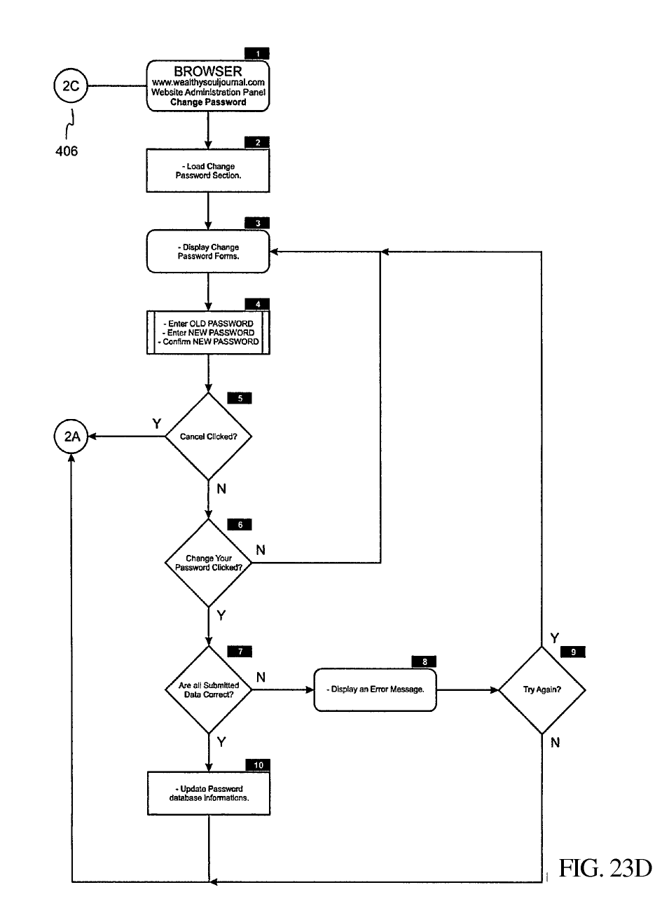

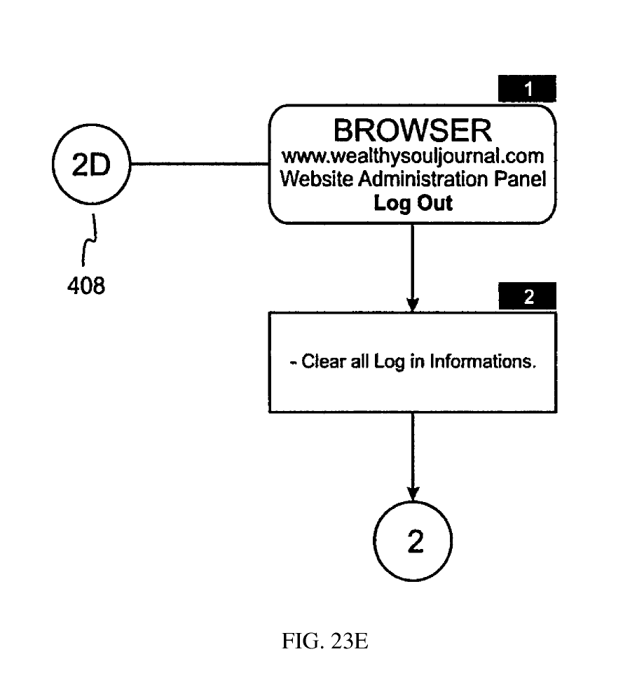

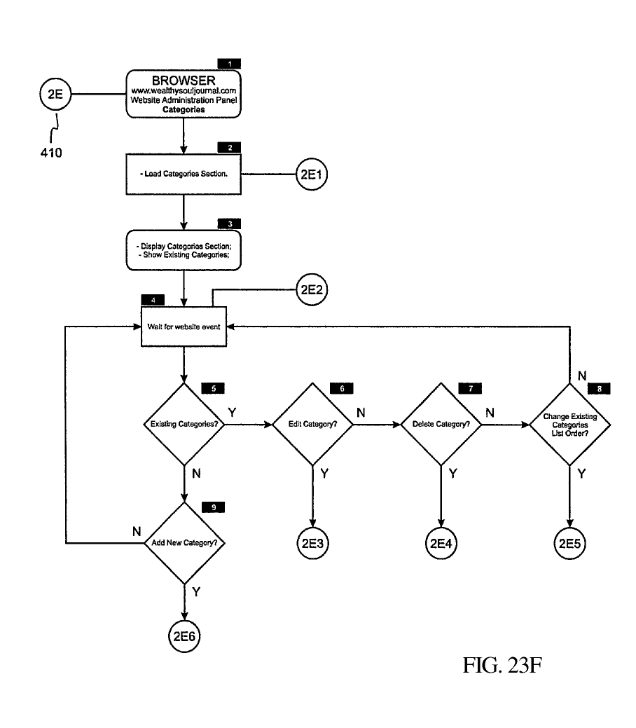

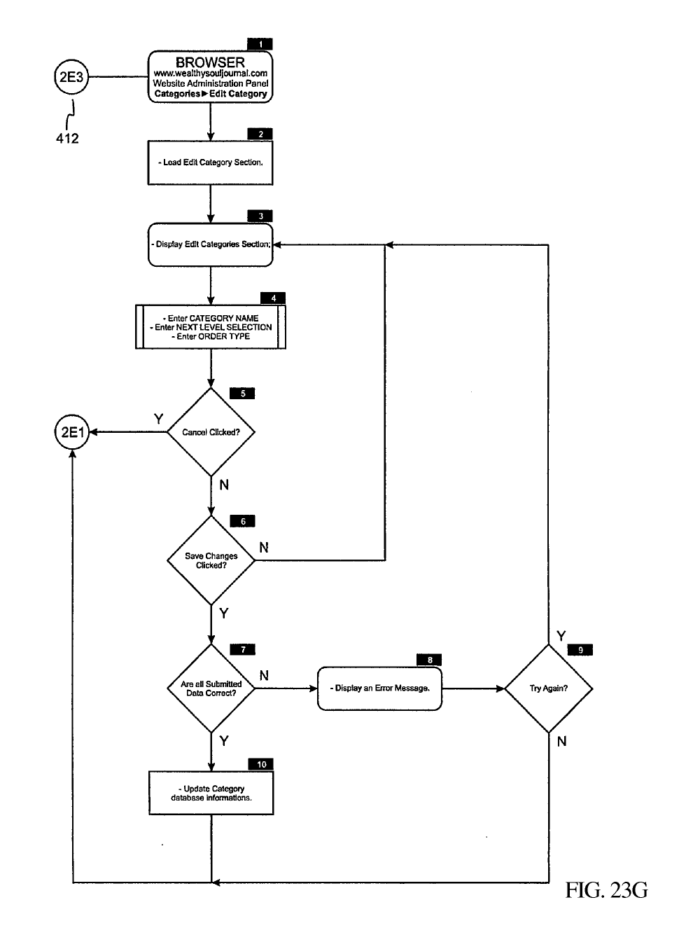

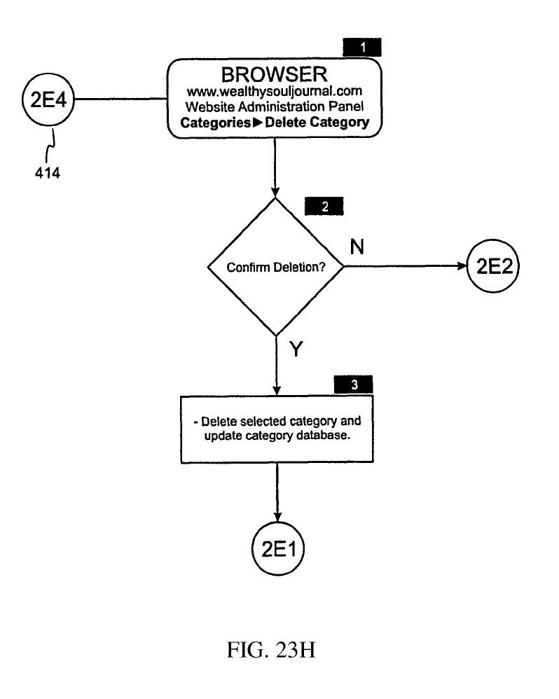

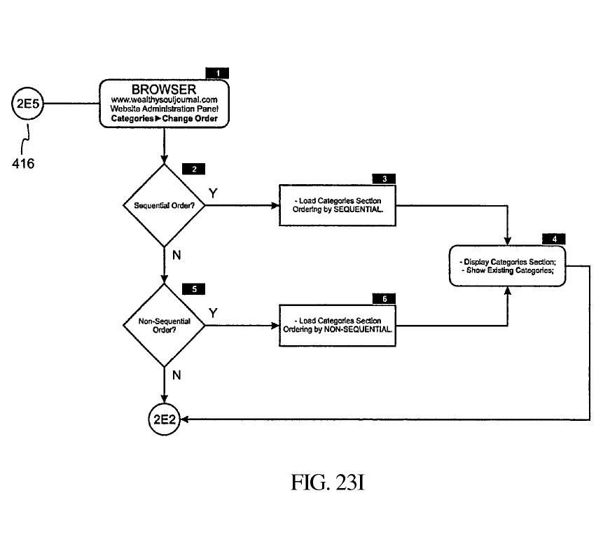

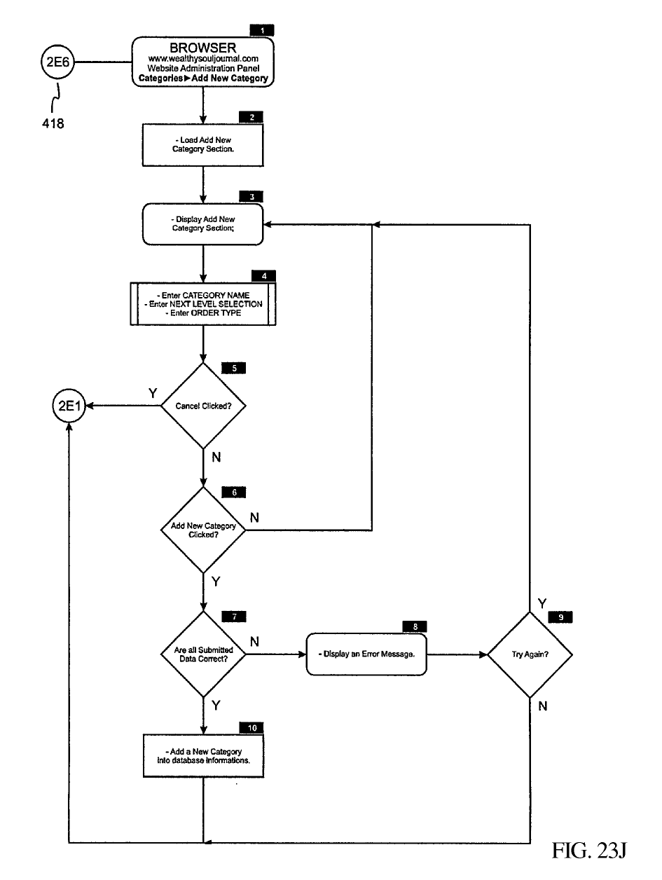

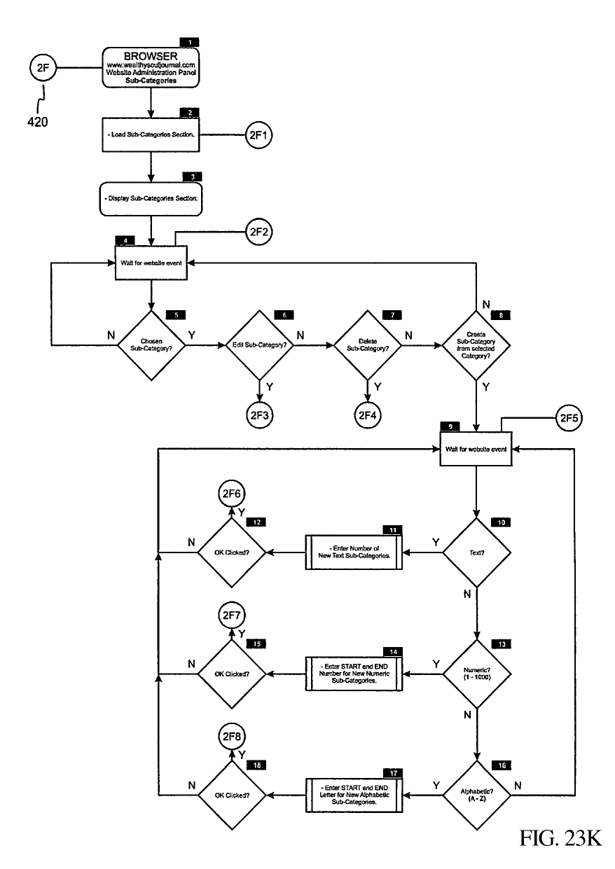

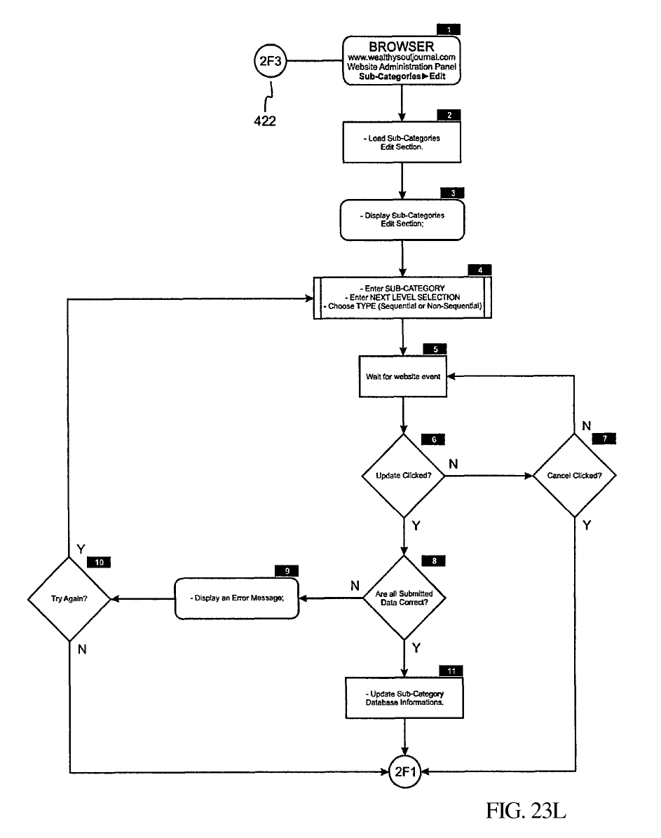

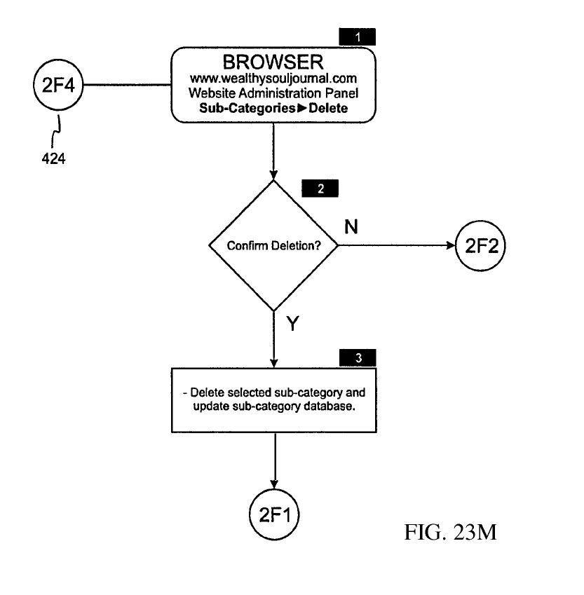

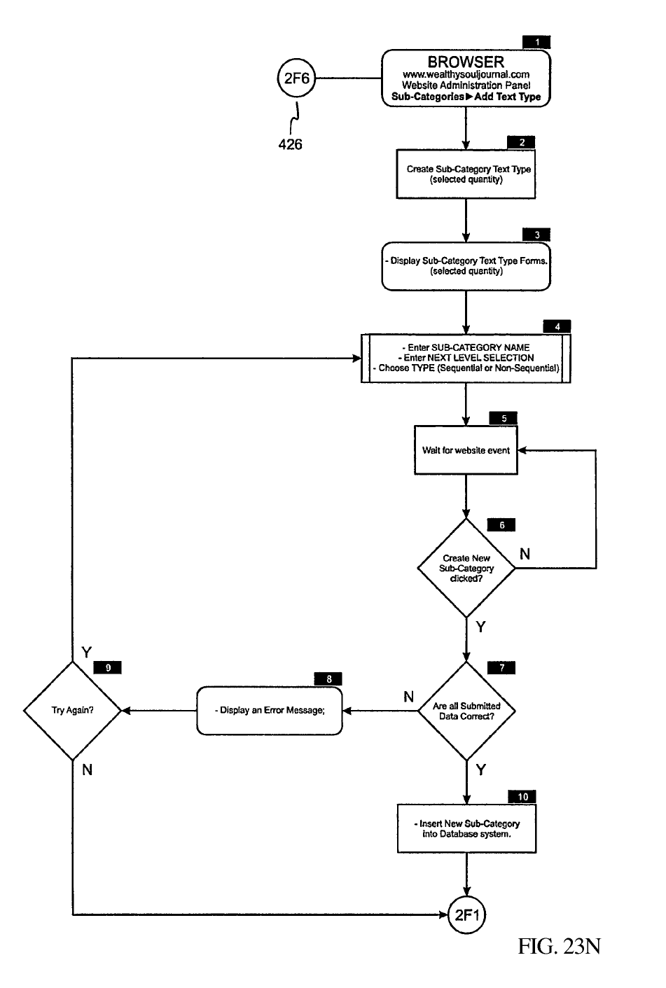

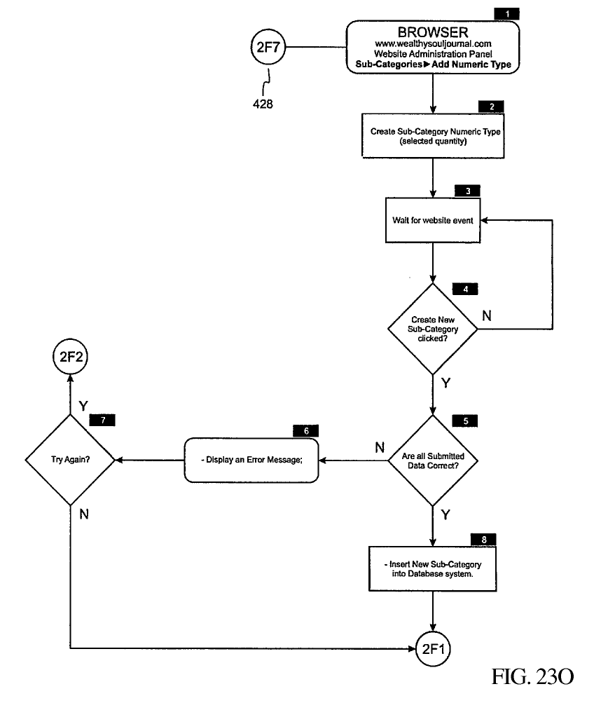

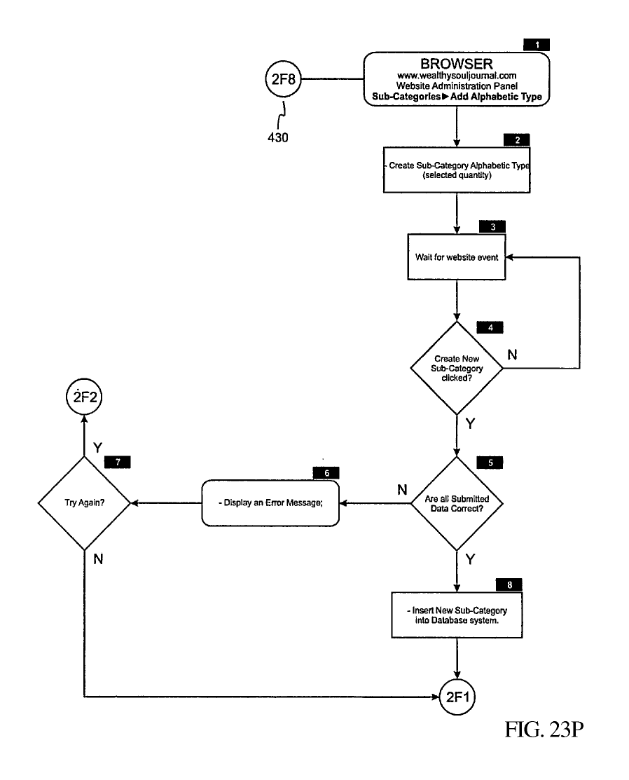

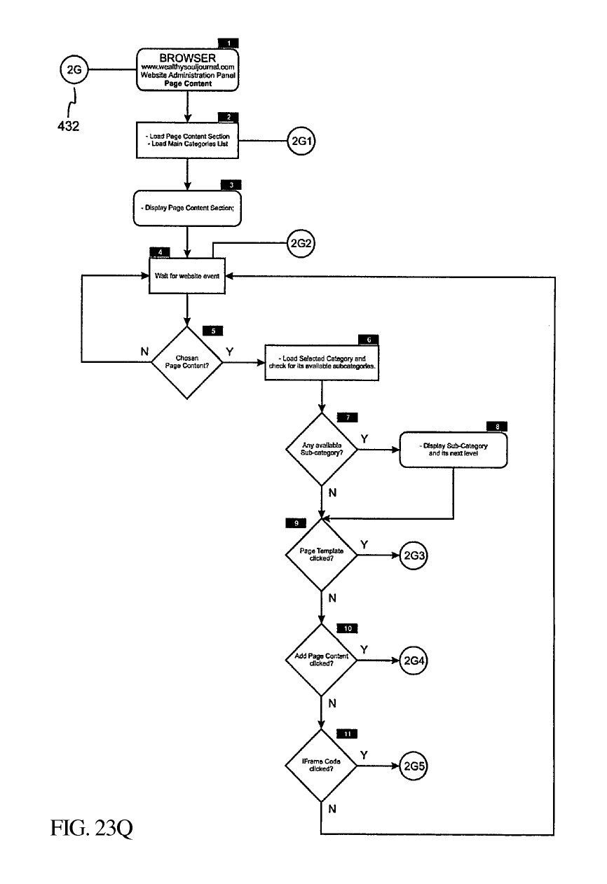

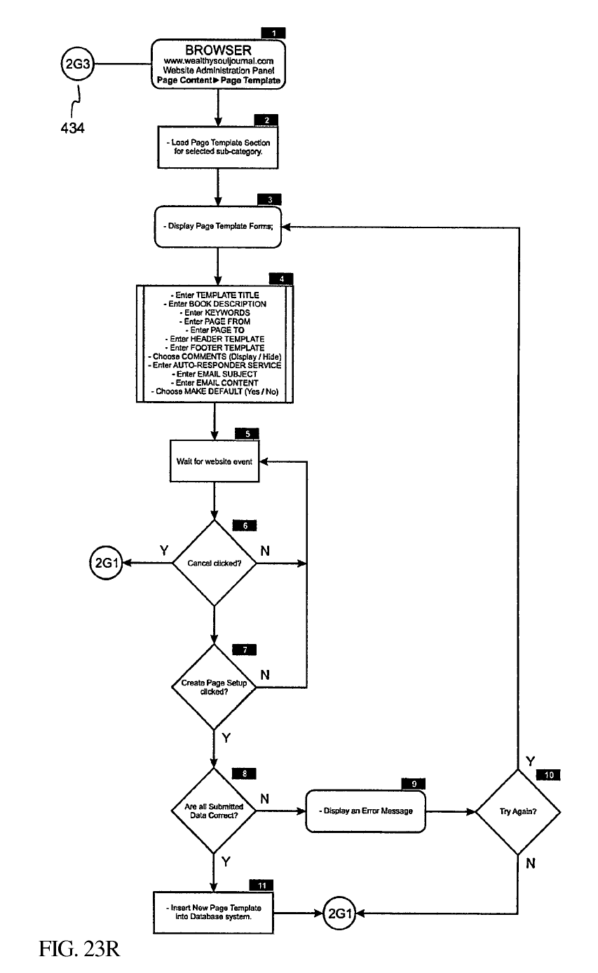

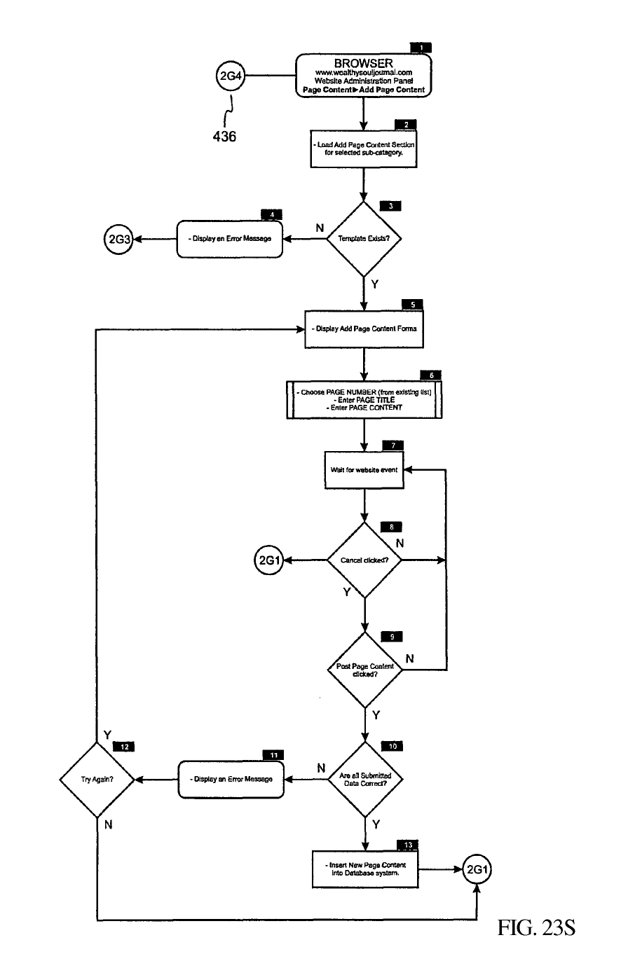

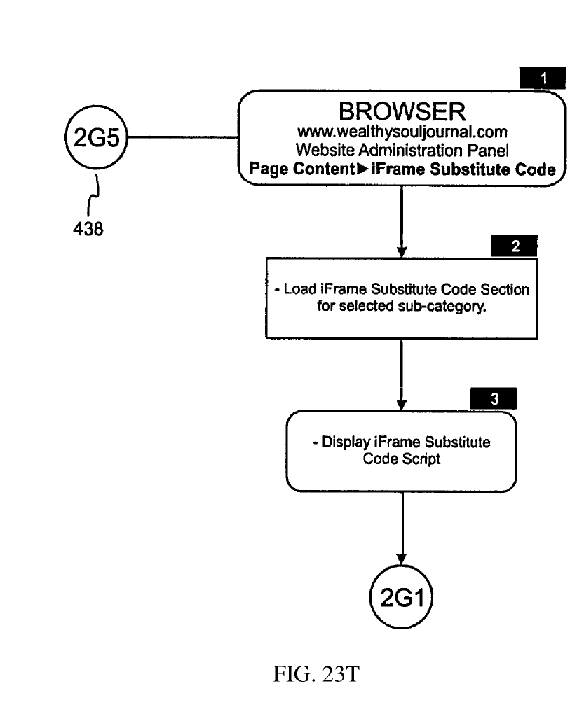

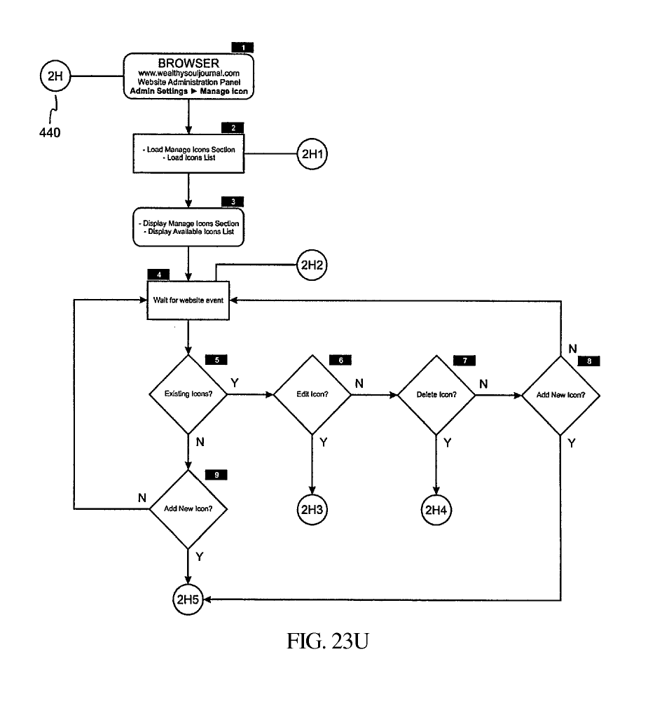

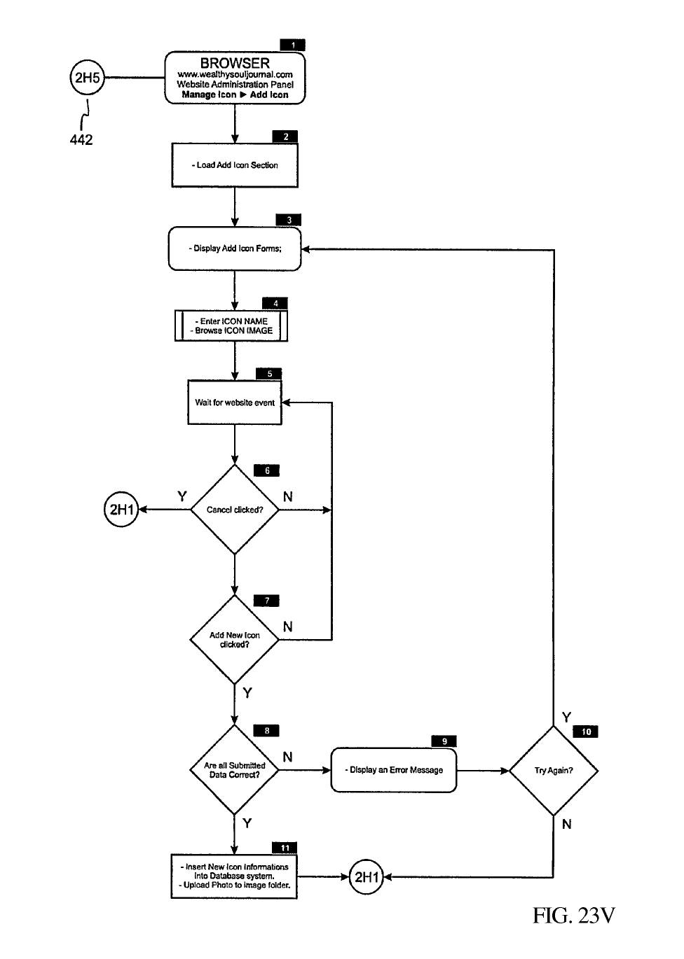

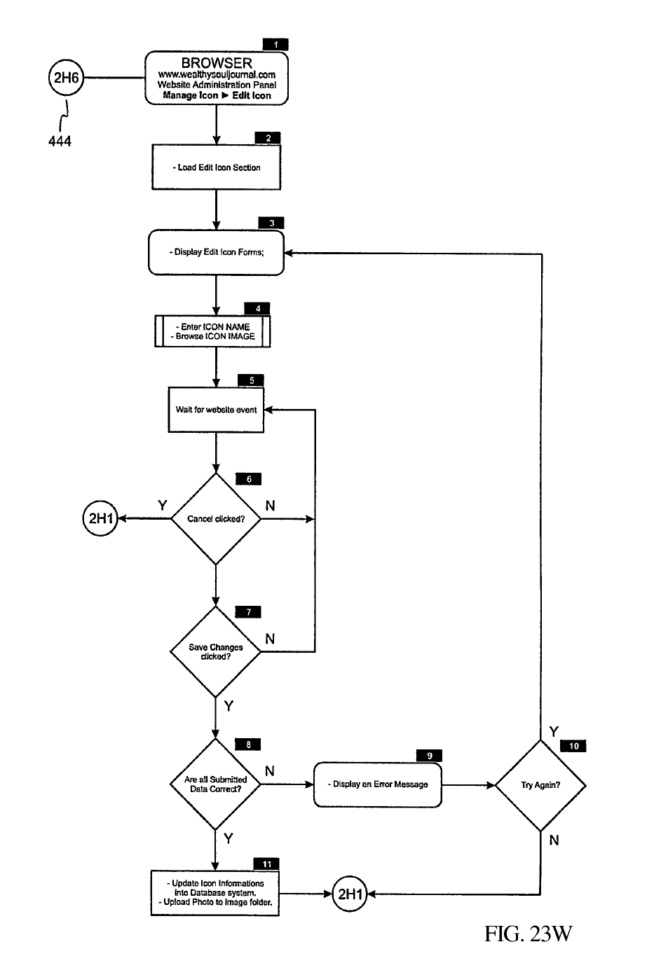

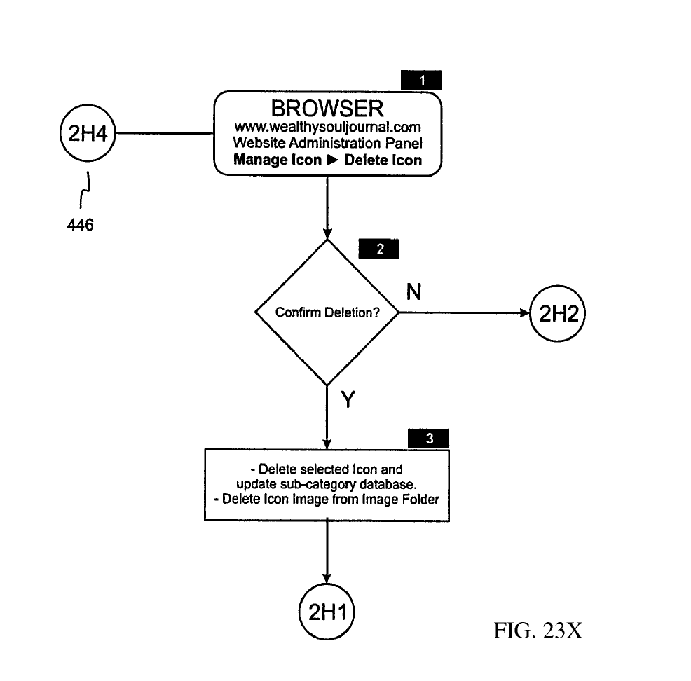

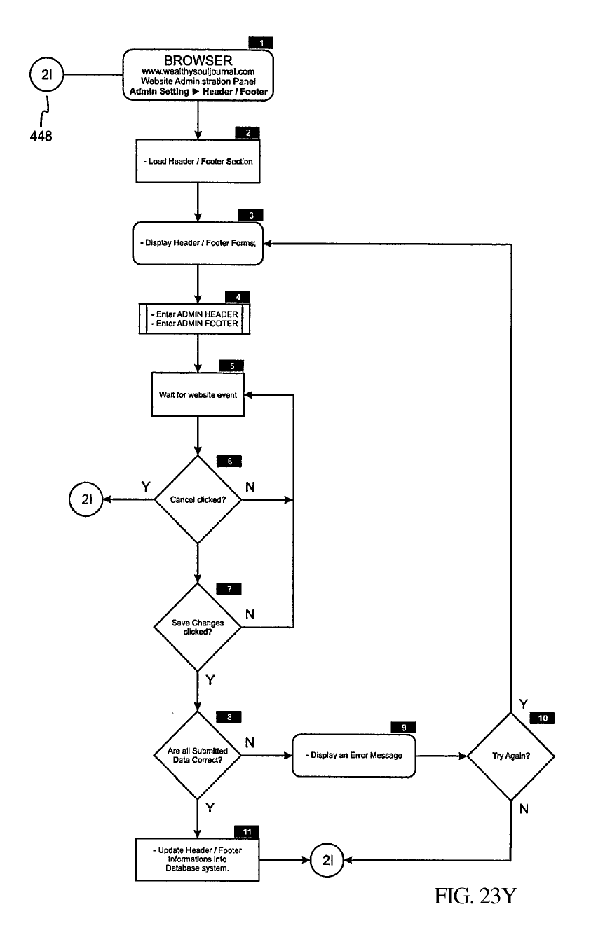

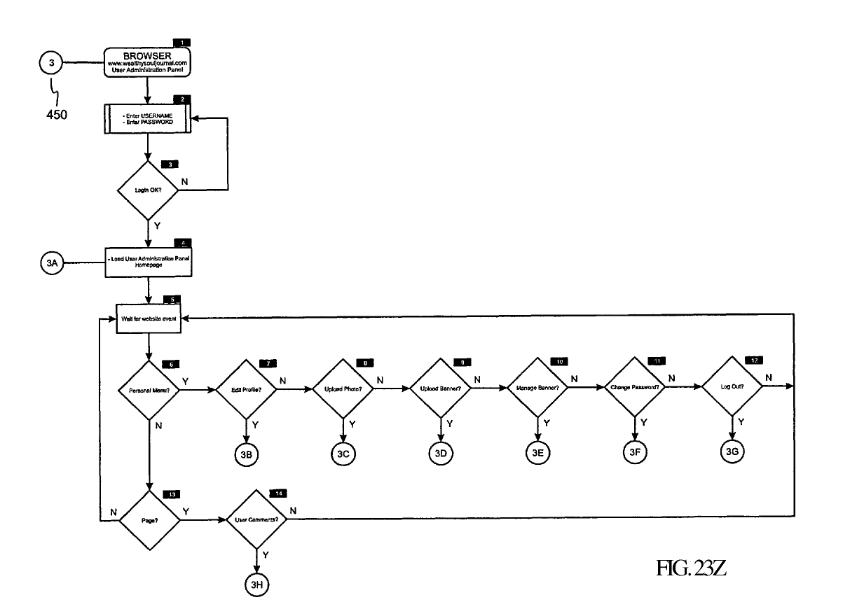

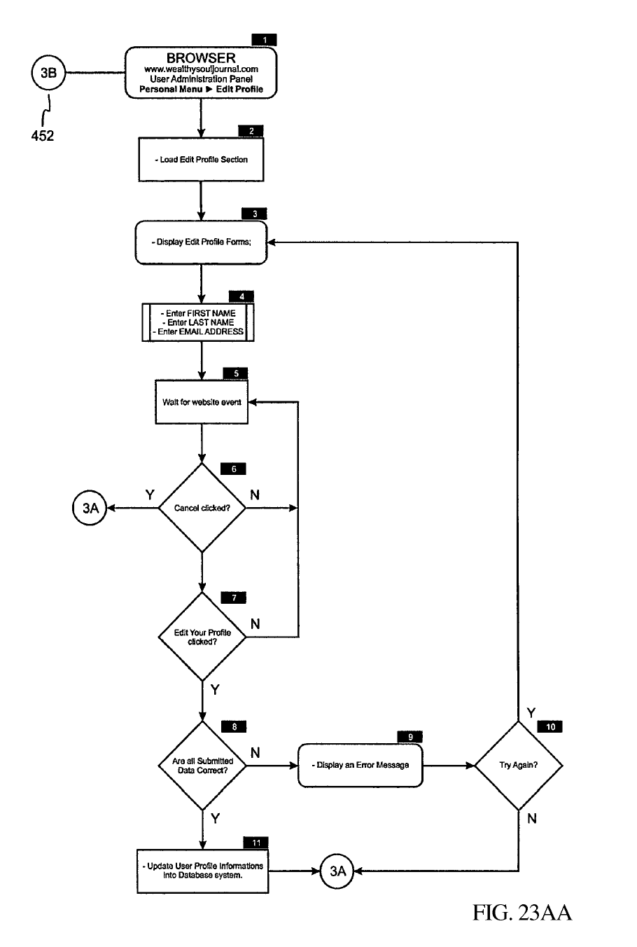

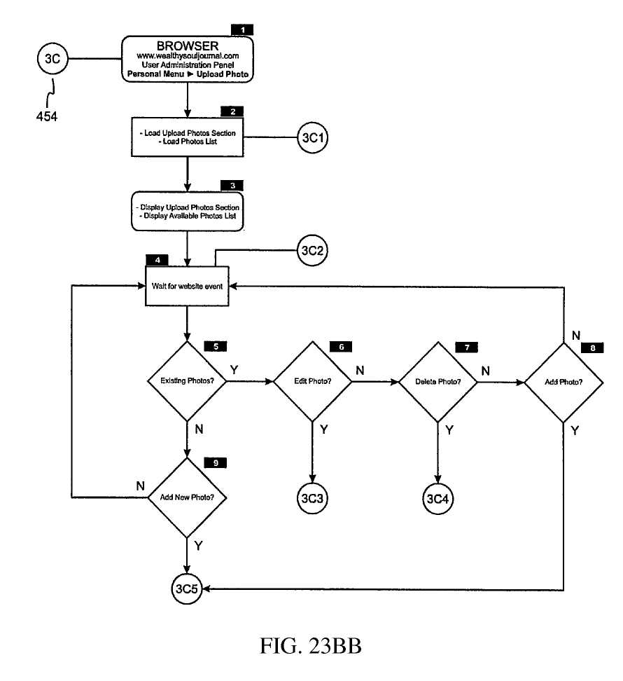

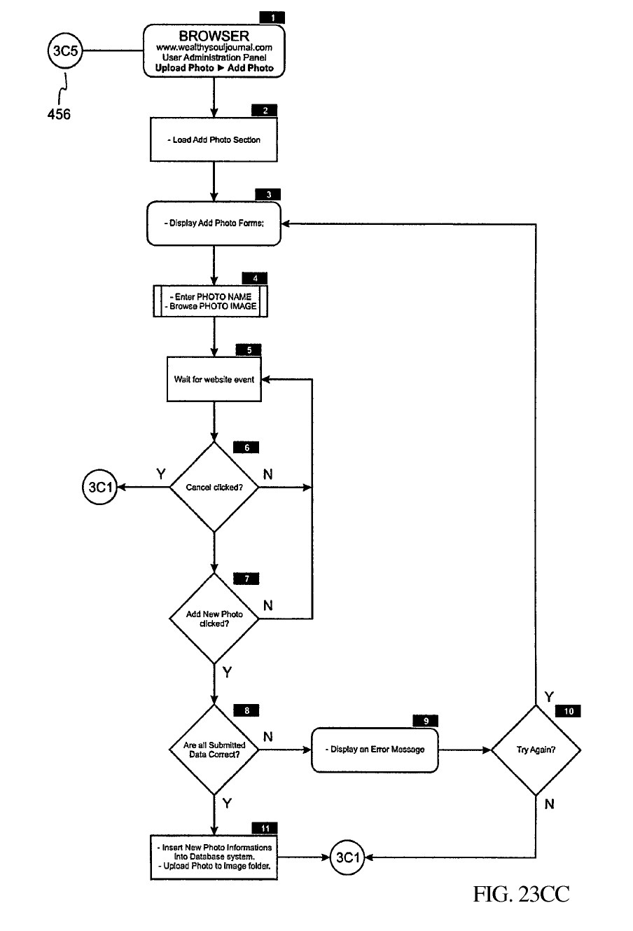

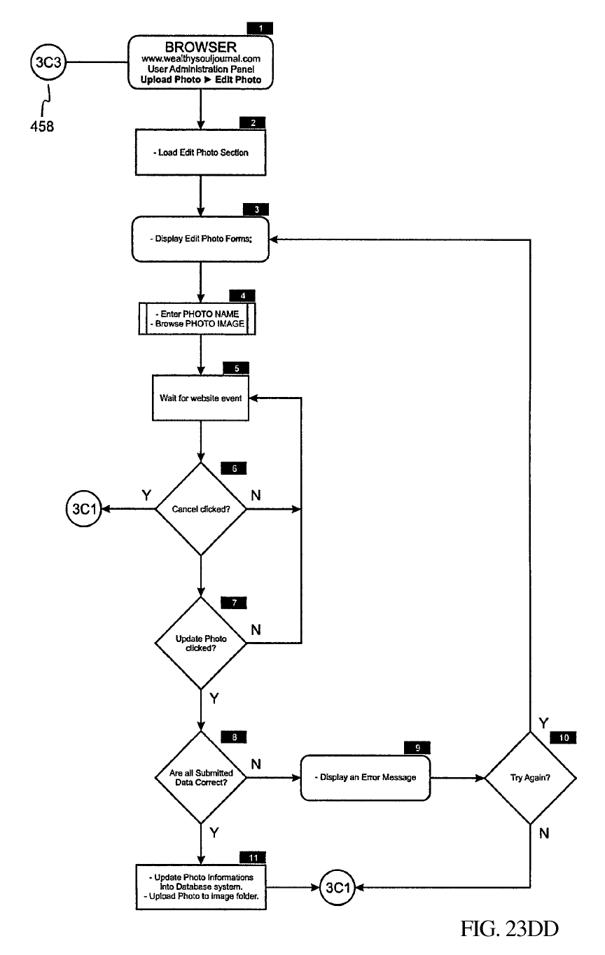

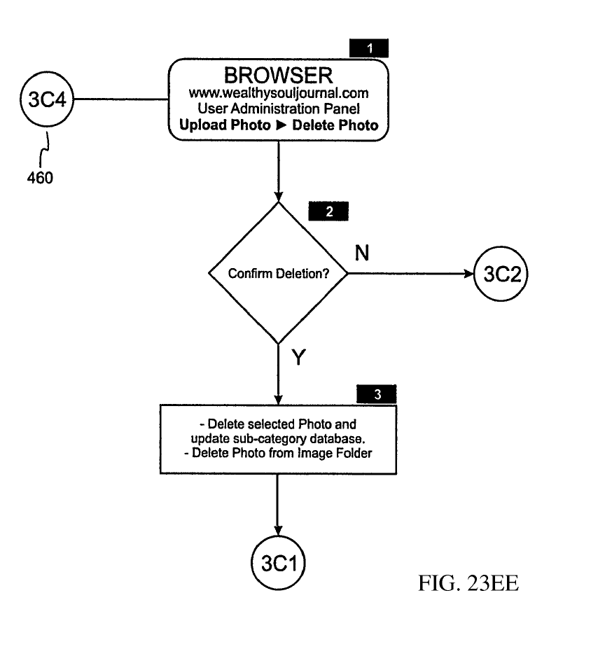

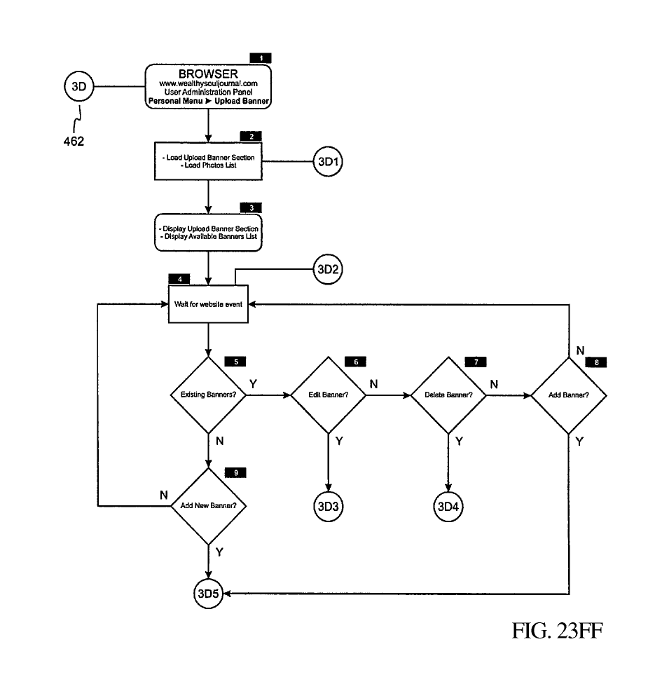

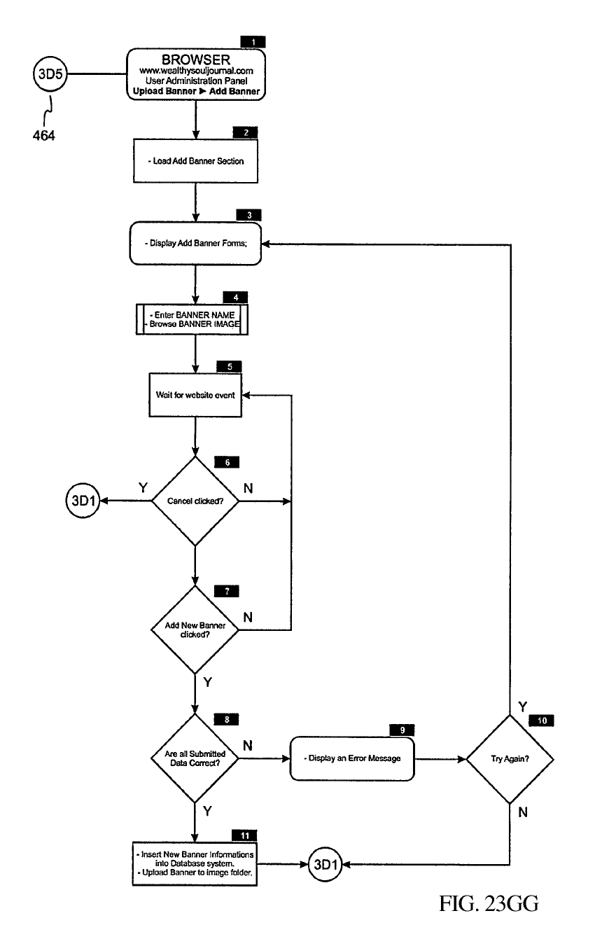

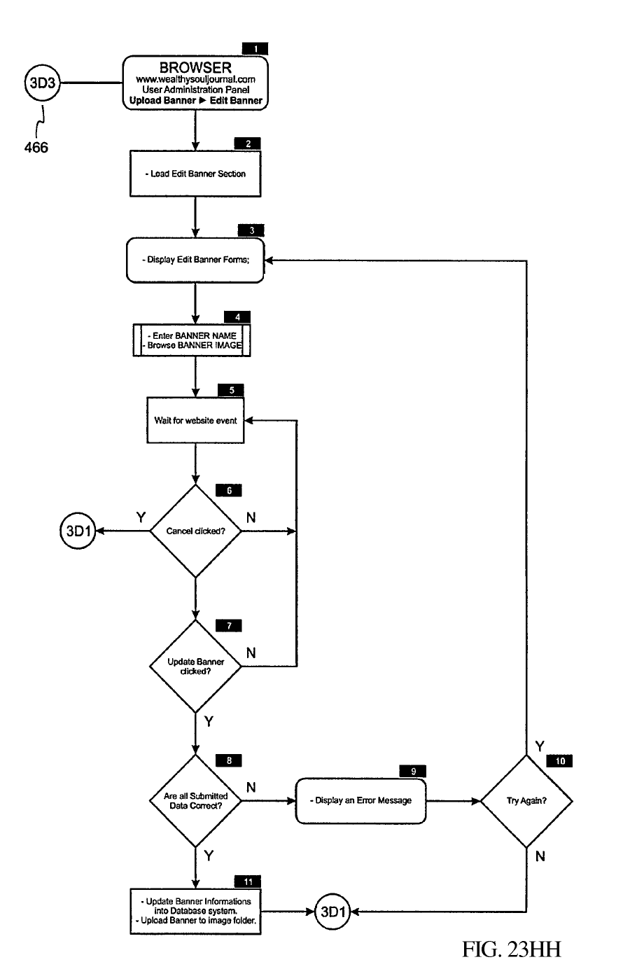

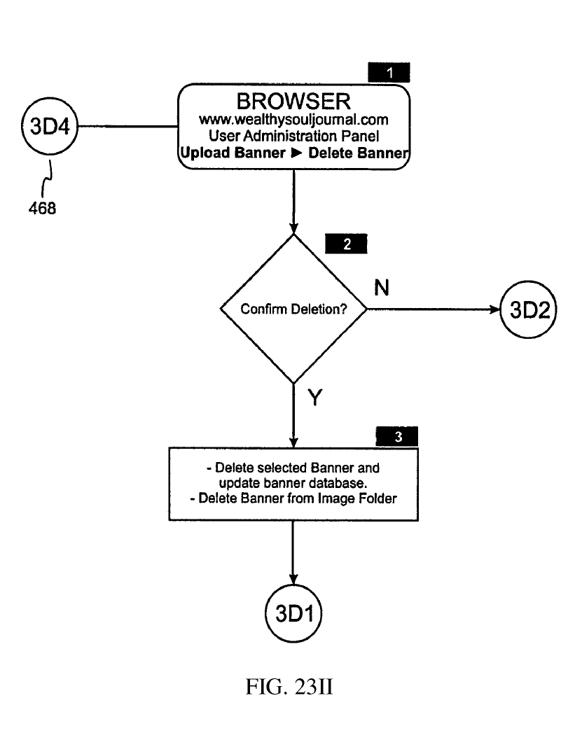

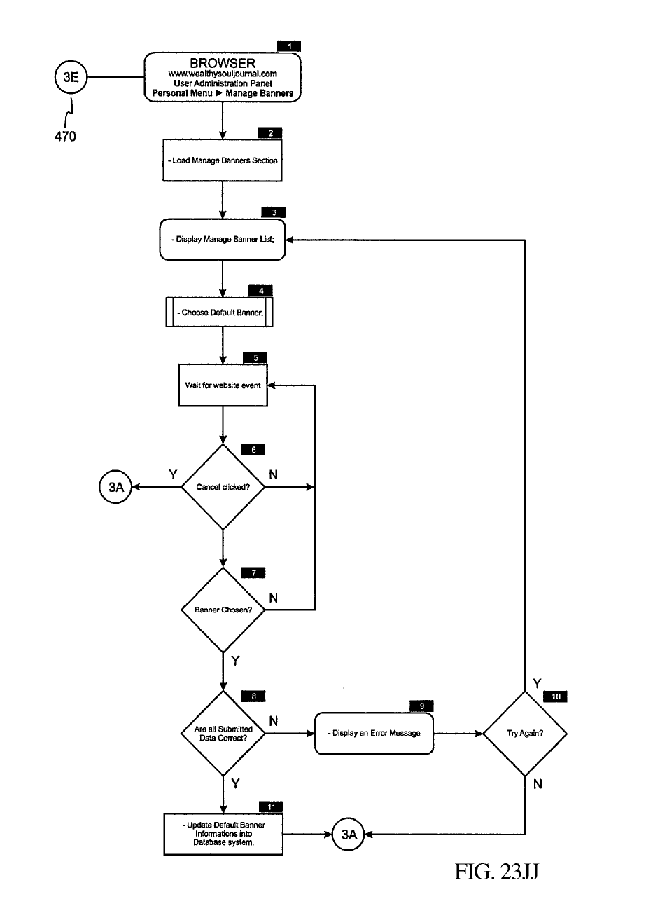

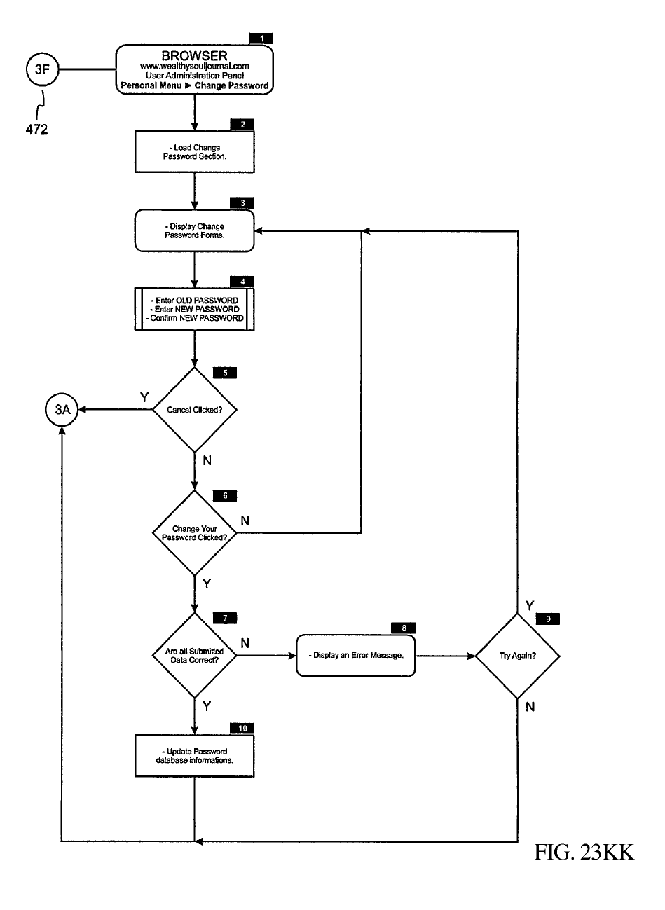

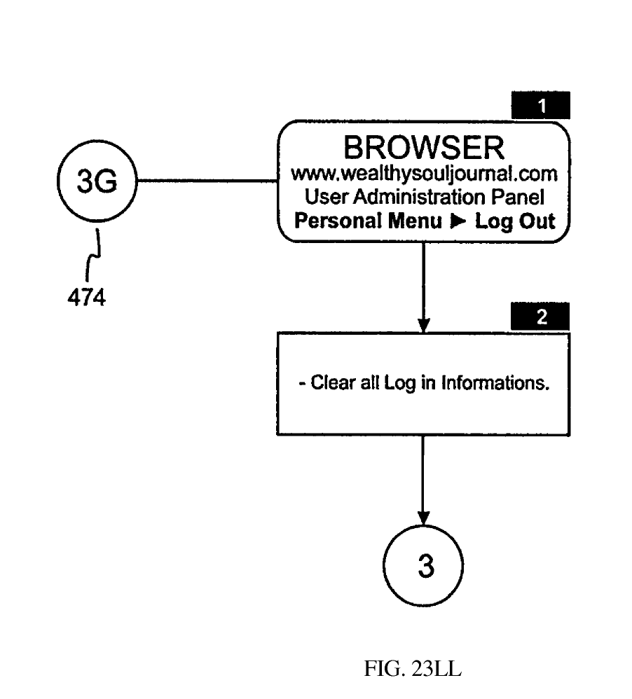

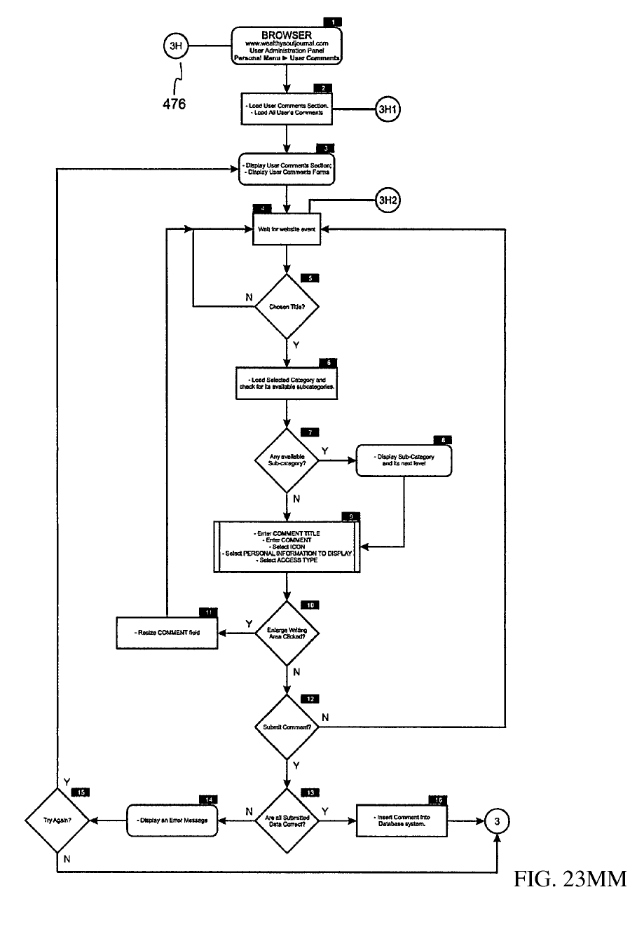

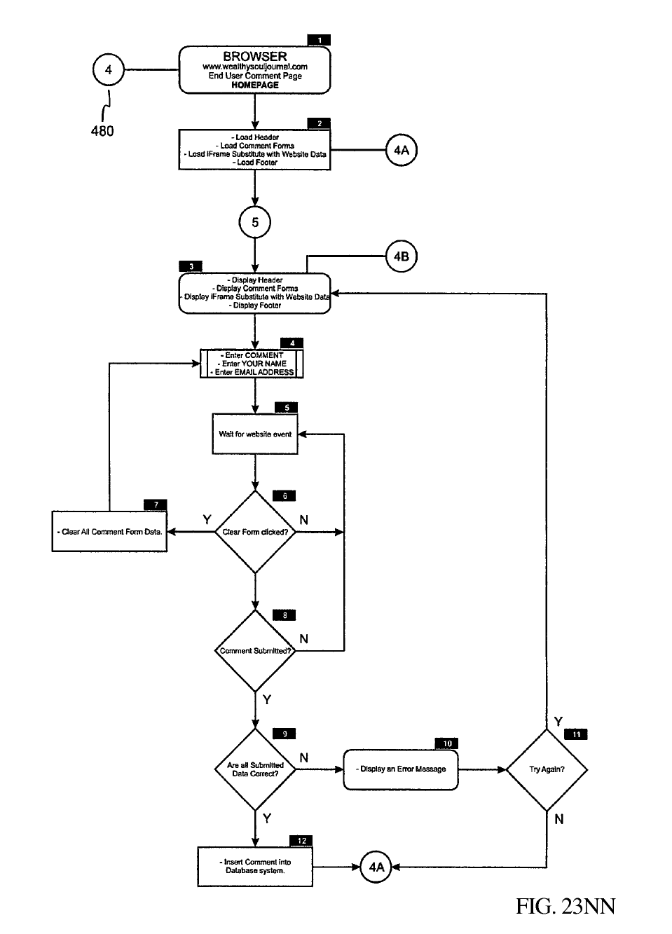

Referring to FIGS. 23A-23OO, a flow diagram illustrating the web site administration, user administration, and end user components for an example embodiment of the present invention is shown. The present invention comprises an iFrame solution to provide features and functionality related to reader comment areas. The embedded technologies in the iFrame Solution include HTML, PHP, Javascript, MySQL, CSS, and AJAX methods.

Referring to FIG. 23A, beginning at 400, the following steps are performed.

TABLE 1

| Step | Action |
|---|---|
| 1 | With any ECMA-262 compatible browsers (Internet Explorer 5+, FireFox 1.5+, Opera 8+, etc), the user |
| | accesses a URL (e.g., (www.wealthysouljournal.com). Users are permitted to access to one of three |
| | distinct sections: Web Site Administration System Panel, Users Administration System Panel, and End |
| | User System Panel. |
| 2 | The user proceeds to the WEB SITE administration panel login page. |
| 3 | The user proceeds to the USERS administration panel login page. |
| 4 | The user proceeds to the END USERS comment page. |

Referring to FIG. 23B, beginning at 402, the following steps are performed.

TABLE 2

| Step | Action |
|---|---|
| 1 | Browser will display a security check page asking USERNAME and PASSWORD. |
| 2 | User MUST enter USERNAME and PASSWORD; |
| 3 | If USERNAME and PASSWORD are OK, then follow the “Y” path, otherwise, follow the “N” path; |
| 4 | With an authenticated user, the system will load the “Website Administration Panel” homepage and will |
| | show all available menu option for this section; |
| 5 | The website will wait until the user choose one of the options on main menu; |
| 6 | If user chose PERSONAL MENU, a sub-menu with another options will appear and wait until one of its |
| | options are chosen; Its options are: (7) Edit Profile, (8) Change Password and (9) Log out; |
| 7 | If user chose PERSONAL MENU→EDIT PROFILE, it will follow “Y” path to diagram [2B], otherwise it |
| | will wait until the user's choice. |
| 8 | If user chose PERSONAL MENU→EDIT PROFILE, it will follow “Y” path to diagram [2C], otherwise it |
| | will wait until the user's choice. |
| 9 | If user chose PERSONAL MENU→EDIT PROFILE, it will follow “Y” path to diagram [2D], otherwise it |
| | will wait until the user's choice. |
| 10 | If user chose CREATE & MANAGE MENU, a sub-menu with another options will appear and wait until |
| | one of its options are chosen; Its options are: (11) Categories, (12) Sub-Categories and (13) Page Content; |
| 11 | If user chose CREATE & MANAGE MENU→CATEGORIES, it will follow “Y” path to diagram [2E], |
| | otherwise it will wait until the user's choice. |
| 12 | If user chose CREATE & MANAGE MENU→SUB-CATEGORIES, it will follow “Y” path to diagram |
| | [2F], otherwise it will wait until the user's choice. |
| 13 | If user chose CREATE & MANAGE MENU→PAGE CONTENT, it will follow “Y” path to diagram |
| | [2G], otherwise it will wait until the user's choice. |
| 14 | If user chose ADMIN SETTINGS MENU, a sub-menu with another options will appear and wait until one |
| | of its options are chosen; Its options are: (15) Manage Icon and (16) HEADER/FOOTER; |
| 15 | If user chose ADMIN SETTINGS MENU→MANAGE ICON, it will follow “Y” path to diagram [2H], |
| | otherwise it will wait until the user's choice. |
| 16 | If user chose ADMIN SETTINGS MENU→HEADER/FOOTER, it will follow “Y” path to diagram [2I], |
| | otherwise it will wait until the user's choice. |

Referring to FIG. 23C, beginning at 404, the following steps are performed:

TABLE 3

| Step | Action |
|---|---|
| 1 | Browser will display EDIT PROFILE title. |
| 2 | Website will load EDIT PROFILE section; |
| 3 | Website will display EDIT PROFILE page with its forms; |
| 4 | User MUST enter FIRST NAME, LAST NAME and EMAIL |
| | ADDRESS; |
| 5 | If user clicked on CANCEL during the process, the system will |
| | follow the “Y” path to diagram [2A], otherwise |
| | it will follow the “N” path; |
| 6 | If user clicked on EDIT YOUR PROFILE, the system will follow |
| | the “Y” path, otherwise it will follow the “N” path; |
| 7 | If all submitted data are correct, it will follow the “Y” path, |
| | otherwise it will follow the “N” path; |
| 8 | If an error happens, an error message will be showed and user |
| | can choose to try again; |
| 9 | If user wants to try again it will follow the “Y” path, otherwise |
| | it will follow the “N” path to diagram [2A]; |
| 10 | The system will update USER PROFILE database and goes to |
| | diagram [2A]; |

Referring to FIG. 23D, beginning at 406, the following steps are performed.

TABLE 4

| Step | Action |
|---|---|
| 1 | Browser will display CHANGE PASSWORD title. |
| 2 | Website will load CHANGE PASSWORD section; |
| 3 | Website will display CHANGE PASSWORD page with its forms; |
| 4 | User MUST enter OLD PASSWORD, NEW PASSWORD and |
| | CONFIRM NEW PASSWORD; |
| 5 | If user clicked on CANCEL during the process, the system will |
| | follow the “Y” path to diagram [2A], otherwise it will follow |
| | the “N” path; |
| 6 | If user clicked on CHANGE PASSWORD, the system will follow |
| | the “Y” path, otherwise it will follow |
| | the “N” path; |
| 7 | If all submitted data are correct, it will follow the “Y” path, |
| | otherwise it will follow the “N” path; |
| 8 | If an error happens, an error message will be showed and user |
| | can choose to try again; |
| 9 | If user wants to try again it will follow the “Y” path, otherwise |
| | it will follow the “N” path to diagram [2A]; |
| 10 | The system will update PASSWORD database and goes to |
| | diagram [2A]; |

Referring to FIG. 23E, beginning at 408, the following steps are performed.

TABLE 5

| Step | Action |
|---|---|
| 1 | Browser will display LOG OUT title. |
| 2 | Website will clear all log in information and goes to diagram [2]; |

Referring to FIG. 23F, beginning at 410, the following steps are performed.

TABLE 6

| Step | Action |
|---|---|
| 1 | Browser will display CATEGORIES title. |
| 2 | Website will load CATEGORIES section and check if there are |
| | any categories into database system; |
| 3 | If any category was previously added, these categories will be |
| | listed and a special menu for it will be loaded and ADD |
| | NEW CATEGORY will be in the options too. The options for its |
| | menu are: (9) Add New Category, (6) Edit Category, (7) Delete |
| | Category, (8) Change Existing Categories List Order; |
| 4 | If user chose PERSONAL MENU, a sub-menu with another |
| | options will appear and wait until one of its options are chosen; |
| | Its options are: (7) Edit Profile, (8) Change Password and (9) |
| | Log out; |
| 5 | If user clicked on CANCEL during the process, the system will |
| | follow the “Y” path to diagram [2E1], otherwise |
| | it will follow the “N” path; |
| 6 | If user chose CATEGORIES→EDIT CATEGORY, it will |
| | follow “Y” path to diagram [2E3], otherwise it will |
| | wait until the user's choice. |
| 7 | If user chose CATEGORIES→DELETE CATEGORY, |
| | it will follow “Y” path to diagram [2E4], otherwise |
| | it will wait until the user's choice. |
| 8 | If user chose CATEGORIES→CHANGE LIST ORDER, |
| | it will follow “Y” path to diagram [2E5], otherwise |
| | it will wait until the user's choice. |

Referring to FIG. 23G, beginning at 412, the following steps are performed.

TABLE 7

| Step | Action |
|---|---|
| 1 | Browser will display CATEGORIES - EDIT CATEGORY title. |
| 2 | Website will load EDIT CATEGORY section and check if there |
| | are any sub-categories for selected category; |
| 3 | Website will display EDIT CATEGORY page with its forms; |
| 4 | User MUST enter CATEGORY NAME, NEXT LEVEL |
| | SELECTION and ORDER TYPE; |
| 5 | If user clicked on CANCEL during the process, the system will |
| | follow the “Y” path to diagram [2E1], otherwise |
| | it will follow the “N” path; |
| 6 | If user clicked on SAVE CHANGES, the system will follow |
| | the “Y” path, otherwise it will follow the “N” path; |
| 7 | If all submitted data are correct, it will follow the “Y” path, |
| | otherwise it will follow the “N” path; |
| 8 | If an error happens, an error message will be showed and user |
| | can choose to try again; |
| 9 | If user wants to try again it will follow the “Y” path, otherwise |
| | it will follow the “N” path to diagram [2E1]; |
| 10 | The system will update CATEGORY database and goes to |
| | diagram [2E1]; |

Referring to FIG. 23H, beginning at 414, the following steps are performed.

TABLE 8

| Step | Action |
|---|---|
| 1 | Browser will display CATEGORIES - DELETE CATEGORY title. |
| 2 | Website will ask user to CONFIRM CATEGORY TO DELETE; |
| | If user clicked on NO during the |
| | process, the system will follow the “N” path to diagram [2E2], |
| | otherwise it will follow the “Y” path; |
| 3 | The system will delete selected CATEGORY, update category |
| | database and goes to diagram [2E1]; |

Referring to FIG. 23I, beginning at 416, the following steps are performed.

TABLE 9

| Step | Action |
|---|---|
| 1 | Browser will display CATEGORIES - CHANGE ORDER title. |
| 2 | If user chose SEQUENTIAL ORDER, it will follow the “Y” path, |
| | otherwise it will follow “N” path; |
| 3 | Website will load all available categories ordering by |
| | “SEQUENTIAL” option; |
| 4 | The system display CATEGORIES SECTION using the chosen |
| | order and goes to diagram [2E2]; |
| 5 | If user chosen NON-SEQUENTIAL ORDER, it will follow |
| | the “Y” path, otherwise it will follow “N” path; |
| 6 | Website will load all available categories ordering |
| | by “NON-SEQUENTIAL” option; |

Referring to FIG. 23J, beginning at 418, the following steps are performed.

TABLE 10

| Step | Action |
|---|---|
| 1 | Browser will display ADD NEW CATEGORY title. |
| 2 | Website will load ADD NEW CATEGORY section; |
| 3 | Website will display ADD NEW CATEGORY page with its forms; |
| 4 | User MUST enter CATEGORY NAME, NEXT LEVEL |
| | SELECTION and ORDER TYPE; |
| 5 | If user clicked on CANCEL during the process, the system will |
| | follow the “Y” path to diagram [2E1], otherwise it |
| | will follow the “N” path; |
| 6 | If user clicked on ADD NEW CHANGE PASSWORD, the system |
| | will follow the “Y” path, otherwise it will follow |
| | the “N” path; |
| 7 | If all submitted data are correct, it will follow the “Y” path, |
| | otherwise it will follow the “N” path; |
| 8 | If an error happens, an error message will be showed and user |
| | can choose to try again; |
| 9 | If user wants to try again it will follow the “Y” path, otherwise |
| | it will follow the “N” path to diagram [2E1]; |
| 10 | The system will ADD A NEW CATEGORY into database |
| | and goes to diagram [2E1]; |

Referring to FIG. 23K, beginning at 420, the following steps are performed.

TABLE 11

| Step | Action |
|---|---|
| 1 | Browser will display SUB-CATEGORIES title. |
| 2 | Website will load SUB-CATEGORIES section; |
| 3 | Website will display SUB-CATEGORIES page with its forms; |
| 4 | Website will wait until one of the available options is chosen; |
| 5 | If SUB-CATEGORIES chosen, it will follow the “Y” path |
| | and a sub-menu will appear for its sub- categories, otherwise |
| | it will follow the “N” path; |
| 6 | If user chose SUB-CATEGORIES→EDIT SUB-CATEGORY, |
| | it will follow “Y” path to diagram [2F3], otherwise |
| | it will wait until the user's choice. |
| 7 | If user chose SUB-CATEGORIES→DELETE SUB-CATEGORY, |
| | it will follow “Y” path to diagram [2F4], otherwise |
| | it will wait until the user's choice. |
| 8 | If a category is chosen and the user clicks on |
| | SUB-CATEGORIES→CREATE SUB-CATEGORY, a list |
| | of options for SUB-CATEGORY creation type will appear; |
| 9 | The system will wait until one of the available types of |
| | sub-categories is chosen. The options are: (10) Text, (13) |
| | Numeric and (16) Alphabetic; |
| 10 | If TEXT is chosen, it will follow “Y” path, otherwise |
| | it will follow “N” path; |
| 11 | User MUST enter the number (quantity) of NEW TEXT |
| | SUB-CATEGORIES that will be created; |
| 12 | If creation is confirmed, it will follow “Y” path to diagram [2F6], |
| | otherwise it will be canceled and will follow the “N” path; |
| 13 | If NUMERIC is chosen, it will follow “Y” path, otherwise |
| | it will follow “N” path; |
| 14 | User MUST enter the STARTING NUMBER and END |
| | NUMBER of NEW NUMERIC SUB-CATEGORIES that will be |
| | created. These numbers MUST be bigger than 0 and |
| | smaller than 1001; |
| 15 | If creation is confirmed, it will follow “Y” path to diagram [2F7], |
| | otherwise it will be canceled and will follow the “N” path; |
| 16 | If ALPHABETIC is chosen, it will follow “Y” path, otherwise |
| | it will follow “N” path; |
| 17 | User MUST enter the STARTING LETTER and END LETTER |
| | of NEW ALPHABETIC SUB-CATEGORIES that will be created; |
| 18 | If creation is confirmed, it will follow “Y” path to diagram [2F8], |
| | otherwise it will be canceled and will follow the “N” path; |

Referring to FIG. 23L, beginning at 422, the following steps are performed.

TABLE 12

| Step | Action |
|---|---|
| 1 | Browser will display SUB-CATEGORIES-EDIT title. |
| 2 | Website will load SUB-CATEGORIES - EDIT section; |
| 3 | Website will display SUB-CATEGORIES-EDIT page with its |
| | forms; |
| 4 | User MUST enter CATEGORY NAME, NEXT LEVEL |
| | SELECTION and ORDER TYPE; |
| 5 | Website will wait until one of the available options is chosen; |
| 6 | If UPDATE clicked, the system will follow the “Y” path, |
| | otherwise it will follow the “N” path; |
| 7 | If user clicked on CANCEL during the process, the system will |
| | follow the “Y” path to diagram [2F1], otherwise it will |
| | follow the “N” path; |
| 8 | If all submitted data are correct, it will follow the “Y” path, |
| | otherwise it will follow the “N” path; |
| 9 | If an error happens, an error message will be showed and user can |
| | choose to try again; |
| 10 | If user wants to try again it will follow the “Y” path, otherwise |
| | it will follow the “N” path to diagram [2F1]; |
| 11 | The system will UPDATE THE SUB-CATEGORY into database |
| | and goes to diagram [2F1]; |

Referring to FIG. 23M, beginning at 424, the following steps are performed.

TABLE 13

| Step | Action |
|---|---|
| 1 | Browser will display SUB - CATEGORIES-DELETE title. |
| 2 | Website will ask user to CONFIRM SUB-CATEGORY TO |
| | DELETE; If user clicked on NO during the process, the |
| | system will follow the “N” path to diagram [2F2], |
| | otherwise it will follow the “Y” path; |
| 3 | The system will delete selected SUB-CATEGORY, update |
| | sub-category database and goes to diagram [2F1]; |

Referring to FIG. 23N, beginning at 426, the following steps are performed.

TABLE 14

| Step | Action |
|---|---|
| 1 | Browser will display SUB-CATEGORIES - ADD TEXT TYPE |
| | title. |
| 2 | Website will create SUB-CATEGORIES TEXT TYPE |
| | (selected category); |
| 3 | Website will display SUB-CATEGORIES TEXT TYPE forms |
| | (selected category); |
| 4 | User MUST enter SUB-CATEGORY NAME, NEXT LEVEL |
| | SELECTION and ORDER TYPE; |
| 5 | Website will wait until one of the available options is chosen; |
| 6 | If CREATE NEW SUB-CATEGORY clicked, the system will |
| | follow the “Y” path, otherwise it will |
| | follow the “N” path; |
| 7 | If all submitted data are correct, it will follow the “Y” path, |
| | otherwise it will follow the “N” path; |
| 8 | If an error happens, an error message will be showed and |
| | user can choose to try again; |
| 9 | If user wants to try again it will follow the “Y” path, |
| | otherwise it will follow the “N” path to diagram [2F1]; |
| 10 | The system will add the NEW SUB-CATEGORIES into |
| | database and goes to diagram [2F1]; |

Referring to FIG. 23O, beginning at 428, the following steps are performed.

TABLE 15

| Step | Action |
|---|---|
| 1 | Browser will display SUB-CATEGORIES - ADD NUMERIC |
| | TYPE title. |
| 2 | Website will create SUB-CATEGORIES NUMERIC TYPE |
| | (selected category); |
| 3 | Website will wait until one of the available options is chosen; |
| 4 | If CREATE NEW SUB-CATEGORY clicked, the system will |
| | follow the “Y” path, otherwise it will follow the “N” path; |
| 5 | If all submitted data are correct, it will follow the “Y” path, |
| | otherwise it will follow the “N” path; |
| 6 | If an error happens, an error message will be showed and |
| | user can choose to try again; |
| 7 | If user wants to try again it will follow the “Y” path and goes |
| | to diagram [2F2], otherwise it will follow the “N” path |
| | to diagram [2F1]; |
| 8 | The system will add the NEW SUB-CATEGORIES into |
| | database and goes to diagram [2F1]; |

Referring to FIG. 23P, beginning at 430, the following steps are performed.

TABLE 16

| Step | Action |
|---|---|
| 1 | Browser will display SUB-CATEGORIES - ADD ALPHABETIC |
| | TYPE title. |
| 2 | Website will create SUB-CATEGORIES ALPHABETIC TYPE |
| | (selected category); |
| 3 | Website will wait until one of the available options is chosen; |
| 4 | If CREATE NEW SUB-CATEGORY clicked, the system will |
| | follow the “Y” path, otherwise it will follow the “N” path; |
| 5 | If all submitted data are correct, it will follow the “Y” path, |
| | otherwise it will follow the “N” path; |
| 6 | If an error happens, an error message will be showed and |
| | user can choose to try again; |
| 7 | If user wants to try again it will follow the “Y” path and goes |
| | to diagram [2F2], otherwise it will follow the “N” path |
| | to diagram [2F1]; |
| 8 | The system will add the NEW SUB-CATEGORIES into database |
| | and goes to diagram [2F1]; |

Referring to FIG. 23Q, beginning at 432, the following steps are performed.

TABLE 17

| Step | Action |
|---|---|
| 1 | Browser will display PAGE CONTENT title. |
| 2 | Website will load PAGE CONTENT section and all MAIN |
| | CATEGORIES LIST; |
| 3 | Website will display PAGE CONTENT page with its forms; |
| 4 | Website will wait until one of the available options is chosen; |
| 5 | If PAGE CONTENT chosen, it will follow the “Y” path and |
| | a sub-menu will appear for its sub-categories, otherwise it will |
| | follow the “N” path; |
| 6 | The system will load selected category and will check for |
| | its available sub-categories; |
| 7 | If category has any sub-categories available it will follow “Y” |
| | path, otherwise it will follow “N” path; |
| 8 | Website will display Category's sub-categories and its next levels; |
| 9 | If PAGE TEMPLATE was clicked, it will follow “Y” path |
| | to diagram [2G3], otherwise it will follow “N” path; |
| 10 | If ADD PAGE CONTENT was clicked, it will follow “Y” path |
| | to diagram [2G4], otherwise it will follow “N” path; |
| 11 | If IFRAME CODE was clicked, it will follow “Y” path to |
| | diagram [2G5], otherwise it will follow “N” path; |

Referring to FIG. 23R, beginning at 434, the following steps are performed.

TABLE 18

| Step | Action |
|---|---|
| 1 | Browser will display PAGE CONTENT - PAGE TEMPLATE title. |
| 2 | Website will load PAGE TEMPLATE section for selected category or sub-category; |
| 3 | Website will display PAGE TEMPLATE page with its forms; |
| 4 | User MUST enter TEMPLATE TITLE, BOOK DESCRIPTION, KEYWORDS, PAGE FROM, PAGE |
| | TO, HEADER TEMPLATE, FOOTER TEMPLATE, choose COMMENTS TYPE (Display or Hide), |
| | AUTO-RESPONDER SERVICE, EMAIL SUBJECT, EMAIL CONTENT and choose MAKE |
| | DEFAULT (Yes or No); |
| 5 | Website will wait until one of the available options is chosen; |
| 6 | If user clicked on CANCEL during the process, the system will follow the “Y” path to diagram [2G1], |
| | otherwise it will follow the “N” path; |
| 7 | If CREATE PAGE SETUP clicked, the system will follow the “Y” path, otherwise it will follow the “N” |
| | path; |
| 8 | If all submitted data are correct, it will follow the “Y” path, otherwise it will follow the “N” path; |
| 9 | If an error happens, an error message will be showed and user can choose to try again; |
| 10 | If user wants to try again it will follow the “Y” path, otherwise it will follow the “N” path to diagram |
| | [2G1]; |
| 11 | The system will ADD A NEW TEMPLATE into database and goes to diagram [2G1]; |

Referring to FIG. 23S, beginning at 436, the following steps are performed.

TABLE 19

| Step | Action |
|---|---|
| 1 | Browser will display PAGE CONTENT - ADD PAGE CONTENT title. |
| 2 | Website will load ADD PAGE CONTENT section for selected category or sub-category; |
| 3 | If no templates are found for its category/subcategory it will follow the “N” path, otherwise it will follow |
| | the “Y” path; |
| 4 | System will show an error message and goes to diagram [2G3]; |
| 5 | Website will display ADD PAGE CONTENT page with its forms; |
| 6 | User MUST choose PAGE NUMBER (from existing list), enter PAGE TITLE and enter PAGE |
| | CONTENT; |
| 7 | Website will wait until one of the available options is chosen; |
| 8 | If user clicked on CANCEL during the process, the system will follow the “Y” path to diagram [2G1], |
| | otherwise it will follow the “N” path; |
| 9 | If POST PAGE CONTENT clicked, the system will follow the “Y” path, otherwise it will follow the “N” |
| | path; |
| 10 | If all submitted data are correct, it will follow the “Y” path, otherwise it will follow the “N” path; |
| 11 | If an error happens, an error message will be showed and user can choose to try again; |
| 12 | If user wants to try again it will follow the “Y” path, otherwise it will follow the “N” path to diagram |
| | [2G1]; |
| 13 | The system will ADD NEW PAGE CONTENT into database and goes to diagram [2G1]; |

Referring to FIG. 23T, beginning at 438, the following steps are performed.

TABLE 20

| Step | Action |
|---|---|
| 1 | Browser will display PAGE CONTENT - IFRAME SUBSTITUTE |
| | CODE title. |
| 2 | Website will load IFRAME SUBSTITUTE CODE section for |
| | selected category or sub-category; |
| 3 | Website will display IFRAME SUBSTITUTE CODE SCRIPT |
| | to be used into website's HTML body and goes to diagram [2G1]; |

Referring to FIG. 23U, beginning at 440, the following steps are performed.

TABLE 21

| Step | Action |
|---|---|
| 1 | Browser will display ADMIN SETTINGS - MANAGE ICON title. |
| 2 | Website will load MANAGE ICON section and its available icons; |
| 3 | Website will display MANAGE ICON and its available icons; |
| 4 | Website will wait until one of the available options is chosen; |
| 5 | If there are any previously icons added it will follow the “Y” path |
| | and a sub-menu for its icons will appear, otherwise it will follow |
| | the “N” path and only ADD NEW ICON must be showed; |
| 6 | If EDIT ICON is chosen it will follow “Y” path to diagram [2H3], |
| | otherwise it will await until the user's choice. |
| 7 | If DELETE ICON is chosen it will follow “Y” path to diagram |
| | [2H4], otherwise it will await until the user's choice. |
| 8 | If ADD ICON is chosen it will follow “Y” path to diagram [2H5], |
| | otherwise it will await until the user's choice. |
| 9 | If ADD ICON is chosen it will follow “Y” path to diagram [2H5], |
| | otherwise it will await until the user's choice. |

Referring to FIG. 23V, beginning at 442, the following steps are performed.

TABLE 22

| Step | Action |
|---|---|
| 1 | Browser will display MANAGE ICON - ADD ICON title. |
| 2 | Website will load ADD ICON section; |
| 3 | Website will display ADD ICON page with its forms; |
| 4 | User MUST enter ICON NAME and choose an ICON IMAGE to |
| | upload; |
| 5 | Website will wait until one of the available options is chosen; |
| 6 | If user clicked on CANCEL during the process, the system will |
| | follow the “Y” path to diagram [2H1], otherwise it will |
| | follow the “N” path; |
| 7 | If ADD NEW ICON clicked, the system will follow the “Y” |
| | path, otherwise it will follow the “N” path; |
| 8 | If all submitted data are correct, it will follow the “Y” path, |
| | otherwise it will follow the “N” path; |
| 9 | If an error happens, an error message will be showed and user can |
| | choose to try again; |
| 10 | If user wants to try again it will follow the “Y” path, otherwise it |
| | will follow the “N” path to diagram [2H1]; |
| 11 | The system will ADD NEW ICON information and UPLOAD AN |
| | ICON IMAGE to image folder and goes to diagram [2H1]; |

Referring to FIG. 23W, beginning at 444, the following steps are performed.

TABLE 23

| Step | Action |
|---|---|
| 1 | Browser will display MANAGE ICON - EDIT ICON title. |
| 2 | Website will load EDIT ICON section; |
| 3 | Website will display EDIT ICON page with its forms; |
| 4 | User MUST enter ICON NAME and choose an ICON IMAGE to |
| | upload; |
| 5 | Website will wait until one of the available options is chosen; |
| 6 | If user clicked on CANCEL during the process, the system will |
| | follow the “Y” path to diagram [2H1], otherwise it will |
| | follow the “N” path; |
| 7 | If SAVE CHANGES clicked, the system will follow the “Y” path, |
| | otherwise it will follow the “N” path; |
| 8 | If all submitted data are correct, it will follow the “Y” path, |
| | otherwise it will follow the “N” path; |
| 9 | If an error happens, an error message will be showed and user can |
| | choose to try again; |
| 10 | If user wants to try again it will follow the “Y” path, otherwise |
| | it will follow the “N” path to diagram [2H1]; |
| 11 | The system will UPDATE ICON information and UPLOAD AN |
| | ICON IMAGE to image folder and goes to diagram [2H1]; |

Referring to FIG. 23X, beginning at 446, the following steps are performed.

TABLE 24

| Step | Action |
|---|---|
| 1 | Browser will display MANAGE ICON - DELETE title. |
| 2 | Website will ask user to CONFIRM ICON TO DELETE; If user |
| | clicked on NO during the process, the system will follow the |
| | “N” path to diagram [2H2], otherwise it will |
| | follow the “Y” path; |
| 3 | The system will delete selected ICON and ICON IMAGE, update |
| | icon database and goes to diagram [2H1]; |

Referring to FIG. 23Y, beginning at 448, the following steps are performed.

TABLE 25

| Step | Action |
|---|---|
| 1 | Browser will display ADMIN SETTING - HEADER/FOOTER |
| | title. |
| 2 | Website will load HEADER/FOOTER section; |
| 3 | Website will display HEADER/FOOTER page with its forms; |
| 4 | User MUST enter ADMIN HEADER and ADMIN FOOTER; |
| 5 | Website will wait until one of the available options is chosen; |
| 6 | If user clicked on CANCEL during the process, the system will |
| | follow the “Y” path to diagram [2I], otherwise it will follow |
| | the “N” path; |
| 7 | If SAVE CHANGES clicked, the system will follow the “Y” path, |
| | otherwise it will follow the “N” path; |
| 8 | If all submitted data are correct, it will follow the “Y” path, |
| | otherwise it will follow the “N” path; |
| 9 | If an error happens, an error message will be showed and user can |
| | choose to try again; |
| 10 | If user wants to try again it will follow the “Y” path, otherwise |
| | it will follow the “N” path to diagram [2I]; |
| 11 | The system will UPDATE HEADER AND FOOTER information |
| | and goes to diagram [2I]; |

Referring to FIG. 23Z, beginning at 450, the following steps are performed.

TABLE 26

| Step | Action |
|---|---|
| 1 | Browser will display a security check page asking USERNAME and PASSWORD. |
| 2 | User MUST enter USERNAME and PASSWORD; |
| 3 | If USERNAME and PASSWORD are OK, then follow the “Y” path, otherwise, follow the “N” path; |
| 4 | With an authenticated user, the system will load the “User Administration Panel” homepage and will |
| | show all available menu option for this section; |
| 5 | The website will wait until the user choose one of the options on main menu; |
| 6 | If user chose PERSONAL MENU, a sub-menu with another options will appear and wait until one of its |
| | options are chosen; Its options are: (7) Edit Profile, (8) Upload Photo, (9) Upload Banner, (10) Manage |
| | Banner, (11) Change Password and (12) Log out; |
| 7 | If user chose PERSONAL MENU→EDIT PROFILE, it will follow “Y” path to diagram [3B], otherwise |
| | it will wait until the user's choice. |
| 8 | If user chose PERSONAL MENU→UPLOAD PHOTO, it will follow “Y” path to diagram [3C], |
| | otherwise it will wait until the user's choice. |
| 9 | If user chose PERSONAL MENU→UPLOAD BANNER, it will follow “Y” path to diagram [3D], |
| | otherwise it will wait until the user's choice. |
| 10 | If user chose PERSONAL MENU→MANAGE BANNER, it will follow “Y” path to diagram [3E], |
| | otherwise it will wait until the user's choice. |
| 11 | If user chose PERSONAL MENU→CHANGE PASSWORD, it will follow “Y” path to diagram [3F], |
| | otherwise it will wait until the user's choice. |
| 12 | If user chose PERSONAL MENU→LOG OUT, it will follow “Y” path to diagram [3G], otherwise it |
| | will wait until the user's choice. |
| 13 | If user chose PAGE MENU, a sub-menu with another option will appear and wait until one of its options |
| | are chosen; Its options is: (14) User Comments; |
| 14 | If user chose PAGE MENU→USER COMMENTS, it will follow “Y” path to diagram [3H], otherwise it |
| | will wait until the user's choice. |

Referring to FIG. 23AA, beginning at 452, the following steps are performed.

TABLE 27

| Step | Action |
|---|---|
| 1 | Browser will display PERSONAL MENU - EDIT PROFILE title. |
| 2 | Website will load EDIT PROFILE section; |
| 3 | Website will display EDIT PROFILE page with its forms; |
| 4 | User MUST enter FIRST NAME, LAST NAME and EMAIL |
| | ADDRESS; |
| 5 | Website will wait until one of the available options is chosen; |
| 6 | If user clicked on CANCEL during the process, the system will |
| | follow the “Y” path to diagram [3A], otherwise it will follow |
| | the “N” path; |
| 7 | If EDIT YOUR PROFILE was clicked, the system will follow the |
| | “Y” path, otherwise it will follow the “N” path; |
| 8 | If all submitted data are correct, it will follow the “Y” path, |
| | otherwise it will follow the “N” path; |
| 9 | If an error happens, an error message will be showed and user can |
| | choose to try again; |
| 10 | If user wants to try again it will follow the “Y” path, otherwise it |
| | will follow the “N” path to diagram [3A]; |
| 11 | The system will UPDATE USER PROFILE information and goes |
| | to diagram [3A]; |

Referring to FIG. 23BB, beginning at 454, the following steps are performed.

TABLE 28

| Step | Action |
|---|---|
| 1 | Browser will display PERSONAL MENU - UPLOAD PHOTO |
| | title. |
| 2 | Website will load UPLOAD PHOTO section and its available |
| | photos; |
| 3 | Website will display UPLOAD PHOTO and its available photos; |
| 4 | Website will wait until one of the available options is chosen; |
| 5 | If there are any previously photos added it will follow the “Y” path |
| | and a sub-menu for its photos will appear, otherwise it will follow |
| | the “N” path and only ADD NEW PHOTO must be showed; |
| 6 | If EDIT PHOTO is chosen it will follow “Y” path to diagram |
| | [3C3], otherwise it will await until the user's choice. |
| 7 | If DELETE PHOTO is chosen it will follow “Y” path to diagram |
| | [3C4], otherwise it will await until the user's choice. |
| 8 | If ADD PHOTO is chosen it will follow “Y” path to diagram |
| | [3C5], otherwise it will await until the user's choice. |
| 9 | If ADD PHOTO is chosen it will follow “Y” path to diagram |
| | [3C5], otherwise it will await until the user's choice. |

Referring to FIG. 23CC, beginning at 456, the following steps are performed.

TABLE 29

| Step | Action |
|---|---|
| 1 | Browser will display UPLOAD PHOTO - ADD PHOTO title. |
| 2 | Website will load ADD PHOTO section; |
| 3 | Website will display ADD PHOTO page with its forms; |
| 4 | User MUST enter PHOTO NAME and choose a PHOTO to |
| | upload; |
| 5 | Website will wait until one of the available options is chosen; |
| 6 | If user clicked on CANCEL during the process, the system will |
| | follow the “Y” path to diagram [3C1], otherwise it will follow |
| | the “N” path; |
| 7 | If ADD NEW PHOTO clicked, the system will follow the “Y” |
| | path, otherwise it will follow the “N” path; |
| 8 | If all submitted data are correct, it will follow the “Y” path, |
| | otherwise it will follow the “N” path; |
| 9 | If an error happens, an error message will be showed and user can |
| | choose to try again; |
| 10 | If user wants to try again it will follow the “Y” path, otherwise it |
| | will follow the “N” path to diagram [3C1]; |
| 11 | The system will ADD THE PHOTO information and UPLOAD |
| | THE PHOTO to image folder and goes to diagram [3C1]; |

Referring to FIG. 23DD, beginning at 458, the following steps are performed.

TABLE 30

| Step | Action |
|---|---|
| 1 | Browser will display UPLOAD PHOTO - EDIT PHOTO title. |
| 2 | Website will load EDIT PHOTO section; |
| 3 | Website will display EDIT PHOTO page with its forms; |
| 4 | User MUST enter PHOTO NAME and choose a PHOTO to |
| | upload; |
| 5 | Website will wait until one of the available options is chosen; |
| 6 | If user clicked on CANCEL during the process, the system will |
| | follow the “Y” path to diagram [3C1], otherwise it will follow |
| | the “N” path; |
| 7 | If SAVE CHANGES clicked, the system will follow the “Y” |
| | path, otherwise it will follow the “N” path; |
| 8 | If all submitted data are correct, it will follow the “Y” path, |
| | otherwise it will follow the “N” path; |
| 9 | If an error happens, an error message will be showed and user can |
| | choose to try again; |
| 10 | If user wants to try again it will follow the “Y” path, otherwise it |
| | will follow the “N” path to diagram [3C1]; |
| 11 | The system will UPDATE PHOTO information and UPLOAD |
| | THE PHOTO to image folder and goes to diagram [3C1]; |

Referring to FIG. 23EE, beginning at 460, the following steps are performed.

TABLE 31

| Step | Action |
|---|---|
| 1 | Browser will display UPLOAD PHOTO - DELETE PHOTO title. |
| 2 | Website will ask user to CONFIRM PHOTO TO DELETE; |
| 3 | If user clicked on NO during the process, the system will follow |
| | the “N” path to diagram [2C2], otherwise it will follow the |
| | “Y” path; |
| 4 | The system will delete selected PHOTO information and PHOTO, |
| | update photo database and goes to diagram [3C1]; |

Referring to FIG. 23FF, beginning at 462, the following steps are performed.

TABLE 32

| Step | Action |
|---|---|
| 1 | Browser will display PERSONAL MENU - UPLOAD BANNER |
| | title. |
| 2 | Website will load UPLOAD BANNER section and its available |
| | photos; |
| 3 | Website will display UPLOAD BANNER and its available photos; |
| 4 | Website will wait until one of the available options is chosen; |
| 5 | If there are any previously banners added it will follow the “Y” |
| | path and a sub-menu for its banners will appear, otherwise it will |
| | follow the “N” path and only ADD NEW BANNER must be |
| | showed; |
| 6 | If EDIT BANNER is chosen it will follow “Y” path to diagram |
| | [3D3], otherwise it will await until the user's choice. |
| 7 | If DELETE BANNER is chosen it will follow “Y” path to diagram |
| | [3D4], otherwise it will await until the user's choice. |
| 8 | If ADD BANNER is chosen it will follow “Y” path to diagram |
| | [3D5], otherwise it will await until the user's choice. |
| 9 | If ADD BANNER is chosen it will follow “Y” path to diagram |
| | [3D5], otherwise it will await until the user's choice. |

Referring to FIG. 23GG, beginning at 464, the following steps are performed.

TABLE 33

| Step | Action |
|---|---|
| 1 | Browser will display UPLOAD BANNER - ADD BANNER title. |
| 2 | Website will load ADD BANNER section; |
| 3 | Website will display ADD BANNER page with its forms; |
| 4 | User MUST enter BANNER NAME and choose a BANNER |
| | to upload; |
| 5 | Website will wait until one of the available options is chosen; |
| 6 | If user clicked on CANCEL during the process, the system will |
| | follow the “Y” path to diagram [3D1], otherwise it will |
| | follow the “N” path; |
| 7 | If ADD NEW BANNER clicked, the system will follow the “Y” |
| | path, otherwise it will follow the “N” path; |
| 8 | If all submitted data are correct, it will follow the “Y” path, |
| | therwise it will follow the “N” path; |
| 9 | If an error happens, an error message will be showed and |
| | ser can choose to try again; |
| 10 | If user wants to try again it will follow the “Y” path, |
| | therwise it will follow the “N” path to diagram [3D1]; |
| 11 | The system will ADD THE BANNER information and UPLOAD |
| | HE BANNER to image folder and goes to diagram [3D1]; |

Referring to FIG. 23HH, beginning at 464, the following steps are performed.

TABLE 34

| Step | Action |
|---|---|
| 1 | Browser will display UPLOAD BANNER - EDIT BANNER title. |
| 2 | Website will load EDIT BANNER section; |
| 3 | Website will display EDIT BANNER page with its forms; |
| 4 | User MUST enter BANNER NAME and choose a BANNER |
| | to upload; |
| 5 | Website will wait until one of the available options is chosen; |
| 6 | If user clicked on CANCEL during the process, the system will |
| | follow the “Y” path to diagram [3D1], |
| | otherwise it will follow the “N” path; |
| 7 | If SAVE CHANGES clicked, the system will follow the “Y” |
| | path, otherwise it will follow the “N” path; |
| 8 | If all submitted data are correct, it will follow the “Y” path, |
| | otherwise it will follow the “N” path; |
| 9 | If an error happens, an error message will be showed and |
| | user can choose to try again; |
| 10 | If user wants to try again it will follow the “Y” path, |
| | otherwise it will follow the “N” path to diagram [3D1]; |
| 11 | The system will UPDATE BANNER information and UPLOAD |
| | THE BANNER to image folder and goes to diagram [3C1]; |

Referring to FIG. 23II, beginning at 468, the following steps are performed.

TABLE 35

| Step | Action |
|---|---|
| 1 | Browser will display UPLOAD BANNER - DELETE BANNER |
| | title. |
| 2 | Website will ask user to CONFIRM BANNER TO DELETE; |
| | If user clicked on NO during the process, the system will follow |
| | the “N” path to diagram [3D2], otherwise it will follow the “Y” |
| | path; |
| 3 | The system will delete selected BANNER information and |
| | BANNER, update banner database and goes to diagram [3C1]; |

Referring to FIG. 23JJ, beginning at 470, the following steps are performed.

TABLE 36

| Step | Action |
|---|---|
| 1 | Browser will display PERSONAL MENU - MANAGE |
| | BANNER title. |
| 2 | Website will load MANAGE BANNER section; |
| 3 | Website will display MANAGE BANNER page with its forms; |
| 4 | User MUST choose the DEFAULT BANNER; |
| 5 | Website will wait until one of the available options is chosen; |
| 6 | If user clicked on CANCEL during the process, the system will |
| | follow the “Y” path to diagram [3A], |
| | otherwise it will follow the “N” path; |
| 7 | If BANNER is chosen, the system will follow the “Y” path, |
| | otherwise it will follow the “N” path; |
| 8 | If all submitted data are correct, it will follow the “Y” path, |
| | otherwise it will follow the “N” path; |
| 9 | If an error happens, an error message will be showed and |
| | user can choose to try again; |
| 10 | If user wants to try again it will follow the “Y” path, |
| | otherwise it will follow the “N” path to diagram [3A]; |
| 11 | The system will UPDATE DEFAULT BANNER information |
| | into database system and goes to diagram [3A]; |

Referring to FIG. 23KK, beginning at 472, the following steps are performed.

TABLE 37

| Step | Action |
|---|---|
| 1 | Browser will display PERSONAL MENU - CHANGE |
| | PASSWORD title. |
| 2 | Website will load CHANGE PASSWORD section; |
| 3 | Website will display CHANGE PASSWORD page with its forms; |
| 4 | User MUST enter OLD PASSWORD, NEW PASSWOR and |
| | CONFIRM NEW PASSWORD; |
| 5 | If user clicked on CANCEL during the process, the system will |
| | follow the “Y” path to diagram [3A], |
| | otherwise it will follow the “N” path; |
| 6 | If CHANGE YOUR PASSWORD was clicked, the system will |
| | follow the “Y” path, otherwise it will |
| | follow the “N” path; |
| 7 | If all submitted data are correct, it will follow the “Y” path, |
| | otherwise it will follow the “N” path; |
| 8 | If an error happens, an error message will be showed and |
| | user can choose to try again; |
| 9 | If user wants to try again it will follow the “Y” path, |
| | otherwise it will follow the “N” path to diagram [3A]; |
| 10 | The system will UPDATE PASSWORD information into |
| | database system and goes to diagram [3A]; |

Referring to FIG. 23LL, beginning at 474, the following steps are performed.

TABLE 38

| Step | Action |
|---|---|
| 1 | Browser will display LOG OUT title. |
| 2 | Website will clear all log in information and goes to diagram [3]; |

Referring to FIG. 23MM, beginning at 476, the following steps are performed.

TABLE 39

| Step | Action |
|---|---|
| 1 | Browser will display PERSONAL MENU - USER |
| | COMMENTS title. |
| 2 | Website will load USER COMMENTS section and all available |
| | users' comments; |
| 3 | Website will display USER COMMENTS page with its forms; |
| 4 | Website will wait until one of the available options is chosen; |
| 5 | If Title is chosen the system will follow the “Y” path, |
| | otherwise it will follow the “N” path; |
| 6 | Website will load the selected category and will check for |
| | available sub-categories; |
| 7 | If there are sub-categories, it will follow the “Y” path, |
| | otherwise it will follow the “N” path; |
| 8 | The system will display all available sub-categories for selected |
| | category and its next levels; |
| 9 | User MUST enter COMMENT TITLE, COMMENT, choose |
| | ICON, select which PERSONAL INFORMATION the |
| | system will display, and select ACCESS TYPE; |
| 10 | If Enlarge Writing Area was clicked it will follow the “Y” path, |
| | otherwise it will follow the “N” path; |
| 11 | As soon Enlarge Writing Area is chosen, the COMMENT field |
| | will be resized either to a bigger writing |
| | area or, if it already resized, will be resized to its initial size; |
| 12 | If all information were submitted it will follow the “Y” path, |
| | otherwise it will follow the “N” path; |
| 13 | If all submitted data are correct, it will follow the “Y” path, |
| | otherwise it will follow the “N” path; |
| 14 | If an error happens, an error message will be showed and user |
| | can choose to try again; |
| 15 | If user wants to try again it will follow the “Y” path, otherwise |
| | it will follow the “N” path to diagram [3]; |
| 16 | The system will ADD COMMENT information into database |
| | system and goes to diagram [3]; |

Referring to FIG. 23NN, beginning at 480, the following steps are performed.

TABLE 40

| Step | Action |
|---|---|
| 1 | Browser will display WEALTHYSOULJOURNAL.COM HOMEPAGE (A.K.A. End Users' Comments |
| | Page) title. |
| 2 | Website will load HEADER, COMMENT FORMS, IFRAME SUBSTITUTE (described on DIAGRAM 5 |
| | file) and FOOTER sections; |
| 3 | Website will display HEADER, COMMENT FORMS, IFRAME SUBSTITUTE (described on |
| | DIAGRAM 5 file) and FOOTER sections; |
| 4 | User MUST enter COMMENT, NAME and EMAIL ADDRESS; |
| 5 | Website will wait until one of the available options is chosen; |
| 6 | If CLEAR FORM was clicked the system will follow the “Y” path, otherwise it will follow the “N” path; |
| 7 | The system will clear any information that user added to comments forms; |
| 8 | If User's comments were submitted it will follow the “Y” path, otherwise it will follow “N” path; |
| 9 | If all submitted data are correct, it will follow the “Y” path, otherwise it will follow the “N” path; |
| 10 | If an error happens, an error message will be showed and user can choose to try again; |
| 11 | If user wants to try again it will follow the “Y” path, otherwise it will follow the “N” path to diagram |
| | [4A]; |
| 12 | The system will ADD USER'S COMMENT information into database system and goes to diagram [4A]; |

Referring to FIG. 23OO, beginning at 482, the following steps are performed.

TABLE 41

| Step | Action |
|---|---|
| 1 | Browser will display an iFrame DIV into HTML body's layout; |
| 2 | Browser will display a LOADING PAGE until all iFrame is loaded; |
| 3 | Website will send its ID to comments database to identify which data will be loaded; |
| 4 | Website will load Comment Title, Keyword (used for Search Engine Optimizations), Full Comment, |
| | Personal Data, Date and Time for each comment; |
| 5 | If all data is already loaded it will follow the “Y” path, otherwise it will follow the “N” until all available |
| | data is loaded; |
| 6 | Website will load user's template that was chosen into “User's Admin Panel”; |
| 7 | If template is loaded, all data will be formatted into it and the website will create the complete comments' |
| | page; |
| 8 | If iFrame is fully loaded it will follow the “Y” path, otherwise it will follow the “N” until all available |
| | data is loaded; |
| 9 | With all data loaded, another script will detect if these data has been fit into the actual height, or if it needs |
| | to be resized. If it has been fit then the script will follow the “Y” path, if not, it will follow the “N” path; |
| 10 | When the loaded data can't fit into its actual iFrame height, another script will be triggered and a new |
| | height will be calculated; |
| 11 | When the new height has been calculated, this script will resize the iFrame to its new height and will fit it |
| | into the all page content; |
| 12 | With all internal iFrame process is done, it will remove the LOADER PAGE from iFrame Substitute Area |
| | and goes to diagram [4B]; |

The present invention comprises an “iFrame solution” to add reader comment areas to web pages. Typically, XML code is used to display input from a local web site to a remote web site. However, XML code cannot display database input fields from one site to another. This requirement is met using an “iFrames.” The use of iFrames with XML code is a unique combination that allows this feature to be implemented. The reason that HTML Frames are not used exclusively is that the text of reader comments would not be placed on the remote web site (even though it would appear to be), thus preventing the search engine optimization feature of this system as produced in the keyword label 262 of the display page as shown in FIG. 7.

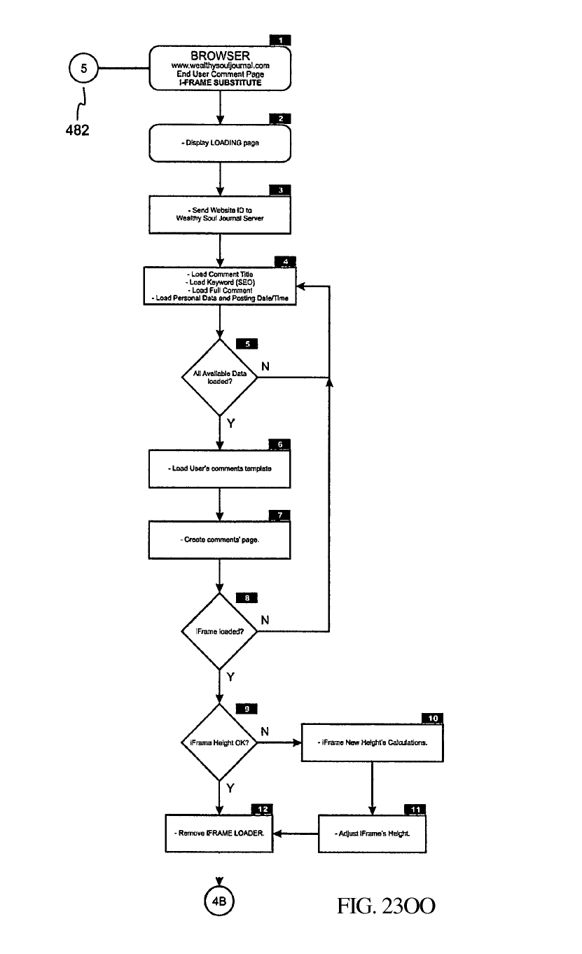

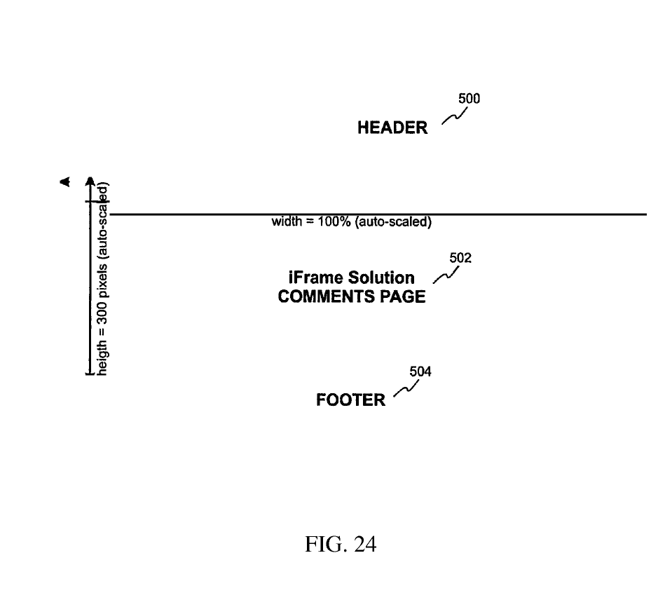

The “iFrame solution” of the present invention may be implemented with an existing web page framework. In the following example, the www.wealthysoul.com domain is used. An iFrame is a webpage element that creates an inline frame that contains another document. An iFrame functions as a document within a document, or like a floating FRAME. It just loads another HTML document within the <iframe> tags. Syntax <IFRAME> . . . </IFRAME>. The following example uses the IFRAME element and an HTML fragment to create a frame containing the page sample.htm as shown in FIG. 24. The page comprises a header 500, comments page 502, and footer 504. Comments, therefore, may be added within any section of a HTML document comprising the iFrame solution of the present invention.

TABLE 42

| Code | Parameters for IFrame |
|---|---|
| <IFRAME | SRC = URI (URI of frame content) |
| ID=“iFrame1” | NAME = CDATA (name of frame) |
| FRAMEBORDER=“0” | LONGDESC = URI (link to long description) |
| SCROLLING=“NO” | WIDTH = Length (frame width) |
| SRC=“sample.htm”> | HEIGHT = Length (frame height) |
| </IFRAME> | ALIGN = [top\|middle\|bottom\|left\|right] |
| | (frame alignment) |
| | FRAMEBORDER = [1\|0] (frame border) |
| | MARGINWIDTH = Pixels (margin width) |
| | MARGINHEIGHT = Pixels (margin height) |
| | SCROLLING = [yes\|no\|auto] (ability to scroll) |

The embedded technologies into iFrame solution are HTML, PHP, Javascript, MySQL, CSS and AJAX methods.

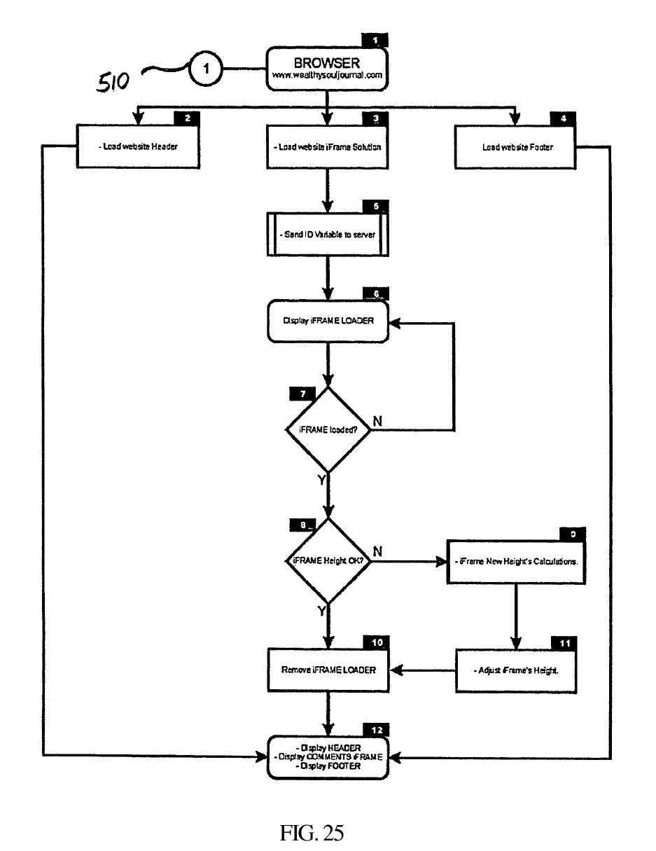

Referring to FIG. 25, a flowchart illustrating the iFrame solution according to an example embodiment of the present invention is shown. Referring to FIG. 25, beginning at 510, the following steps are performed to implement the iFrame solution.

TABLE 43

| Step | Action |
|---|---|
| 1 | With any ECMA-262 compatible browsers (Internet Explorer 5+, FireFox 1.5+, Opera 8+, etc), the |
| | user will access URL given in this example (www.wealthysoul.com); |
| 2 | Accessing the domain, the main framework will load its HEADER information and will display it as |
| | seen FIG. 24 header 500; |
| 3 | Accessing the domain, the main framework will load its FOOTER information and will display it as |
| | seen in FIG. 24 footer 500; |
| 4 | The iFrame will load an internal PHP dynamic page called comments.php. |
| 5 | Starting the loading functions, the framework should detect its domain (in this example, |
| | www.wealthysoul.com), and will send an ID variable that will define which data the comments.php |
| | page must load, as all its CSS styles; |
| 6 | As soon as comments.php start its function, a Javascript code will load a DIV tag who will display an |
| | 100% opaque image (white board in the example given), displaying an animated gif showing |
| | “LOADING”; |
| 7 | Into the HEAD TAG, an OnLoad trigger will start another script as soon as all contents from database |
| | is loaded as noticed into “Y” path. If all data haven't been loaded yet, the loader DIV will stay on |
| | screen as noticed into the “N” path; |
| 8 | With all data loaded, another script will detect if these data has been fit into the actual height, or if it |
| | needs to be resized. If it has been fit then the script will follow the “Y” path, if not, it will follow the |
| | “N” path; |
| 9 | When the loaded data can't fit into its actual iFrame height, another script will be triggered and a new |
| | height will be calculated; |
| 10 | When the new height has been calculated, this script will resize the iFrame to its new height and will |
| | fit it into the all page content; |
| 11 | After all scripts have been executed and none has failed, the iFrame LOADER DIV will be removed |
| | and the loaded data will be revealed. |
| 12 | HEADER, comments.php iFrame and FOOTER will be revealed into user's browser (e.g., as shown in |
| | FIG. 24: header 500, comments page 502, footer 504. |

Referring to FIG. 26A, beginning at 520, the tagging feature of aspect (1) comprising an end-user creating a comment and assigning one or more tags to it concurrently, the following steps are performed.

TABLE 44

| Step | Action |
|---|---|
| 1 | Website Administrator's server receives computer code w/in |
| | webpages to create comment and tag function |
| 2 | Administrator's server receives data (e.g. a comment and tag) |
| | input into the webpage by an end-user (reader) |
| 3 | In response to “one-click” or input by end-user, the |
| | administrator's server displays the data on the webpage |
| | and/or transmits the data to third party servers via the network |
| 3a | Data is displayed on Administrator's Webpage |
| 3b | Third Party stores data within end-user's account on party's |
| | database |
| 3c | Third Party server displays data on 3rd party's website |

Referring to FIG. 26B, beginning at 530, the tagging feature of aspect (1) comprising action taken by the remote server when an end-user inputs a comment and concurrently assigns one or more tags to it, wherein the following steps are performed.

TABLE 45

| Step | Action |
|---|---|
| 1 | Receiving by remote 2nd server, data for a reader comment and tag |
| | that is transferred to the 2nd server upon activation of submit |
| | function on webpage of 1st server |
| 2 | Storing on 2nd server's database, data related to the reader |
| | comment and tag |

Referring to FIG. 27, beginning at 540, the tagging feature of aspect (2) comprising enabling an end-user to assign one or more tags to a comment stored on a server database, wherein the following steps are performed.

TABLE 46

| Step | Action |
|---|---|
| 1 | Administrator's server displays data (e.g. comment), that is stored |
| | on server database, onto a webpage with a tag function |
| 2 | In response to user's tag selection, the administrator's server |
| | assigns the tag to the comment & transmits |
| | the data (tag + comment) to 3rd Party servers via the network |
| 2a | Data (comment + tag) is displayed on Administrator's webpage |
| 2b | 3rd Party server stores data (tag + comment) in user's account |
| | (e.g. journal) on 3rd Party's database |
| 2c | 3rd Party server displays data (tag + comment) on 3rd |
| | Party's website |

Referring to FIG. 28, beginning at 550, the tagging feature of aspect (3) comprising enabling an end-user to display on a webpage only those comments associated with one or more tags, wherein the following steps are performed.

TABLE 47

| Step | Action |
|---|---|
| 1 | Administrator's server displays data (e.g. comments) that is stored |
| | on the server database, onto a webpage with a tag function. |
| 2 | In response to user's tag(s) selection, the administrator's server |
| | identifies comments stored on database associated with the tag(s) |
| 3 | The administrator's server displays only comments associated with |
| | selected tags |

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

The present embodiments may further computer program products for one or more embodiments disclosed herein, wherein the products comprise computer code stored in memory on the system server, such as a remote cloud-based server, and/or accessible by or stored in whole or in part the within the memory of an end user's electronic computing device. The products may further comprise non-transitory computer readable medium containing computer executable instructions to carry out, by the processor, the methods when the instructions are run on an end user's electronic computing device or on a network, and wherein the instructions are downloadable from or stored on a system server. In one embodiment, for example, the computer program product is a mobile application on an end user's computing device (e.g. smartphone), wherein the product comprises non-transitory computer readable storage medium containing software instructions that, when executed by the device's processor, cause the device to perform acts included in one or more of the embodiments disclosed herein.

What is claimed is:

1. A computerized method for adding a reader comment area to a web page hosted at a first web site server comprising:
(a) prompting an administrator of said web page hosted at said first web site server to define reader comment area details, said reader comment area details comprising a title for a reader comment area and at least one tag;
(b) generating code to be inserted in said web page hosted at said first web site server, said code defining a reader comment area in said web page with said reader comment area details wherein comments entered in said reader comment area are received and stored at a remote second web site server, and said tags comprise code to enable a reader to input and/or select a label associated with said comment;
(c) prompting said administrator to save said web page with said inserted code for posting at said first web site server;
(d) creating in a database at said remote second web site server a comment area associated with said reader comment area for storing comment and tag data entered by readers of said first web site server in response to said readers submitting the comments; wherein said database is remote from said first web site server; and,
(e) wherein said comments associated with one or more tags are searchable and retrievable from a reader's record on a database.

2. The method of claim 1 further comprising: (f) receiving at said first web site server at least one reader comment entered by a reader in said reader comment area of said web page, and at least one tag entered or selected by a reader; and (g) storing in said database at said remote second web site server said at least one reader comment and said tag.

3. The method of claim 1 further comprising:
(f) receiving at said first web site server at least one reader comment entered by a reader in said reader comment area of said web page;
(g) storing in said database at said remote second web site server said at least one reader comment;
(h) retrieving said at least one reader comment by a reader on a website server display;
(i) creating and/or selecting by the reader one or more tags to be associated with said reader comment(s);
(j) receiving at said first web site server said tag(s) associated with said comment(s); and,
(k) storing in said database at said remote second web site server said tag(s) associated with said comment.

4. The method of claim 2 further comprising: (g) prompting said administrator to review said at least one reader comment entered in said reader comment area of said web page.

5. The method of claim 2 further comprising: (h) prompting said administrator to hide said at least one reader comment in said reader comment area of said web page.

6. The method of claim 2 further comprising: (i) prompting said reader entering said at least one reader comment to create a personal journal comprising said at least one reader comment in said reader comment area.

7. The method of claim 2 further comprising: (j) prompting said reader entering said at least one reader comment to keep said at least one reader comment private.

8. The method of claim 2 further comprising: (k) prompting said reader entering said at least one reader comment to email said reader comment to others.

9. The method of claim 1 further comprising, in step (a) said reader comment area further comprising at least one keyword, wherein step (b) said keyword is associated with said web page at said first web site server to facilitate search engine optimization of said web page at said first web site server based on said keyword.

10. The method of claim 1, wherein said reader's record on said database comprises comments associated with tags from one or more of websites.

11. A computerized system for managing a web site reader comment area in a web page comprising:
a) an administrator page creator software component for defining a reader comment area details for said web page, said reader comment area details comprising a title and a means for a reader created and/or selected tag associating a reader label with a reader's comment;
b) a code generation software component for generating code to define a reader comment area in a web page hosted at a first web site server, said reader comment area defined by said reader comment area details and wherein comments and one or more tags associated with a comment are entered in said reader comment area are received and stored at a remote second web site server;
c) a web page editing software component for editing a web page selected by an administrator to contain said code defining said reader comment area;
d) a database at a remote second web site server for receiving reader comments and said one or more tags associated with a comment entered in said reader comment area within said web page; wherein said database is remote from said first web site server and receives reader comments and tag(s) as they are entered by said reader; and,
e) an administrator page editor software component for reviewing reader comments entered in said reader comment area within said web page.

12. The system of claim 11 wherein said administrator page editor software component comprises options for publishing all incoming comments and hiding all incoming comments.

13. The system of claim 11 wherein said administrator page editor comprises options for hiding a single reader comment.

14. The system of claim 11 further comprising a display page software component for displaying a reader comment input section and a reader comment output section to a reader of said web page.

15. The system of claim 14 wherein said reader comment input section comprises a field for entering a title for a comment, a comments field for entering a comment, a tag field for creating and/or selecting one or more tags associated with a comment, and an identifier field for entering an identifier for said reader.

16. The system of claim 14 wherein said reader comment input section comprises an option for creating a personal journal for said reader, said personal journal accessible via login by said reader and comprising comments entered by said reader in said comments field.

17. The system of claim 14 further comprising a reader comment output section for displaying comments entered by readers.

18. The system of claim 14 wherein comments entered by readers comprise a keyword label with keywords for use in search engine optimization of said web page.

19. The system of claim 11 wherein said code generation software component generates code for iframe substitution such that an iframe in said web page loads a dynamic internal page comprising said reader comment area and associated reader comments.

20. The system of claim 11 wherein said web page has an associated category and optional subcategory defined by said administrator for accessing portions of said web page.
